(19) United States
(12) Patent Application Publication
(10) Pub. No.: US 2012/0056450 A1
(43) Pub. Date: Mar. 8, 2012

(54) Devices for securing panels over an opening

(76) Inventors: Joseph DiMario, Troy, MI (US); John Helner, Lake Orion, MI (US); Timothy Smith, Commerce Township, MI (US); Wesley Blanchard, Charlotte, NC (US); Michael Pritchett, Waterford, MI (US)

(21) Appl. No.: 12/877,562

(22) Filed: Sep. 8, 2010

(51) Int. Cl. B60J 7/185

(52) U.S. Cl. 296/224

(57) ABSTRACT

A transparency of a panel of the invention is secured to an recess in a vehicle by biasing the panel toward a hole in the recess defined by an end of a flange, and fixedly mounting the panel to the flange in less than 10 minutes. In one embodiment, the transparency is secured to the recess from a position within the vehicle. In another embodiment, the panel is replaced by providing access to the hole and moving the mounting devices toward the hole to engage the flange to fixedly secure the panel over the hole. When a prior art broken transparency is replaced, the broken transparency and the structural adhesive is removed, and a panel of the invention is mounted over the hole. When an unbroken panel of the invention is to be replaced, the inner trim from the recess is removed, and the mounting devices released from the flange.

### CROSS-REFERENCE TO RELATED APPLICATIONS

This application claims the benefits of copending U.S. application Ser. No. 11/486,789, filed Jul. 14, 2006, entitled “METHOD OF MOUNTING A PANEL OVER AN OPENING”, which claims the benefits Application No. 60/716,372, filed Sep. 12, 2005, entitled “METHOD OF MOUNTING A PANEL OVER AN OPENING, DEVICES FOR SECURING PANELS OVER AN OPENING, AND PANELS HAVING THE DEVICES”. This application is related to U.S. application Ser. No. 11/486,918 entitled “DEVICES FOR SECURING PANELS OVER AN OPENING, AND PANELS HAVING THE DEVICES”; U.S. application Ser. No. 11/486,790 entitled “DEVICES FOR SECURING PANELS OVER AN OPENING, AND PANELS HAVING THE DEVICES”; and U.S. application Ser. No. 11/486,919 entitled “DEVICES FOR SECURING PANELS OVER AN OPENING, AND PANELS HAVING THE DEVICES”; each filed concurrently therewith. These applications are herein incorporated by reference in their entirety.

### BACKGROUND OF THE INVENTION

1. Field of the Invention

This invention relates to a method of mounting or installing a panel over a hole, and for removing a panel from over the hole, and more particularly, to a method of fixedly securing a panel in a recess in the body of an automotive vehicle without the use of structural adhesive between transparency of the panel and surface of the flange defining the recess in the vehicle body and end of the flange defining perimeter of the hole.

2. Discussion of the Available Technology

Land vehicles, e.g. cars, trucks, trains and buses are provided with either fixed or moveable transparencies or glass windows. Of particular interest in this discussion, but not limiting to the invention, are the mounting of fixed transparencies and/or the replacement of damaged fixed transparencies. Usually, fixed vehicular transparencies, e.g. windshields, rear windows, and quarter windows or panels are secured in a recess in the body of the vehicle by a bead or layer of a curable or thermosetting structural adhesive. The recess is defined by an outer surface of a flange with an opening or a hole in the recess defined by the inner edge of the flange. The adhesive is applied on the inner marginal edge portions of the replacement transparency and, thereafter, the transparency is biased toward the outer surface of the flange to flow the adhesive layer between the flange and the transparency. The transparency is securely mounted in the recess after the adhesive layer cures.

As can be appreciated by those skilled in the art, the replacement of a damaged transparency is time consuming and expensive. More particularly, the damaged transparency or pieces of the damaged transparency and the adhesive layer are removed from the outer surface of the flange. The time to complete the removal and cleaning steps depends on the size of the transparency being replaced. As a general statement, the time required to carry out the manual steps to remove a damaged windshield and mount a replacement windshield in the recess is in the time range of 24 to 45 minutes, and the time for the adhesive to fully cure is in the time range of one day to a week depending on the environment and the type of adhesive used.

To overcome the drawback of the long curing time, and to accommodate the desire of the vehicle owner to have and drive the vehicle, strips of tape are applied over the edge of the transparency and the body of the vehicle to hold the transparency in place while the adhesive cures. As an added precaution, it is recommended not washing the car for at least 8 hours.

As can be appreciated by those skilled in the art, it would be advantageous to provide a technique to replace a damaged transparency that does not have the limitations of the presently available procedure. More particularly, provide a technique that is more cost effective than the presently available procedures, and to provide a mounting system for mounting transparencies such that the transparencies are securely mounted in the recess in a shorter time period than the presently available mounting systems, e.g. securely mount the transparency in the recess in less than ½ hour by, among other things, eliminating the need for the structural adhesive.

### SUMMARY OF THE INVENTION

This invention relates to a method of securing a panel to a recess having a hole, the perimeter of the hole defined by an end of a flange. In one non-limiting embodiment of the invention, the recess is a recess of an enclosure selected from land, air, space, above water and below water vehicles, residential housing, commercial buildings, oven doors and containers having doors with viewing areas. The method includes biasing the panel toward the recess, and fixedly mounting the panel to the flange within one of the following time ranges: greater than 0 seconds to equal to or less than 60 minutes; greater than 0 seconds to equal to or less than 45 minutes; greater than 0 seconds to equal to or less than 30 minutes, greater than 0 seconds to equal to or less than 20 minutes, and greater than 0 seconds to equal to or equal to 10 minutes. Optionally, the biasing can be practiced from a position inside the vehicle or from a position outside the vehicle.

In one non-limiting embodiment of the invention, the panel includes a transparency having two or more mounting devices securely mounted on a major surface of the transparency in spaced relationship to one another. Each of the mounting devices has a first contact surface, e.g. a supporting surface and a second contact surface, e.g. an engaging surface, and the flange has an outer surface and an opposite inner surface. Fixedly mounting the transparency to the recess includes moving the first contact surface of the mounting devices and the flange relative to one another to move the first contact surface and the outer surface of the flange into contact with one another, and moving the second surface of the mounting devices and the flange relative to one another to move the second contact surface and the inner surface of the flange into contact with one another to fixedly secure the panel to the recess.

Moving the first contact surface and moving the second contact surface occurs in accordance to one of the following sequences:

moving the first contact surface is practiced before moving the second contact surface,

moving the first contact surface is practiced after moving the second contact surface,

and moving the first contact surface and the step of moving the second contact surface are practiced together.

The invention further relates to a method of fixedly securing a transparency over a hole in a recess of a vehicle by passing the transparency through the hole in the recess from a position within the vehicle, and securing the transparency over the hole from a position within the vehicle.

The invention still further relates to a method of replacing a transparency of a vehicle by providing access to the hole; providing a panel having a transparency having a first major surface and an opposite second major surface. A plurality of mounting devices are securely mounted in spaced relationship to one another on inner marginal edge portions of the first major surface of the transparency. The panel is moved to move the mounting devices toward the hole to engage the outer and inner surface portions of the flange with the mounting devices to fixedly secure the panel over the hole.

In another non-limiting embodiment of the invention, the transparency to be replaced is a broken transparency secured over the hole by a structural adhesive wherein the step of providing access to the hole includes the steps of removing the damaged transparency and the structural adhesive. In a further non-limiting embodiment of the invention, the step of providing access to the hole includes the steps of removing inner trim from the recess, and releasing the mounting devices from the flange to remove the panel from the recess.

### BRIEF DESCRIPTION OF THE DRAWINGS

FIG. 1 is an elevated orthogonal back-side view of a van having panels of the invention mounted or secured in accordance to the invention to selected ones of the flanges defining a recess in the body of the van.

FIG. 2 is a view taken along lines 2-2 of FIG. 1 illustrating a non-limiting embodiment of a generic design of a mounting device of the invention to secure the panel of the invention to a flange defining a recess in the body of the van.

FIG. 3 is a view similar to the view of FIG. 2 illustrating a prior art system for mounting a transparency in the recess in the body of a van.

FIG. 4 is an elevated fragmented orthogonal interior view of a recess in the body of the van having a panel of the invention mounted in the recess in accordance to the invention.

FIG. 5 is a plan view of a first non-limiting embodiment of a mounting device of the invention (hereinafter also referred to as “first mounting device”).

FIG. 6 is a side view showing a view of the first mounting device taken along line 6-6 of FIG. 5 and showing the first mounting device in a non-engaging position, securely mounted on marginal edge portions of a transparency and spaced from the flange defining the recess. FIG. 6A is an enlarged view of a restraining member for engaging a tooth of a first plurality of teeth, the restraining member shown in the non-engaging position, and FIG. 6B is an enlarged view of a second restraining member for engaging a tooth of a second plurality of teeth, the second restraining member shown in the engaging position.

FIG. 7 is a view of similar to the view of FIG. 6 showing the first mounting device engaging the flange to secure the panel in the recess in accordance to the invention.

FIG. 8 is an elevated orthogonal back-side view of the first mounting device.

FIG. 9 is an elevated orthogonal back view of the first mounting device.

FIG. 10 is an elevated fragmented side view of a panel having a second non-limiting embodiment of a mounting device of the invention (hereinafter also referred to as “second mounting device”) securely mounted on marginal edge portions of a transparency and spaced from outer surface of the flange defining the recess.

FIG. 11 is an elevated orthogonal front-side view of the second mounting device taken along line 11-11 of FIG. 10, the mounting device in spaced relationship to the flange.

FIG. 12 is a view similar to the view of FIG. 10 showing the second mounting device contacting the outer corner of the flange.

FIG. 13 is a view similar to the view of FIG. 10 showing the second mounting device engaging the flange to secure the panel in the recess.

FIG. 14 is an elevated orthogonal front-side view having portions removed for purposes of clarity of a third non-limiting embodiment of a mounting device of the invention (hereinafter also referred to as “third mounting device”) securely mounted on marginal edge portions of a transparency and engaging the flange defining the recess.

FIG. 15 is an elevated side view having portions removed for purposes of clarity of a fourth non-limiting embodiment of a mounting device of the invention (hereinafter also referred to as “fourth mounting device”) securely mounted on marginal edge portions of a transparency and engaging the flange defining the recess.

FIG. 16 is an elevated orthogonal front-side fragmented view of a panel having a fifth non-limiting embodiment of a mounting device of the invention (hereinafter also referred to as “fifth mounting device”) securely mounted on marginal edge portions of a transparency and contacting end of the flange defining the recess.

FIG. 17 is an elevated fragmented side view of the panel of FIG. 16 showing the fifth mounting device securely mounted on marginal edge portions of a transparency and spaced from the end of the flange.

FIG. 18 is a view similar to the view of FIG. 17 showing the fifth mounting device engaging the flange to secure the panel in the recess.

FIG. 19 is an elevated fragmented side view having portions removed for purposes of clarity of a sixth non-limiting embodiment of a mounting device of the invention (hereinafter also referred to as “sixth mounting device”) securely mounted on marginal edge portions of a transparency and spaced from the end of the flange defining the recess.

FIG. 20 is a view similar to the view of FIG. 19 showing the sixth mounting device engaging the flange to secure the panel in the recess.

FIG. 21 is an elevated side view having portion removed for purposes of clarity of a seventh non-limiting embodiment of the mounting device of the invention (hereinafter also referred to as “seventh mounting device”),

FIG. 22 is a top view of the sixth mounting device.

FIG. 23 is an elevated fragmented side view of a panel showing the seventh mounting device securely mounted on marginal edge portions of a transparency and contacting the outer corner of the flange.

FIG. 24 is a view similar to the view of FIG. 23 showing the seventh mounting device engaging the flange to secure the panel in the recess.

FIG. 25 is an elevated fragmented side view of a panel having an eighth non-limiting embodiment of a mounting device of the invention (hereinafter also referred to as “eighth mounting device”) securely mounted on marginal edge portions of a transparency and contacting outer surface of the flange defining the recess.

FIG. 26 is a view similar to the view of FIG. 25 showing the eighth mounting device engaging the flange to secure the panel in the recess.

FIG. 27 is an elevated orthogonal top-side view of the view of FIG. 26 having portions removed for purposes of clarity.

FIG. 28 is an elevated fragmented side view of a panel having a ninth non-limiting embodiment of the mounting device of the invention (hereinafter also referred to as “ninth mounting device”) securely mounted on marginal edge portions of a transparency and contacting outer surface of the flange defining the recess.

FIG. 29 is a view similar to the view of FIG. 28 showing the ninth mounting device moved further into the recess.

FIG. 30 is a view similar to the view of FIG. 28 showing the ninth mounting device engaging the flange to secure the panel in the recess.

FIG. 31 is an elevated orthogonal side view of the view of FIG. 30 having portions removed for purposes of clarity.

FIG. 32 is an elevated orthogonal fragmented front-side view of a panel having a tenth non-limiting embodiment of a mounting device of the invention (hereinafter also referred to as “tenth mounting device”) securely mounted on marginal edge portions of a transparency and contacting outer surface of the flange defining the recess.

FIG. 33 is an elevated fragmented side view showing the tenth mounting device in the position shown in FIG. 32. FIG. 33A is a plane view of the tenth mounting device in the position shown in FIGS. 32 and 33.

FIG. 34 is a view similar to the view of FIG. 33 showing the tenth mounting device moved further into the recess. FIG. 34A is a plane view of the tenth mounting device in the position shown in FIG. 34.

FIG. 35 is a view similar to the view shown in FIG. 33 showing the tenth mounting device engaging the flange to secure the panel in the recess. FIG. 35 A is a plane view of the tenth mounting device in the position shown in FIG. 35.

FIG. 36 is an elevated orthogonal fragmented front-side view of a panel having an eleventh non-limiting embodiment of the mounting device of the invention (hereinafter also referred to as “eleventh mounting device”) securely mounted on marginal edge portions of a transparency and contacting outer corner of the flange defining the recess; the flange shown in phantom.

FIG. 37 is a side elevated fragmented view of the panel of FIG. 36 showing the eleventh mounting device contacting the outer corner of the flange.

FIG. 38 is a view similar to the view of FIG. 37 showing the eleventh mounting device contacting the end of the flange.

FIG. 39 is a view similar to the view of FIG. 37 showing the eleventh mounting device engaging the flange to secure the panel in the recess.

FIG. 40 is an elevated fragmented side view of a panel having a twelfth non-limiting embodiment of the mounting device of the invention (hereinafter also referred to as twelfth mounting device”) securely mounted on marginal edge portions of a transparency and engaging the flange to secure the panel in the recess defined by the flange.

FIG. 41 is an elevated split plan view of the panel shown in FIG. 40 with the left side of the plan view showing the panel as viewed from inside the van, and the right side of the plan view showing the panel as viewed from outside the van.

FIG. 42 is an orthogonal fragmented front-side view of a panel having a thirteenth non-limiting embodiment of the mounting device of the invention (hereinafter also referred to as “thirteenth mounting device”) securely mounted on marginal edge portions of a transparency,

FIG. 43 is an elevated fragmented side view of the panel of FIG. 42 showing the engaging member of the thirteenth mounting device in a hole in the flange defining the recess.

FIG. 44 is a view similar to the view of FIG. 43 showing the thirteenth mounting device engaging the flange to secure the panel in the recess.

FIG. 45 is an elevated fragmented side view of a panel having a fourteenth non-limiting embodiment of a mounting device of the invention (hereinafter also referred to as “fourteenth mounting device”) secured to the marginal edge portions of a transparency and having the engaging members of the fourteenth mounting device in a hole of the flange defining an recess.

FIG. 46 is a view similar to the view of FIG. 45 showing the engaging members of the fourteenth mounting device above the inner surface of the flange.

FIG. 47 is a view similar to the view of FIG. 45 showing the mounting device engaging the flange to secure the panel in the recess.

FIG. 48 is an orthogonal top-side view of a non-limiting embodiment of a flexible engaging member that can be used with at least the thirteenth and fourteenth mounting devices.

FIG. 49 is an orthogonal top-side view of another non-limiting embodiment of a flexible engaging member that can be used with at least the thirteenth and fourteenth mounting devices.

FIG. 50 is an elevated orthogonal front-side view of a fifteenth non-limiting embodiment of a mounting device of the invention (hereinafter also referred to as “fifteenth mounting device”).

FIG. 51 is an elevated orthogonal back-side view of the fifteenth mounting device.

FIG. 52 is an elevated fragmented side view of a panel having the fifteenth mounting device positioned in relationship to the end of a flange defining a recess.

FIG. 53 is a view similar to the view of FIG. 52 showing the outer surface of the flange contacting the supporting surface of the fifteenth mounting device.

FIG. 54 is a view similar to the view of FIG. 52 showing the fifteenth mounting device engaging the flange to secure the panel in the recess.

FIG. 55 is an elevated orthogonal front-side view of a sixteenth non-limiting embodiment of a mounting device of the invention (hereinafter also referred to as “sixteenth mounting device”).

FIG. 56 is an elevated fragmented side view of a panel having the sixteenth mounting device securely mounted on the marginal edge portions of a transparency and contacting outer corner of the flange defining the recess.

FIG. 57 is a view similar to the view of FIG. 56 showing the sixteenth mounting device contacting the outer corner of the flange.

FIG. 58 is a view similar to the view of FIG. 56 showing the sixteenth mounting device engaging the flange to secure the panel in the recess.

FIG. 59 is an elevated orthogonal front-side view having portions removed for purposes of clarity of a seventeenth non-limiting embodiment of a mounting device of the invention (hereinafter also referred to as “seventeenth mounting clip”).

FIG. 60 is an elevated fragmented side view of a panel having the seventeenth mounting device securely mounted on the marginal edge portions of a transparency and in spaced relationship to outer surface of the flange defining the recess.

FIG. 61 is a view similar to the view of FIG. 60 showing the seventeenth mounting device contacting outer surface of the flange defining the recess.

FIG. 62 is a view similar to the view of FIG. 60 showing the seventeenth mounting device engaging the flange to secure the panel in the recess.

FIG. 63 is an elevated orthogonal front-side view of an eighteenth non-limiting embodiment of a mounting device of the invention (hereinafter also referred to as “eighteenth mounting device”).

FIG. 64 is an elevated fragmented side view of a panel having the eighteenth mounting device securely mounted on the marginal edge portions of a transparency; the eighteenth mounting device is in a non-engaging position and the flange defining the recess is shown in phantom.

FIG. 65 is a view similar to the view of FIG. 64 showing the eighteenth mounting device engaging the flange to secure the panel in the recess.

FIG. 66 is an elevated orthogonal rear-side view of a nineteenth non-limiting embodiment of a mounting device of the invention (hereinafter also referred to as “nineteenth mounting device”).

FIG. 67 is an elevated fragmented side view of a panel having the nineteenth mounting device securely mounted on the marginal edge portions of a transparency; the nineteenth mounting device is in a non-engaging, non-cocked position.

FIG. 68 is a view similar to the view of FIG. 67 showing the nineteenth mounting device engaging the flange defining the recess; the nineteenth mounting device is in a non-engaging, cocked position.

FIG. 69 is a view similar to the view of FIG. 68 showing the nineteenth mounting device engaging the flange to secure the panel in the recess.

FIGS. 70 and 71 are elevated orthogonal views of a non-limiting alternate embodiment of the nineteenth mounting device.

### DETAILED DESCRIPTION OF THE INVENTION

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.7, or 3.2 to 8.1, or 5.5 to 10. Also, as used herein, the terms “deposited over”, “applied over”, or “provided over” mean deposited, applied, or provided on but not necessarily in surface contact with. For example, a material “deposited over” a substrate does not preclude the presence of one or more other materials of the same or different composition located between the deposited material and the substrate.

In one non-limiting embodiment of the invention, a technique is disclosed to replace a damaged and/or undamaged panel, window, transparency and/or substrate secured in a recess. The recess in which the panel, window, transparency and/or substrate can be secured is not limiting to the invention and includes but is not limited to an recess in (1) any type of vehicle, e.g. but not limiting the invention thereto, any type of land vehicle, e.g. but not limiting the invention thereto an automobile, a van, a truck, a train; an above water vehicle; a below water vehicle; an air vehicle, or a space vehicle; (2) any type of residential or commercial building; (3) any type of a curtainwall system or cladding for a building, and/or (4) any type of door, e.g. but not limiting the invention, an oven door having a viewing window, a refrigerator door having a viewing window and entrance door having a viewing window.

In one non-limiting embodiment of the invention, the recess is defined by a ledge or flange with the end of the ledge or flange connecting opposed surfaces of the ledge or flange, e.g. the inner and outer surfaces, and the end of the ledge or flange defining an opening. In the following discussion of the non-limiting embodiments of the invention, the recess or opening is in a body and/or body part, e.g. a door of a vehicle, e.g. an automotive van, and the transparency of a panel is mounted over the opening and/or in the recess. In general, and not limiting to the invention, the recess is a depression in the body of the van defined by the flange with the end of the flange defining the opening. The opening interconnects the interior of the van to the exterior of the van. The panel secured in the recess according to the invention in addition to the transparency includes mounting clips of the invention securely mounted to the transparency. As is appreciated, the invention is not limited the shape or material of the transparency and/or the shape of the recess. More particularly, the transparency can have opposed parallel or non-parallel flat major surfaces, opposed parallel or non-parallel curved major surfaces, or combinations thereof. Further, the transparency or substrate can be made of any type of material, for example but not limiting the invention thereto material selected from the group of plastic; glass fiber, metal fiber and/or carbon fiber reinforced plastic; metal; wood; glass of any type, e.g. but not limiting the invention thereto, glass ceramic, annealed glass, tempered glass, heat strengthened glass, colored glass and clear glass. Still further, the transparency can have any type of coating applied over one or more surfaces, e.g. but not limiting the invention thereto, an environmental coating, an electrically conductive coating, a water repellant coating, and/or a self cleaning coating, and combinations thereof. In addition, the transparency can be monolithic or laminated, e.g. but not limiting the invention thereto, a pair of glass sheets, or a glass sheet and plastic sheet, laminated together. In addition, the transparency can be one or both sheets of a double glazed or insulating unit. Further, the panel can be a modular roof, e.g. but not limiting to the type disclosed in U.S. Pat. No. 6,279,989 secured in a recess in the vehicle roof.

In a non-limiting embodiment of the invention, the panel is secured in the recess using mounting devices of the invention discussed in detail below. It is understood that the invention is not limited in its application to the details of the particular non-limiting embodiments of the mounting clips shown and discussed herein since the invention is capable of other embodiments mounting devices. Further, the terminology used herein to discuss the non-limiting embodiments of the invention is for the purpose of description and is not of limitation. Still further, unless indicated otherwise in the following discussion, like numbers refer to like elements.

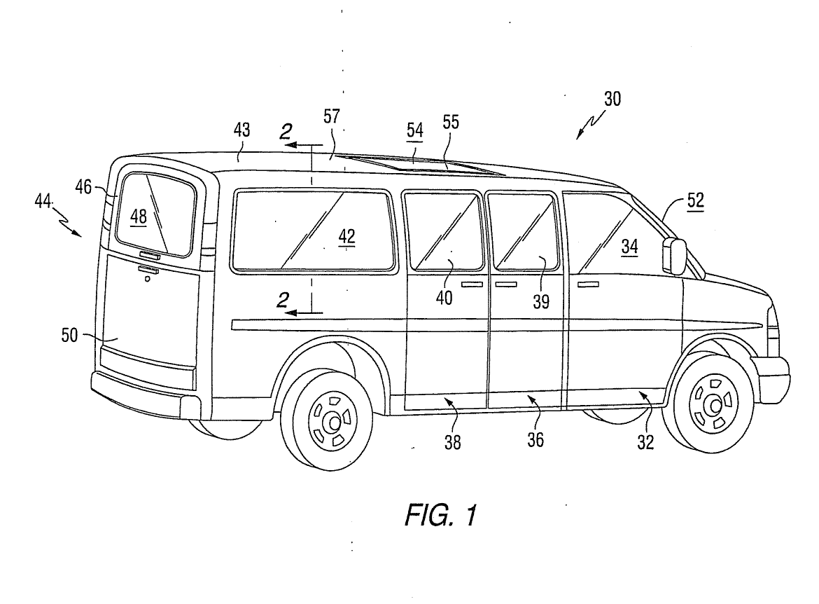

Shown in FIG. 1 is a van 30 having a pair of hinged front doors 32 (only one shown in FIG. 1) having a conventional moveable side window 34; a pair of side doors 36 and 38 each having a side window 39 and 40, respectively secured in an recess in respective door 36 and 38; a transparency 42 (also referred to as a quarter panel or quarter window) secured in an recess in body 43 of the van; a rear door 44 having an upper section 46 having a rear window 48 secured in recess in the upper section 46 and having a lower section 50 with the upper and lower sections hinged to the van body 43 in any convenient manner; a windshield 52 secured in an recess in the front of the van body, and a roof transparency secured in, or a modular roof panel secured in, or a window secured to a frame moveably mounted in, recess 55 in roof 57 of the van body. The roof transparency, modular roof and window secured in a frame are each designated by the number 54. As can be appreciated, one or both of the side doors 36 and 38 can be hinged to the van body 43 in a similar manner as the front door 32, or one or both of the side doors can be mounted on a track of the type used in the art (not shown) to move the door(s) along a reciprocating path along the side of the van body to provide passenger entrance and exit. Further the invention contemplates the side windows 39 and 40 mounted on their respective door for movement as is known in the art. Still further, the van 30 can have one side door instead of two side doors as shown in FIG. 1.

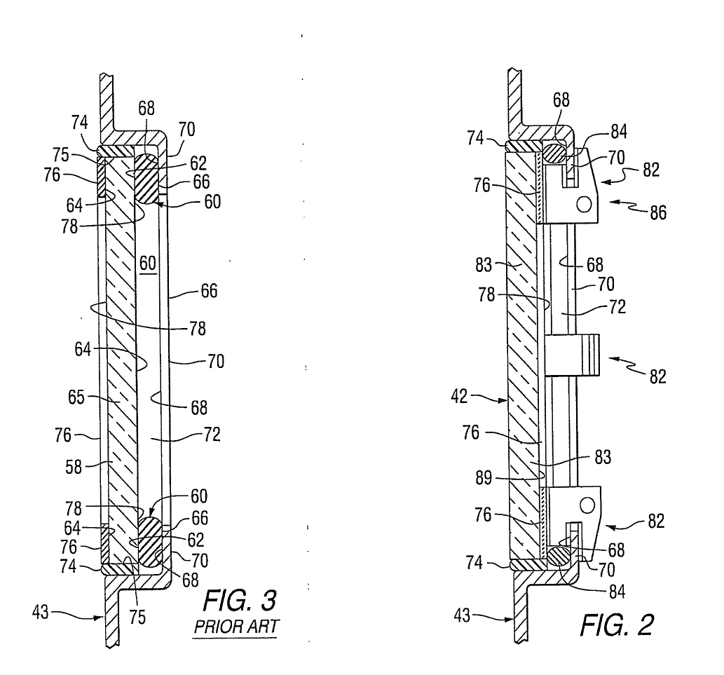

In the following discussion, non-limiting embodiments of the invention are practiced to secure a transparency in the recess in the body 43 of the van 30 shown in FIG. 1 as having the window 42. The transparency is mounted in a general manner as shown in FIG. 2 and discussed in detail below. As is appreciated, the invention is not limited thereto, and the invention can be practiced to secure the side windows 39 and 40, the rear window 48, the windshield 52, the roof window 54, and/or the modular roof panel 54 in an recess in the body of the van and/or to secure the window to the frame mounted in the roof recess 55. For an appreciation of the invention, a brief discussion of a prior art technique of secure transparencies in recess in the van body is presented. As is appreciated, the invention is not limited to the prior art discussion, and the prior art discussion is presented for purposes of comparison and not of limitation.

With reference to FIG. 3, a transparency 58 is secured in a recess 72 in the body 43 of the van by an adhesive layer 60, e.g. moisture curable urethanes sold by Dow Automotive as Part No. 58702 and 57502 and/or a two component chemically reactive urethane of the type sold by Dow Automotive as Part No. U-216. Surface 62 of the adhesive layer is adhered to inner marginal edge portions 64 of the panel 58, and opposite surface 66 of the adhesive layer 60 is adhered to outer surface 68 of flange or ledge 70 defining recess 72 in the van body 43. In practice, the adhesive layer 60 is applied to the inner marginal edge portions 64 of the transparency 58. A gasket or edge trim 74 of the type used in art is mounted on peripheral edges 75 of the transparency 58 in any convenient manner. The transparency 58 having the edge trim 74 and the adhesive layer 60 is moved into the recess 72 against the outer surface of the flange to flow the adhesive layer 60 on the surface 68 of the flange 70 and the inner marginal edge portions 64 of the transparency 58. The transparency 58 is secured on the flange 70 after the adhesive layer 60 sets or cures. As is appreciated by those skilled in the art, the set or cure time of the adhesive depends on the adhesive used and the environment. Manufacturers of the adhesives provide cure time data. Generally, moisture curable urethanes fully cure in about 7 days and two component chemically reactive urethanes fully cure in about 3 days.

Optionally, a ceramic band 76 is provided on inner or outer marginal edges of the transparency (mounted on inner marginal edge portions 89 of transparency 83 in FIG. 2 and on outer marginal edges 78 of the transparency 58 in FIG. 3) to prevent ultraviolet degradation of the adhesive layers used in the prior art, e.g. the adhesive layer 60 and/or used in the practice of the invention discussed below. The ceramic band 76 is usually black; however, as is appreciated by those skilled in the art, the ceramic band can be any color. Further, as is appreciated by those skilled in the art, the gasket or edge trim 74 can extend over the outer marginal edges 78 of the transparency to eliminate the need of the ceramic band. Types of adhesives presently used to secure transparencies in recess of a vehicular body and/or in recess of parts secured to the vehicular body, and the suppliers of such adhesives are well known in the art and no further discussion is deemed necessary.

With reference to FIG. 2, in the practice of the invention, the adhesive layer 60 that secures the prior art transparency 58 to the outer surface 68 of the flange 70 is eliminated, and the panel of the invention is secured in the recess 72 by mounting devices or mounting clips of the invention generically shown in FIG. 2 and identified by number 82. The mounting devices of the invention are secured on the transparency 83, e.g. tempered glass, in a manner discussed below. The edge trim 74 and/or a weather seal 84 is (are) provided between the transparency 83 of the panel of the invention and the flange defining the recess in the van body to prevent water from moving between the panel and the flange into the interior of the van and is (are) not provided to secure the transparency to the flange. For example and not limiting to the invention, the weather seal has a shear strength of no greater that 100 pounds per square inch, for example no greater than 50 pounds per square inch, for example no greater than 20 pounds per square inch, for example no greater than 10 pounds per square inch. In one non-limiting embodiment of the invention, the weather seal is a butyl tape of the type sold by Adco Products, Inc. of Michigan part No. RT0140 has a shear strength of 8 pounds per square inch and provides minimal if any, structural strength to secure the panel of the invention in the recess.

The discussion is now directed to non-limiting embodiments of the mounting devices or mounting clips of the invention to secure a panel in a recess in the body 43 of the van 30 without the use of structural adhesive. In the practice of the invention discussed below, a panel of the instant invention can be secured in an recess, e.g. and not limiting to the invention, in the recess in the body of a vehicle in a time period in one of the following ranges: greater than 0 seconds to equal to or less than 30 minutes; greater than 0 seconds to equal to or less than 20 minutes; greater than 0 seconds to equal to or less than 15 minutes, and greater than 0 seconds to equal to or less than 10 minutes.

### First Mounting Device

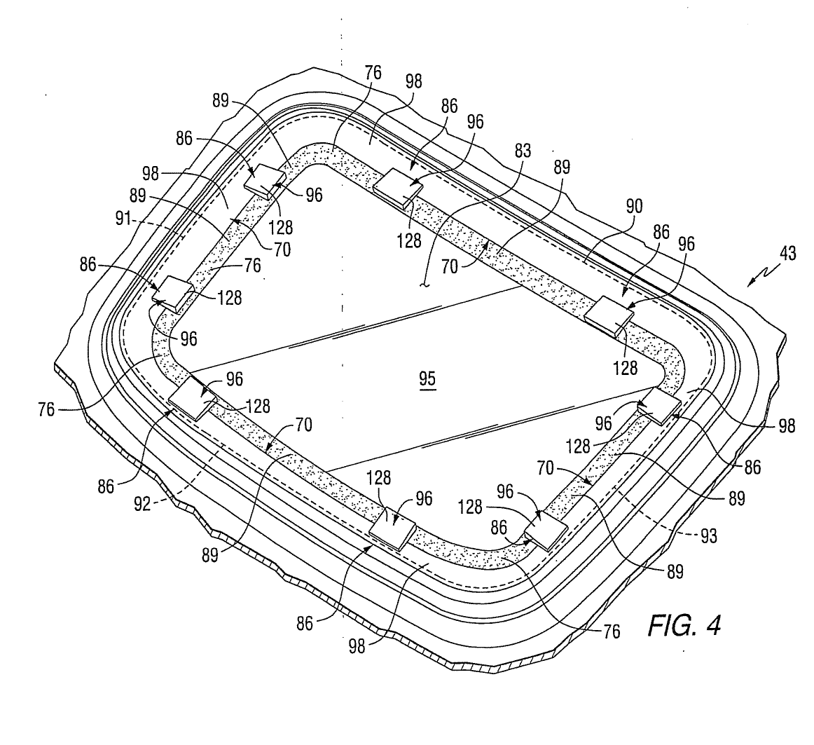

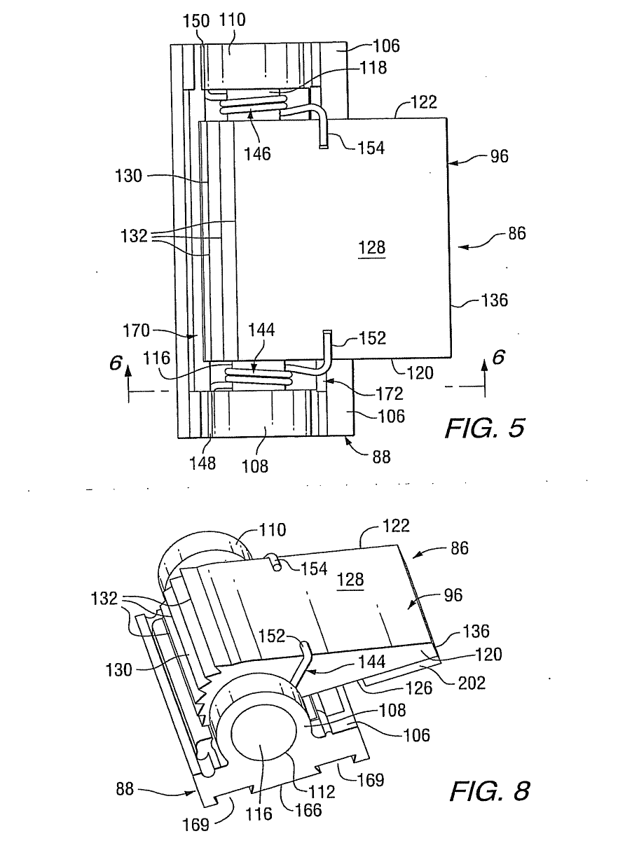

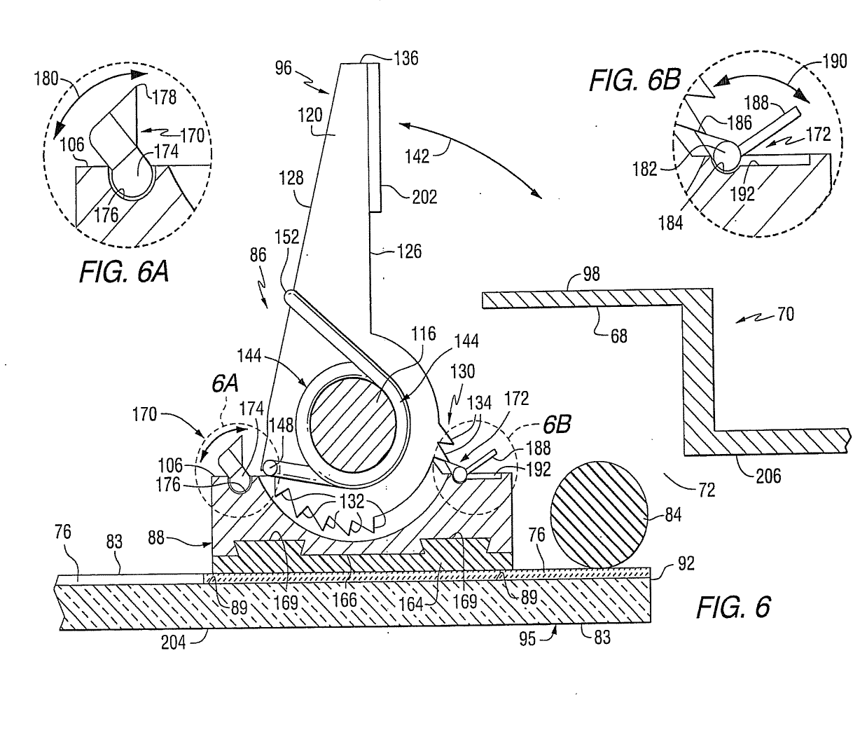

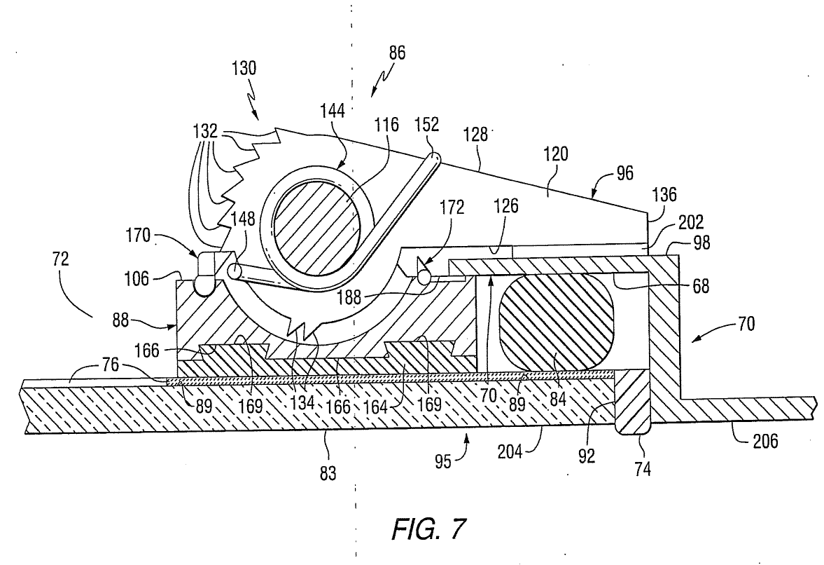

Shown in FIGS. 4-9 is first non-limiting embodiment of a mounting device designated by the number 86. The first mounting device 86 (see FIGS. 5-9) includes a base 88, with the base 88 of each of a plurality of first mounting devices 86 mounted on portions of the ceramic band 76 (see FIGS. 6 and 7) fired on the inner marginal edge portions 89 of the transparency 83 adjacent a peripheral edge or side 90-93 (shown in FIG. 4) of the transparency to provide a panel 95. A spring biased engaging member 96 engages portions of inner surface 98 of the flange 70, i.e. the surface portions of the flange facing the interior of the van and opposite to the outer surface 68 of the flange 70 (see FIGS. 6 and 7).

With reference to FIGS. 5-9 as needed, in one non-limiting embodiment of the invention, the base 88 of the mounting device 86 includes a surface 106 and spaced uprights 108 and 110 extending upward from the surface 106 (see FIGS. 8 and 9). Each of the uprights 108 and 110 have a hole 112 (only hole 112 for the upright 108 shown, see FIGS. 8 and 9) to receive cylindrical shaped ends 116 and 118 (see FIGS. 5 and 9), respective, extending from sides 120 and 122, respectively, of the engaging member 96. The engaging member 96 further includes a first major surface 126 to engage the inner surface 98 of the flange 70 as shown in FIGS. 6 and 7, and an opposite major surface 128. End portion 130 of the engaging member 96 having the cylindrical ends 116 and 118 is rounded between the sides 120 and 122 of the engaging member 96. With specific reference to FIG. 6, considering end 136 of the engaging member 96 to be in the 12 o'clock position, the end portion 130 has a first plurality of elongated inclined teeth 132 extending from the side 120 to the side 122 of the engaging member 96 (see FIG. 5) between the 5 o'clock and the 9 o'clock positions as viewed in FIG. 6, and a second plurality of elongated inclined teeth 134 extending from the side 120 to the side 122 of the engaging member 96 between the 3 o'clock and the 4 o'clock positions.

In the non-limiting embodiment of the invention shown in FIGS. 6-8, the major surfaces 126 and 128 of the engaging member 96 are not parallel to one another to reduce the radius of the arc of the end 136 of the engaging member 96 as the engaging member moves toward and away from the base 88 in the manner discussed below. This reduction in the radius of the arc is not limiting to the invention and can be beneficial when the size of the space in which the engaging member 96 is expected to move is limited. As can be appreciated by those skilled in the art, the invention contemplates having the surfaces 126 and 128 parallel to one another.

The engaging member 96 is biased to rotate along a reciprocating path designated by the number 142 (see FIG. 6) by a pair of coil springs 144 and 146 mounted on the ends 116 and 118 of the engaging member between the sides 120 and 122, respectively of the engaging member and the upright members 108 and 110 on the surface 106 of the base 88. The biasing action of the springs 144 and 146 is provided by positioning arm 148 of the spring 144 against the upright member 108; positioning arm 150 of the spring 146 against the upright member 110, positioning other arm 152 of the spring 144 against the major surface 128 of the engaging member 96, and other arm 154 of the spring 146 against the major surface 128 as clearly shown in FIG. 5.

With reference to FIGS. 6 and 7, the base 88 of the first mounting device 86 is securely mounted on the ceramic band 76 on the inner marginal edge portions 89, or if the ceramic band is not used, mounted on the inner marginal edge portions 89, of the transparency 83 of the panel 95 in any convenient manner, e.g. by an adhesive or mechanical fasteners, e.g. but not limiting to the invention by drilling holes in the transparency 83 and securing the base 88 of the device 86 to the transparency 83 using screws (not shown). In a preferred non-limiting embodiment of the invention, the base 88 is secured to the ceramic band 76 or to the inner marginal edge portions 89 of the transparency 83 by an adhesive layer 164 applied to bottom surface 166 of the base 88. The invention is not limited to the type of adhesive used, e.g. the adhesive layer 164 can be a similar to the type used for the adhesive layer 60 used to secure the transparency 58 to the flange 70 as shown in FIG. 3. As will be appreciated, the adhesive layer 164 should have sufficient strength, e.g. preferably greater than 200 pounds tensile strength and more preferably greater than 500 pounds tensile strength to prevent separation of the mounting devices and the transparency 83 due to normal pulling and/or pushing of the transparency. With continued reference to FIGS. 6 and 7, the bottom surface 166 of the base 88 has a pair of keyways 169 to provide additional engagement area for the adhesive layer 164 to adhere.

With reference to FIGS. 5-7, the base 88 of the mounting device 86 has a first elongated restraining member 170 pivotally mounted in the surface 106 of the base 88 to engage a predetermined one of the first plurality of inclined teeth 132, and a second elongated restraining member 172 pivotally mounted in the surface 106 of the base 88 to engage a predetermined one of the second plurality of inclined teeth 134. With specific reference to FIGS. 6 and 6A, the first elongated restraining member 170 has a rounded end 174 captured in groove 176 in any convenient manner to rotate pawl 178 along reciprocating path 180 toward and away from the surface 106 to selectively engage or disengage one of the first plurality of teeth in a manner discussed below. Although not liming to the invention, the first elongated restraining member 170 is rotatably captured in the base 88 by providing the groove 176 in the surface 106 of the base 88 with a recess less than the diameter of the rounded end 174. With reference to FIGS. 6 and 6B, the second elongated restraining member 172 has a rounded end 182 captured in groove 184 in any convenient manner to rotate pawl 186 and activating member 188 along reciprocating path 190 toward and away from the surface 106 of the base 88 to selectively engage or disengage one of the second plurality of teeth 134 when the activating member 188 is spaced from the surface 106 of the base 88, and to move the pawl 186 out of engagement with selected one of the second plurality of teeth 134 when the activating member 188 is moved toward the surface 106 of the base 88, e.g. into slot 192 formed in the surface 106 of the base 88 (see FIG. 6B). Although not limiting to the invention, the second elongated restraining member 172 is rotatably captured in the base 88 by providing the recess of the groove 184 at the surface 106 of the base 88 with a spaced distance less than the diameter of the rounded end 182 of the second elongated restraining member 172.

In the following non-limiting embodiment of the invention, the panel 95 is mounted in the recess 72 in the body 43 of the van 30 (van shown in FIG. 1). The peripheral dimensions and configuration of the transparency 83 is not limiting to the invention. In general, the transparency 83 for a quarter window 42 has a generally rectangular shape with the sides 90 and 92 having a length of 2.5 feet and the sides 91 and 93 having a length of 2 feet. With reference to FIGS. 6 and 7, the adhesive layer 164 is applied to the bottom surface 166, and into the keyways 169, of the base 88 of the first mounting device 86 to secure the mounting device 86 to the ceramic band 76 on the inner marginal edge portions 89 of the transparency 83 to provide the panel 95. Two of the devices 86 are mounted spaced from one another along each side of the transparency 83 spaced 1 inch from the peripheral edge, e.g. the side 92 of the panel 95 and equally spaced from one another (see FIG. 4).

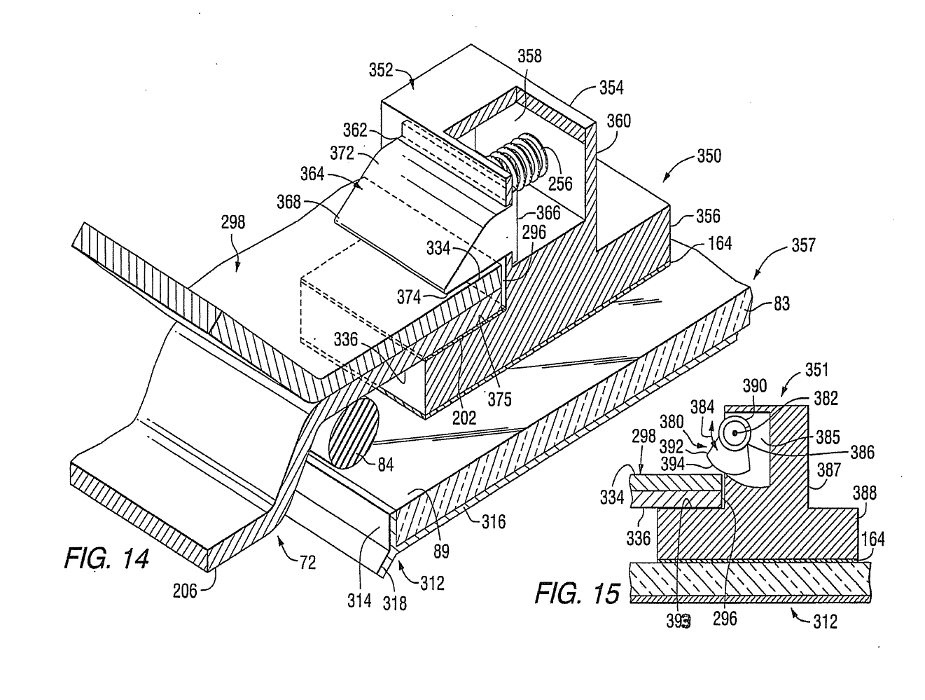

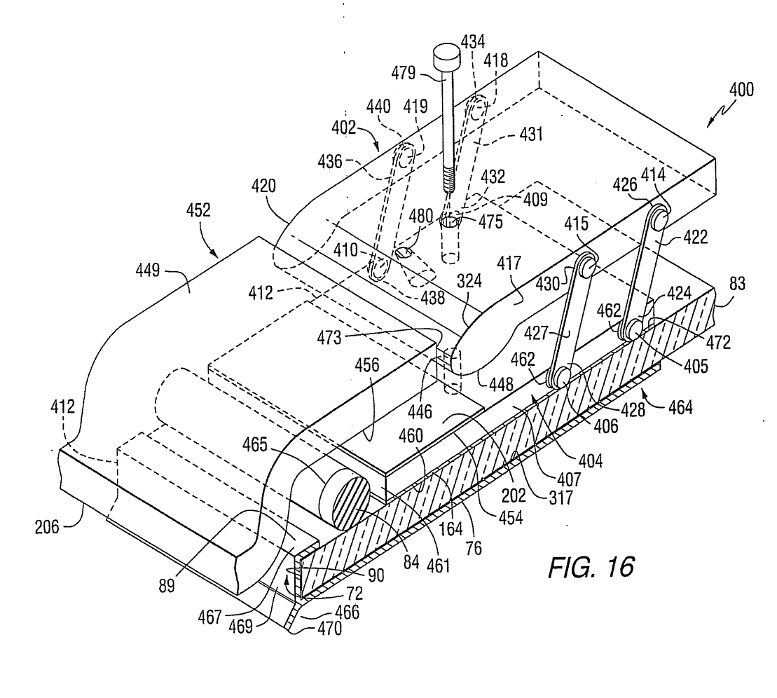

Prior to or after securing, preferably after securing, the mounting devices 86 to the transparency 83, the weather seal 84, e.g. but not limiting to the invention, a butyl layer or rope (see FIGS. 6 and 7) of the type discussed above having a tacky surface is applied to the ceramic band 76 on the inner marginal edge portions of the transparency 83 to encircling the mounting devices 86 with the ends (shown in FIG. 16 as ends 465) of the weather seal contacting one another. As discussed above, the weather seal 84 does not have to have structural strength because the mounting devices of the invention secure the panel 95 in the recess 72. Optionally the edge trim 74 (see FIG. 7) is provided around the sides 90-93 of the transparency 83 of the panel 95.

With reference to FIGS. 6 and 6A, the first elongated restraining member 170 is pivoted to move along the reciprocating path 180 away from the spring based member 96, e.g. and not limiting to the invention in a counterclockwise direction as viewed in FIG. 6A. The engaging member 96 is moved away from the surface 106 of the base 88, e.g. and not limiting to the invention in a counterclockwise direction as viewed in FIG. 6 to an upright position against the biasing action of the springs 144 and 146 (see FIG. 5). With the engaging member 96 in the vertical or mounting position, the pawl 186 of the second elongated restraining member 172 (see FIG. 6B) is in engagement with one of the teeth of the second plurality of teeth 134 to position the engaging arm 96 in the mounting or non-engaging position against the biasing action of the coil springs 144 and 146 (see FIG. 5). With all the engaging arms 96 of the first mounting devices 86 in the mounting position as shown in FIG. 6, the panel 95 is in the mounting position.

The panel 95 is moved into the recess 72, see FIG. 6. Movement of the panel toward the flange 70 moves the activating members 188 of the first mounting devices 96 against portions of the outer surface 68 of the flange 70 to move the activating member 188 toward the slot 192 in the surface 106 of the base 88 (see FIG. 6B). As the activating member 188 moves toward the slot 192, the pawl 186 moves out of engagement with a tooth of the second plurality of teeth 134, and the engaging member 96 moves under the biasing action of the springs 144 and 146 toward and into engagement with portions of the inner surface 98 of the flange 70 as shown in FIG. 7. To further bias the engaging member 96 against the flange 70, the panel 95 and/or the engaging member 96 can be manually pushed toward the flange 70, and the first elongated restraining member 170 moves toward the first plurality of teeth 132 to move the pawl 178 into engagement with one of the teeth of the first plurality of teeth 132 to lock the engaging member 96 of the device 86 against the inner surface 98 of the flange 70 and capture the flange between the engaging member 96 and the surface 106 of the base 88. Biasing the panel 95 against the outer surface 68 of the flange 70 flows the butyl rope 84 to provide a water barrier seal between the transparency 83 and the flange 70.

With continued reference to FIGS. 6 and 7, to minimize or eliminate noise due to movement of the van resulting in vibrations that move the flange 70 and mounting devices relative to one another, a layer 202 of a noise absorbent material or a material with surface friction, e.g. but not limited to the invention, a strip of urethane having a tacky surface, e.g. but not limiting to the invention RT0140 is provided on the surface 126 of the engaging member 96. After the panel 95 is fixedly mounted in the recess 72, trim, e.g. interior trim (not shown) if removed from the interior side of the recess or exterior trim (not shown) if removed from the exterior side of the recess is replaced.

As can be appreciated the invention is not limited to the number of teeth in the first or second plurality of teeth 132 and 134, respectively, and the first plurality of teeth 132 can have more or less than 6, and/or the second plurality of teeth 134 can have more or less than 2, as shown in FIGS. 6 and 7. The number of teeth in the second plurality of teeth 134 is selected to maintain the engaging member 96 in an upright position as shown in FIG. 7 to move the engaging member 96 and the flange 70 past one another to move the activating member 188 and the outer surface 68 of the flange 70 into contact with one another. The number of teeth and the spacing of the teeth in the first plurality of teeth 132 are selected to provide for a firm and tight engagement of the flange 70 between the engaging member 96 and the surface 106 of the base 88 of the device 86.

Further as can be appreciated, the invention is not limited to the material of the engaging member 96 and the base 88 of the mounting device 86 or how components of the device 86 are joined together. In the practice of the invention, the arm, the shaft and the base are machined metal, however the invention contemplates forging or casting the base and the arm. Further the invention contemplates making the arm out of plastic, wood, and/or glass and/or metal reinforced plastic. Still further as can be appreciated the dimensions of the mounting device 86 are not limiting to the invention. In one non-limiting embodiment of the invention the base 88 of the mounting device 86 had a length of 52 millimeters (“mm”), a width of 21 mm, and the engaging member 96 had a length of 33.5 mm.

In a preferred non-limiting embodiment of the invention, the distance between outer surface 204 of the panel 95 and the surface 106 of the base 88 of the device 86 is generally equal to the distance between the outer surface 68 of the flange 70 and outer surface 206 of the body 43 of the van 30. In this manner, the outer surface 204 of the panel 42 is generally flush with the outer surface 206 of the van 30.

As is appreciated, the invention is not limited to the number of mounting devices mounted on a transparency 83. In one non-limiting embodiment of the invention, the number of devices per side of the transparency is a function of the expected force to be applied to the transparency to move it out of the recess and/or the force required to compress the weather seal 84 to provide a watertight seal. The factors to be considered, but not limiting to the invention include the adhesive strength of the adhesive layer 164, the compressibility of the weather seal, the length of the sides 90-93 of the transparency 83, the biasing force of the springs 144 and 146 (see FIG. 5) of the mounting device 86, and the shear strength of the pawl 178 and the first plurality of teeth 132. In a preferred practice of the invention, the center to center spacing between adjacent mounting devices 86, and the spacing between the center of a mounting device and an adjacent side of the panel 42, is no greater than 10 inches with at least one mounting device at each side of the panel.

### Second Mounting Device

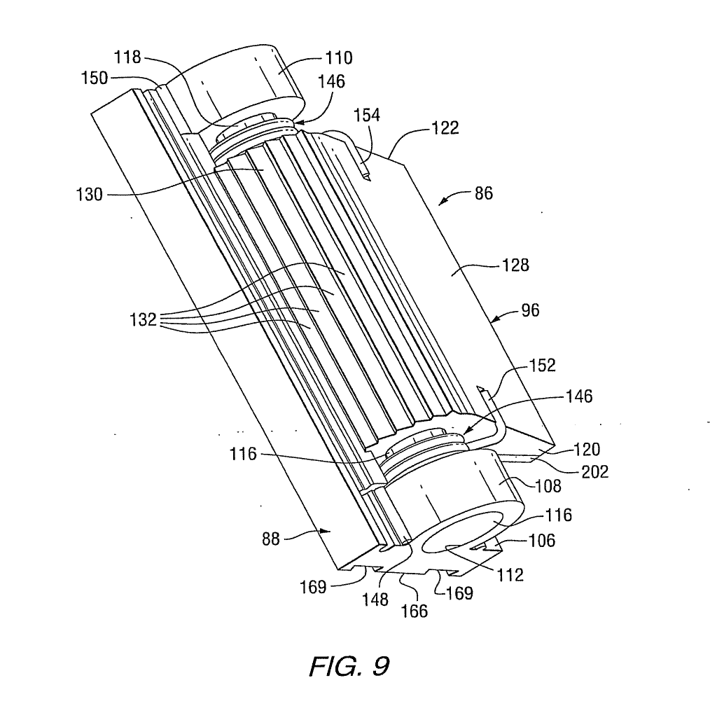

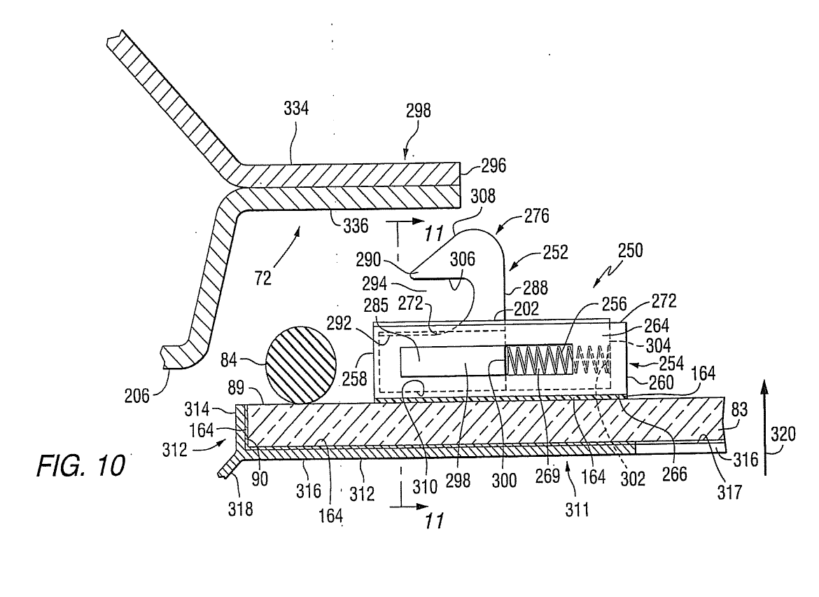

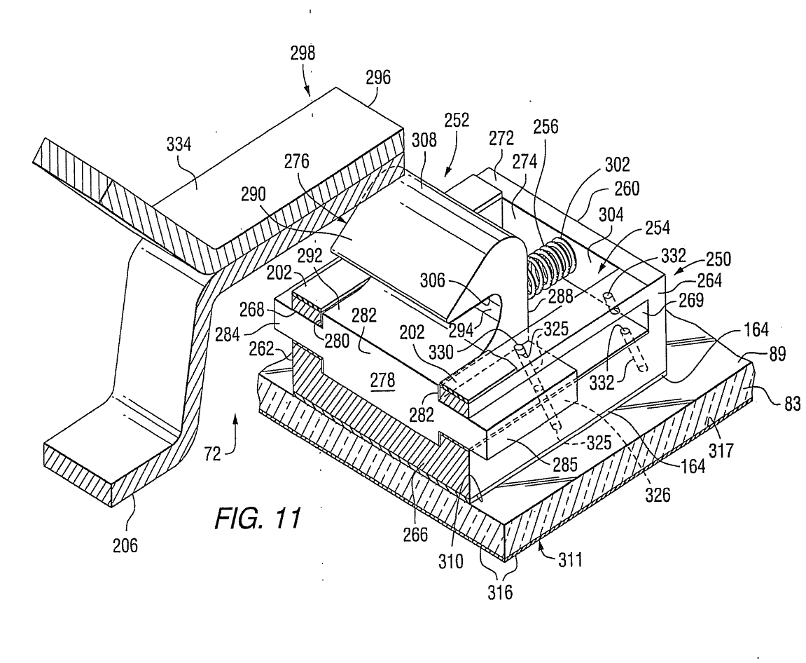

Shown in FIGS. 10-13 is a second non-limiting embodiment of a mounting device of the invention designated by the number 250 having a spring biased engaging member 252. The engaging member 252 is moveable mounted in any convenient manner in a housing 254 and biased in any convenient manner, e.g. by coil spring 256 toward an end, e.g. end 258 of the housing 254 (see FIGS. 10, 12 and 13). With particular reference to FIGS. 10 and 11, the housing 254 further includes an end 260 opposite the end 258 and a pair of opposed sides 262 and 264 with the ends 258 and 260, and the sides 262 and 264 extending upward from a base 266. Each of the sides 262 and 264 has a slot 268 and 269 (see FIG. 11), respectively extending between the ends 258 and 260. Upper end or topside 272 of the housing 254 has a recess or slot 274 (see FIG. 11) extending between the ends 258 and 260 through which edge receiving member 276 of the engaging member 252 of the mounting device 250 extends.

The edge receiving member 276 of the engaging member 252 is mounted on platform 278, or the engaging member and the platform formed as one piece. The platform is slideably mounted in the housing 254 to move between the ends 258 and 260. The invention is not limited to the manner in which the platform 278 is slideably mounted in the housing 254. For example and not limiting to the invention, opposed sides 280 and 282 of the platform 278 each has an extension 284 and 285, respectively which extends through the slots 268 and 269 in the sides 262 and 264, respectively. The edge receiving member 276 in cross section, e.g. as viewed in FIGS. 10, 12 and 13 has an inverted “L” shape having long leg 288 of the “L” extending upward from the platform 278, and short leg 290 of the “L” extending over surface 292 of the platform 278 (clearly shown in FIG. 11) to provide the engaging member 252 with a groove 294 to receive end 296 of flange 298 (see 18 FIG. 13) in a manner discussed below. One end, e.g. end 300 of the coil spring 256 is secured to the platform 278 of the engaging member 252 and opposite end 302 of the spring 256 is secured to inner surface 304 of the end 260 of the housing 254 to bias the engaging member 252 toward the end 258 of the housing 254.

Although not limiting to the invention, the surface 292 of the platform 278 is below the upper surface 272 of the housing 254. With this arrangement the width of the groove 294 of the engaging member 252 is the distance from lower surface 306 of the short leg 290 of the engaging member 252 facing the housing 254 and the upper surface 272 of the housing 254. Upper surface 308 of the short leg 290 of the engaging member 252 is sloped toward end of the groove 294, i.e. sloped toward the end 258 of the housing 254 as shown in the FIGS. 10, 12 and 13 for ease of moving the end 296 of the flange 298 and the upper surface 308 of the engaging member 252 relative tone another in a manner discussed below to move the engaging member 252 toward the end 260 of the housing 254 against the biasing action of the spring 256.

The adhesive layer 164 secures bottom surface 310 of the housing 254 of a plurality of the second mounting device 250 and the inner marginal edge portions 89 of the transparency 83 together with the mounting devices 250 in spaced relationship to one another to provide a panel 311. The mounting devices 250 are mounted on the transparency 83 with the open end of the groove 294 of the engaging member 252 facing adjacent one of the sides 90-93 of the transparency 83 (side 90 of the transparency shown in FIGS. 10, 12 and 13). A continuous length of the weather seal 84 is applied to the inner marginal edge portions 89 of the transparency 83 to encircle the mounting devices 250 with ends of the weather seal 84 contacting one another. Although not limiting to the invention, a gasket 312 having a generally “Y” shaped cross section is applied to the sides of the transparency 83 in any convenient manner, e.g. but not limiting to the invention, leg 314 of the gasket 312 (see FIGS. 10, 12 and 13) is secured to the peripheral side, e.g. the side 90 of the transparency 83; leg 316 of the gasket 312 is secured to outer marginal edges 317 of the transparency, and leg 318 of the gasket extends away from the transparency. The legs 314 and 316 of the gasket 312 are secured to the transparency 83 by the adhesive layer 164, and the leg 316 of the gasket on the outer marginal edges 317 of the transparency 83 extends over the adhesive layer 164 as shown in FIGS. 10-13 to prevent UV degradation of the adhesive layer 164 and the weather seal 84, and to hide the mounting device from view. Optionally the leg 316 of the gasket 312 can be made narrower, and the layer 76 of the ceramic paint fired on the inner marginal edge portions 89 of the transparency 83 of the panel 311 as shown for the transparency 83 of the panel 95 shown in FIGS. 6 and 7 to prevent UV degradation of the adhesive layer 164 and the weather seal, and to hide the mounting device.

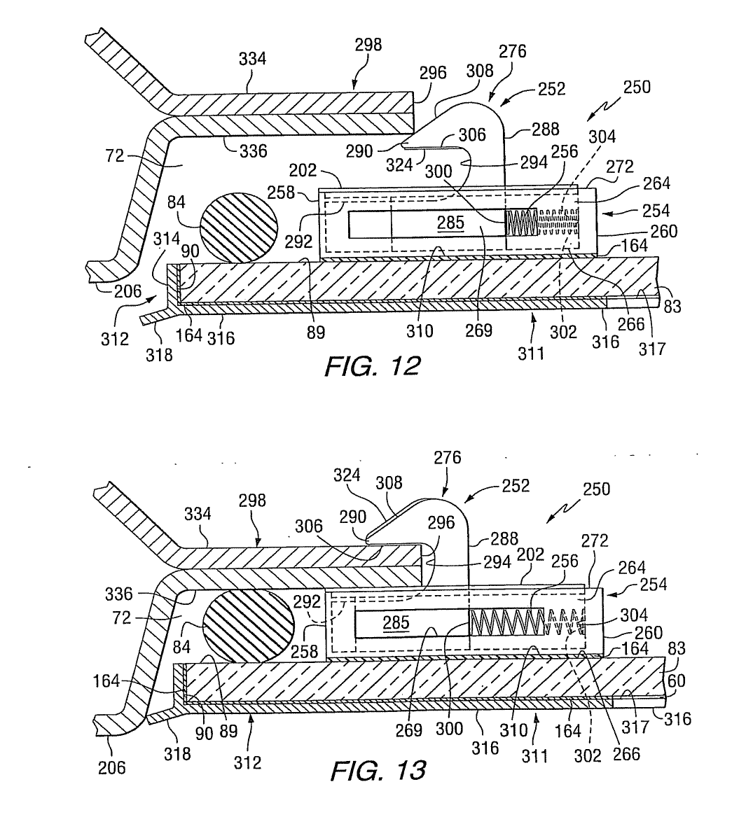

With specific reference to FIGS. 10, 12 and 13, the panel 311 is moved along a path in the direction of the arrow 320 (shown only in FIG. 10) into recess 72 toward the flange 298 defining the recess 72. The panel 311 as it moves along the path moves the upper surface 308 of the short leg 290 of the engaging member 252 into engagement with the end 296 or outer corner of the flange 298. Continued movement of the panel 311 along the path 320 slides the upper surface 308 of the engaging member 252 along the end 296 of the flange 298 moving the engaging member 252 against the biasing action of the coil spring 256 (see FIG. 12); after the leg 290 of the engaging member 252 moves past the end 296 of the flange 298, the biasing action of the coil spring 256 moves the surface 306 of the leg 290 of the engaging member 252 over the inner surface 334 of the flange 298 to capture the flange in the groove 294 of the engaging member 252 as shown in FIG. 13, i.e. the surface 306 of the engaging member contacts inner surface 334 of the flange 298, and the outer surface 336 of the flange contacts the surface 272 of the housing 254, or the layer 202 of the friction material applied to the surface 272 of the housing 254 (the surface 272, and the combination of the layer 202 and the surface 272 also referred to as a supporting surface). The leg 318 of the gasket 312 contacts outer surface 206 of the van 30, and the weather seal 84 adheres to the flange 298 and the panel 311 to prevent fluid from moving through the recess 72 into the van.

Although not limiting to the invention, the layer 202 of the friction material is mounted on the upper surfaces 272 of the sides 262 and 264 of the housing 254 as shown in FIG. 11 to eliminate movement of the flange 298 along the surface 272 of the housing 254. Further and not limiting to the invention, a layer 324 of a low friction material, e.g. of the type sold under the registered trademark TEFLON can be applied to the surface 308 of the short leg 290 (shown only in FIG. 13), and/or applied to the surface 306 of the short leg 290 (shown only in FIG. 12), of the engaging member 252. As can further be appreciated, the surface 292 of the platform 278 of the engaging member 252 can extend above the upper surface 272 of the housing 254 and cooperate with the surface 306 of the leg 290 to form the groove 294.

In the preferred practice of the invention but not limiting the invention thereto, the engaging member 252 can be locked in the engaging position in any convenient manner after the flange 298 is in the groove 294 of the engaging member 252. For example and not limiting to the invention, a non-limiting embodiment of a locking arrangement (shown only in FIG. 11), includes a passageway 325 extending through the sides 262 and 264 (passageway 325 shown only in side 264), and a passageway 326 extending through the extensions 284 and 285 of the platform 278 (passageway 326 shown only through the extension 285 in FIG. 11) of the engaging member 252. With the engaging member 252 engaging the flange 298, i.e. the engaging member 252 biased away from the end 260 of the housing, the passageways 325 and 326 are aligned to receive a shaft 330, which is secured in the passageways 324 and 326 to lock the engaging member 252 in the engaging position.

For ease of removing the panel 311 from the recess 72, a passageway 332 can be provided in each of the sides 262 and 264 (in FIG. 11, the passageway 332 shown only in the side 264). To remove the panel 311, the mounting device 250 is put in the non-engaging position by moving the engaging member 252 toward the end 260 of the housing 254 against the biasing action of the coil spring 256 to align the passageway 326 in the extensions 284 and 285 with its respective one of the passageways 332. The shaft 330 is moved into the passageways 326 and 332 to maintain the engaging member 252 spaced from the end 296 of the flange 298.

As can be appreciate the invention is not limited to the configuration of the housing 254 and the engaging member 252. For example and not limiting to the invention shown in FIGS. 14 and 15 are third and fourth, respectively, non-limiting embodiments of mounting devices of the invention designated by the numbers 350 and 351, respectively.

### Third Mounting Device

More particularly, the third mounting device or mounting clip 350 shown in FIG. 14 includes a housing 354 mounted on a base 356. The housing and the base can be joined together or formed as a unitary piece. The base 356 is mounted to the inner marginal edge portions 89 of transparency 83 by the adhesive layer 164 to provide the panel 357. The housing 354 has a passageway 358 having a closed end 360 and an opposite open end 362. An engaging member 364 has end portion 366 captured in the passageway 358 in any convenient manner, e.g. and not limiting to the invention by having the end portion 366 of the engaging member 364 larger than the open end 362 of the passageway 358. Opposite end portion 368 is biased toward and extends out of the open end 362 of the passageway 358 by the biasing action of the coil spring 256. Although not limiting to the invention, the closed end 360 of the passageway 358 can include a removable wall portion, e.g. a threaded cap (not shown) to provide for positioning the engaging member 364 and the coil spring 256 in the passageway 358.

The end portion 368 of the engaging member 364 extending out of the housing 354 has a sloping surface 372 (similar to the upper surface 308 of the engaging member 252 of the mounting device 250, see FIG. 10) that engages the end 296 or outer corner of the flange 298 to move the engaging member 364 into the passageway 358 against the biasing action of the coil spring 256 as the panel 357 moves into the recess 322 in a manner similar to the engaging member 252 of the mounting device 250 moving against the biasing action of the coil spring 256 of the mounting device 250 (see FIGS. 10-13) as the engaging member 252 is moved against the end 296 or outer corner of the flange 298 as shown in FIG. 12. Opposite surface 374 of the engaging member 364 has a flat surface to engage the inner surface 334 of the flange 298 as shown in FIG. 14 after the engaging member 364 moves past the end 296 of the flange 298, and the outer surface 336 of the flange contacts the friction layer 202 on supporting surface 375 of the base 356. The panel 357 is secured in the recess 72.

As can be appreciated, the invention contemplates a layer 324 of the low friction material on the sloping surface 372 and/or the flat surface 374 of the engaging member 364.

### Fourth Mounting Device

The engaging member 352 of the mounting device 250 shown in FIGS. 10-13, and the engaging member 364 of the mounting device 350 shown in FIG. 14 is mounted for reciprocating motion along a linear path, however, the invention is not limited thereto, and the invention contemplates mounting engaging members for movement along a path of any configuration. For example, and not limiting to the invention, in FIG. 15, engaging member 380 of the fourth mounting device 351 is mounted on axis 382 for pivotal motion along reciprocating circular path 384 to move into and out of recess 385 of tower 387 secured on base 388. A spring 390 is mounted on the axis 382 and acts on the engaging member 380 to bias the engaging member 380 out of the recess 385. As the end 296 or outer corner of the flange 298 contacts engaging surface 392 of the engaging member 380, the engaging member 380 is moved into the recess 385 of tower 387 against the biasing action of the spring 390. After the end 296 of the flange 298 moves past the engaging surface 392 of the engaging member 380, the inner surface 334 of the flange 298 is engaged by the retaining surface 394 of the engaging member 380 moved out of the recess 385 by the action of the spring 390.

As can be appreciated the layer 324 of the low friction material can be provided on the engaging surface 392 and the retaining surface 394 of the engaging member 380, and the layer 202 of a friction material can be provided on the supporting surface 393 of the base 388. As can further be appreciated, interior of the recess should be shaped to accommodate the outer shape of the engaging member 380.

### Fifth Mounting Device

Shown in FIGS. 16-18 is a fifth non-limiting embodiment of a mounting device or mounting clip of the invention designated by the number 400. The mounting device 400 includes engaging member 402 mounted on a base 404 for reciprocating movement relative to one another in any convenient manner. For example and not limiting to the invention, the base 404 includes a pair of spaced stub shafts 405 and 406 extending from side 407 of the base 404, and a pair of stub shafts 409 and 410 extending form opposite side 412 of the base 404. The engaging member 402 has a pair of stub shafts 414 and 415 extending from side 417 of the engaging member 402, and a pair of stub shafts 418 and 419 extending from opposite side 420 of the engaging member 402. A first strut 422 has one end 424 rotatably mounted on the stub shaft 405 of the base 404, and the other end 426 rotatably mounted on the stub shaft 414 of the engaging member 402; a second strut 427 has one end 428 rotatably mounted on the stub shaft 406 of the base 404, and the other end 430 rotatably mounted on the stub shaft 415 of the engaging member 402; a third strut 431 has one end 432 rotatably mounted on the stub shaft 409 of the base 404, and the other end 434 rotatably mounted on the stub shaft 418 of the engaging member 402, and a fourth strut 436 has one end 438 rotatably mounted on the stub shaft 410 of the base 404, and the other end 440 rotatably mounted on the stub shaft 419 of the engaging member 402.

The engaging member 402 has a rounded or bulbous end portion 446 having raised portion 448 facing the base 404. With the engaging member 402 in the engaging position as shown in FIG. 18, the raised portion 448 of the engaging member 402 engages inner surface 449 of flange 452 to bias the layer 202 of friction material on the surface portion or supporting surface 454 of the base 404 against outer surface 456 of the flange 458. As can be appreciated, the invention contemplates the practice of the invention without the layer 202 of the friction material on the supporting surface 454 in which case the supporting surface 454 is biased against the outer surface 456 of the flange 458.

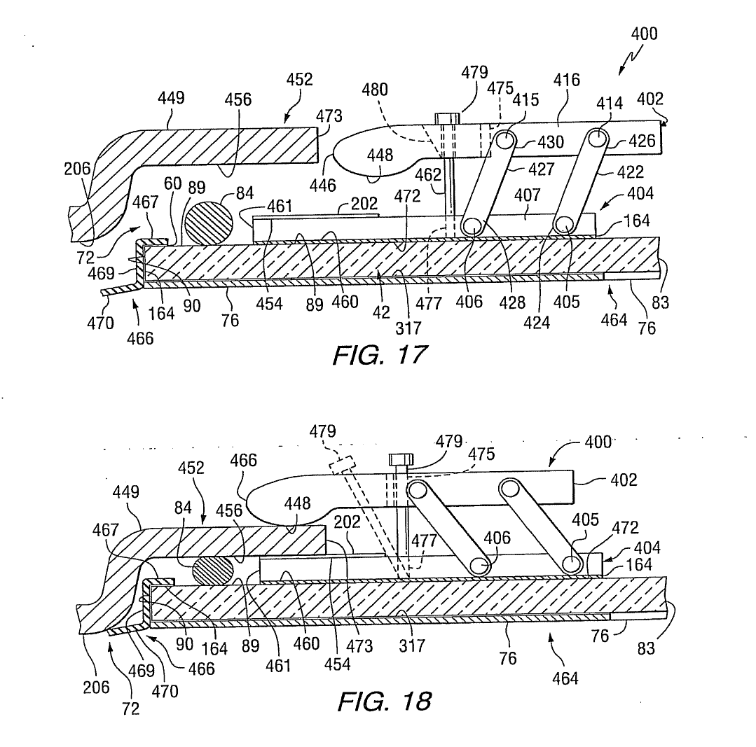

With reference to FIGS. 17 and 18, lower surface 460 of the base 404 of the mounting device 400 is securely mounted by the adhesive layer 164 to the inner marginal edge portions 89 of the transparency 83 with the rounded end portion 446 of the engaging member 402 facing the adjacent side of the transparency, e.g. the side 90 of the transparency 83. The engaging member 402 is biased toward the side 90 of the transparency and side 461 of the base 404 in any convenient manner, e.g. and not limiting to the invention by providing springs 462 on the stub shafts 405, 406, 409 and/or 410 of the base 404, and/or the stub shafts 414, 415, 418 and/or 419 of the engaging member 402 to bias the rounded end portion 446 of the engaging member 402 toward side 461 of the base 404 of the mounting device 400. The springs 462 are only shown in FIG. 16, and only shown mounted on the stub shafts 405 and 406 on the side 407 of the base 404 of the mounting device 400.

Surface 460 of each of a plurality of mounting devices 400 is securely mounted by the adhesive layer 164 to the inner marginal edge portions 89 of the transparency 83 with the mounting devices 400 in spaced relationship to one another to provide a panel 464. The ceramic band 76 is provided on the outer marginal edge portions 317 of the transparency 83 extending over the surface 472 of the base 404 to prevent UV degradation of the adhesive layers 164 and the weather seal 84. The weather seal 84 is applied to the inner marginal edge portions 89 of the transparency 83 completely encircling the mounting devices 400 with the ends of the weather seal contacting one another (the ends of the weather seal designated by the number 465 shown only in FIG. 16). A gasket 466 is provided around the outer sides 90-93 of the transparency 83 (sides 90-93 of the transparency shown in FIG. 4) in any convenient manner, e.g. by the adhesive layer 164. The gasket 466 includes a first leg 467 secured to the inner marginal edge portions 89 of the transparency 83; a second leg 469 secured to the peripheral sides 90-93 of the transparency, and a third leg 470 extending away from the peripheral side of the transparency as shown in FIGS. 16-18.

In one non-limiting embodiment of the invention, the panel 464 is moved into the recess 72 in the body of the van to move the end 446 of the engaging member 402 into engagement with end 473 or outer corner of the flange 452. Continued movement of the panel 464 into the recess 465 moves the engaging member 402 against the biasing action of the springs 462 until the end 446 of the engaging member clears the end 473 of the flange 452. As portions of the end 446 of the engaging member 402 clear the flange end 473, portions of the raised portion 448 move over the inner flange surface 449 under the biasing action of the springs 462 until the raised portion 448 of the engaging member 402 is over the inner surface 449 of the flange 448, i.e. the engaging member is in the engaging position (see FIG. 18). With the raised portion of the engaging member over the inner surface 449 of the flange 450, the panel 464 is secured in the recess 465 of the van 30.

The invention contemplates fixing or locking the engaging member 402 in the engaging position with a locking arrangement. With reference to FIGS. 16-18 as needed and not limiting to the invention, the engaging member 402 has a passageway 475 extending therethrough, and the base 404 has a threaded passageway 477 with the passageways preferably aligned when the engaging member is in the engaging position. A headed screw 479 is inserted through the passageway 475 in the engaging member into the threaded passageway 477 in the base 404 as shown in FIG. 18.

In another non-limiting embodiment of the invention, before moving the panel 464 into the recess 72, the engaging member 402 of the mounting devices 400 is moved against the biasing action of the springs 462 to the non-engaging position as shown in FIG. 17 and maintained in the non-engaging position until the panel 464 is moved into the recess 72. For example and not limiting to the invention, the engaging member 402 is provided with a second passageway 480 between the passageway 475, and the end 446, of the engaging member 402. The second passageway 480 is sized such that with the engaging member 402 in the engaging position (see FIG. 18), the shaft of the headed screw 479 extends through the second passageway 480 with the end of the screw in the recess of the passageway 477 in the base 404 as shown in phantom in FIG. 18. The screw and/or engaging member is moved against the biasing action of the springs to move the engaging member into the non-engaging position as shown in FIG. 17, and the screw threaded in the passageway 477 of the base 404 to maintain the engaging member 402 in the non-engaging position. With the mounting devices 400 in the non-engaging position, the panel 464 is moved into the recess 465 to move the end 446 of the engaging member 402 past the end 473 of the flange 452 to move the weather seal 84 against the outer surface 456 of the flange 452 and the third leg 470 of the gasket 466 against the outer body surface 206 of the van 30. With the panel in the recess 72, the screw 479 is removed from the passageway 477 in the base 404, and the engaging member 402 moves under the biasing action of the springs 462 to move the end 446 of the engaging member 402 over the inner surface 449 of the flange 452; the engaging member is in the engaging position as shown in FIG. 18.

The panel 464 is removed from the recess 72 in any convenient manner. For example and not limiting to the invention, with the engaging members 402 in the engaging position, the screw 470 is used as discussed above to move the engaging member 402 of the mounting devices 400 from the engaging position to the non-engaging position. With the engaging members 402 are in the non-engaging position as shown in FIG. 17, the panel is moved out of the recess.

As can be appreciated, the layer 324 of the low friction material (see FIG. 16) can be provided on the surface of the rounded end portion 446 of the engaging member 402.

### Sixth Mounting Device

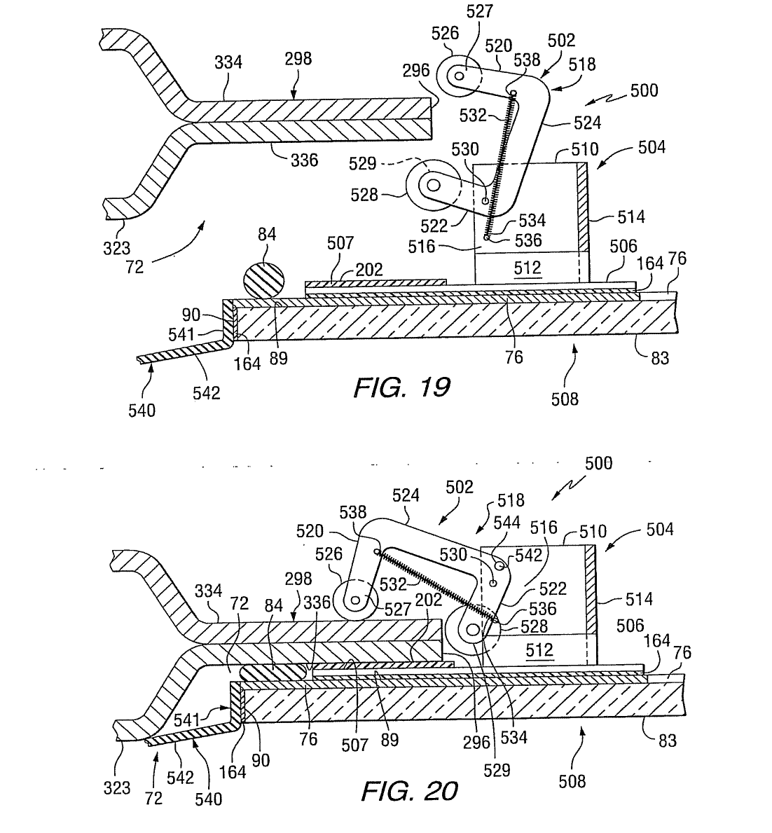

Shown in FIGS. 19 and 20 is a sixth non-limiting embodiment of a mounting device of the invention designated by the number 500. The mounting device 500 includes a spring biased engaging member 502 pivotally mounted in housing 504. The housing 504 is mounted on a platform 506 secured to the ceramic band 76 fired on the inner marginal edge portions 89 of the transparency 83 by the adhesive layer 164 to provide a panel 508 incorporating features of the invention. The platform 506 has a supporting surface 507 extending from the housing 504 toward the adjacent one of the peripheral sides 90-93 (see FIG. 4), e.g. peripheral side 90 to engage the outer surface 336 of the flange 298 in a manner discussed below. The housing 504 has a generally U-shaped cross section having a first wall 510, and opposite second wall 512 (only bottom portion of the second wall 512 shown in FIGS. 19 and 20) interconnected by a third wall 514 with recess 516 of the housing 504 between the walls 510 and 512 facing adjacent one of the peripheral sides 90-93 of the transparency 83.

The engaging member 502 includes an arm member 518 having a bifurcated first arm 520 and an opposite bifurcated second arm 522, each connected to an intermediate arm 524 providing the arm member 518 with a U-shaped cross section as seen in FIGS. 19 and 20. In a non-limiting embodiment of the invention, a wheel 526 is rotatably mounted to end 527 of the first arm 520, and a wheel 528 is rotatably mounted to end 529 of the second arm 522, of the arm member 518. The arm member 518 is pivotally mounted on a shaft 530 secured to the first and second walls 510, 512 (shown only secured to the wall 510 in FIGS. 19 and 20) of the housing 504. The shaft 530 passes through the arm member 518 adjacent the second arm 522 and the intermediate arm 524 such that with the engaging member 502 in the non-engaging position as shown in FIG. 19, moving the wheel 528 in a counter clockwise direction, moves the wheel 526 in a counter clockwise direction moving the engaging member from the non-engaging position to the engaging position, and with the engaging member in the engaging position as shown in FIG. 20, moving the wheel 526 in the clockwise direction moves the wheel 528 in the clockwise direction to move the engaging member from the engaging position to the non-engaging position.

A spring 532 has one end 534 mounted to an elongated member or pin 536 passing through the first and second walls 510,512 of the housing 504 and other end 538 of the spring 532 secured to the arm member 518 adjacent the first arm 520 and the intermediate arm 524. The shaft 530 and the pin 536 engaging the end 534 of the spring 532 are positioned relative to one another, for example, but not limiting to the invention, the pin 536 is mounted below and vertically aligned with the shaft 530 such that with the engaging member 502 in the non-engaging position as shown in FIG. 19, the spring 532 biases the second arm 522 having the wheel 528 away from the third wall 514 of the housing 504, e.g. in a clockwise direction as viewed in FIGS. 19 and 20, and with the engaging member 502 in the engaging position as shown in FIG. 20, the spring 532 biases the second arm 522 having the wheel 528 toward the third wall 514 of the housing 504, e.g. in a counterclockwise direction as viewed in FIGS. 19 and 20.

In one non-limiting embodiment of the invention, the weather seal 84 is applied to the inner marginal edge portions of the 89 of the transparency 83 of the panel 508 encircling the mounting devices 500 with the ends of the weather seal 84 joined together. A gasket 540 has a leg 541 secured to the peripheral sides 90-93 (only side 90 shown in FIGS. 19 and 20) of the transparency 83 by the adhesive layer 164, and has other leg 542 extending away from the transparency 83 to engage the outer surface 323 of the van 30 surrounding the recess 72 in the body of the van when the panel 508 is secured in the recess 72. The panel 508 is moved into the recess 72 to move the wheel 526 on the first arm 520 past the end 296 of the flange 298 to move the wheel 528 on the second arm 522 of the engaging member 502 into engagement with the outer surface 336 of the flange 298. Continued movement of the panel 508 into the recess 72 moves the engaging member 502 in a counter clockwise direction moving the wheel 528 on the second arm 522 toward the third wall 514 of the housing 504, the wheel 526 on the first arm 520 into engagement with the inner surface 334 of the flange 298, and the outer surface 336 of the flange 298 into engagement with the layer 202 of the friction material on the supporting surface 507 of the platform 506 to capture the flange 298 between the engaging member 502 and the supporting surface 507 of the platform 506 to fixedly secure the panel 508 in the recess 72 as shown in FIG. 20.

As can be appreciated the spring 532 can be used as a locking arrangement to lock the engaging member 502 in the engaging or non-engaging position, however, the invention contemplates the use of a locking arrangement in addition to the spring 530. For example and not limiting to the invention, a threaded locking pin 542 passing through holes 544 in each of the walls 510, 512 of the housing 504 (shown in FIG. 20 only in the wall 510), and one of the arms 520, 522,524 of the arm member 518, e.g. the middle arm 524 shown in FIG. 20 to maintain the engaging member 502 in the engaging position. Further the invention contemplates having stationary members in place of the rotating wheels 526,528. When stationary members are used, it is preferred, but not limiting to the invention, to apply the layer 324 of a low-friction material (see FIG. 13) to the surface of the stationary members. Further, the invention contemplates using the layer 324 of a low-friction material on the surface of rotating wheels 526 and 528.

The panels 508 can be removed from the recess 72 in any convenient manner, e.g. and not limiting to the invention, if a locking arrangement is used, the locking arrangement is disengaged; the engaging members 502 of the mounting devices 500 are moved to the non-engaging position, and the panel 508 is moved out of the recess 72.

### Seventh Mounting Device

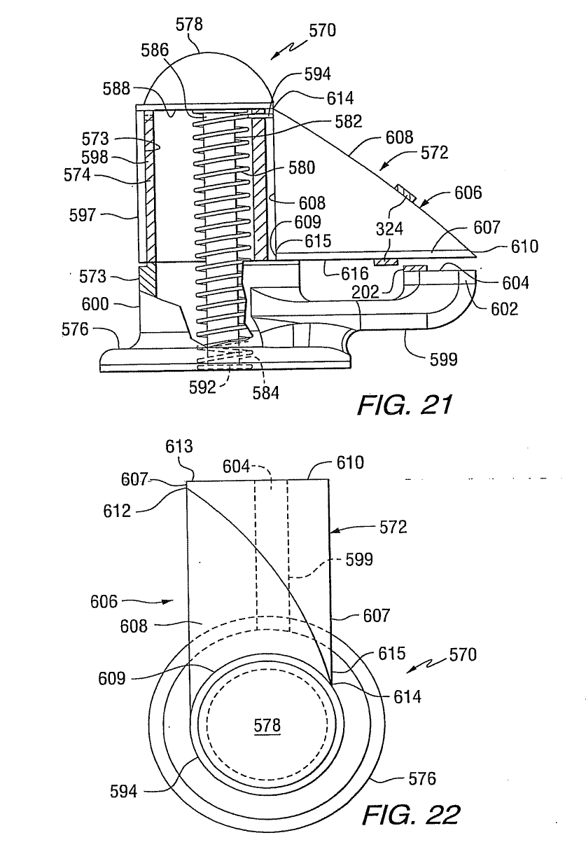

Shown in FIGS. 21-24 is a seventh non-limiting embodiment of a mounting device or mounting clip of the invention designated by the number 570 having a spring biased engaging member 572 captured for rotational motion on outer surface 573 of cylindrical hollow housing 574 (clearly shown in FIG. 21) in a manner discussed below. With continued reference to FIG. 21, the cylindrical housing 574 extends upwardly from a base 576 and has a cap 578 secured on open end 579 of the cylindrical housing 574 in any convenient manner, e.g. by an adhesive or providing the cap 578 and the open end 579 of the cylindrical housing 574 with threads. A coil spring 580 is mounted on a shaft 582 mounted in the cylindrical housing 574 in any convenient manner, e.g. but not limiting to the invention, end 584 of the shaft 582 is mounted to the base 576 and opposite end 586 of the shaft 582 is mounted on inner surface 588 of the cap 578. End 592 of the spring 580 is secured against movement in any convenient manner, e.g. mounting the end 592 of the spring 580 to the shaft 582 or the base 576 of the mounting device 570 with opposite end 594 of the spring 580 extending out of the cylindrical housing 574 through slot 596 (shown in phantom and shown only in FIG. 21). The end 594 of the spring 580 is connected to the engaging member 572, e.g. sleeve 597 of the engaging member 572 to bias the engaging member 572 toward and into the engaging position as shown in FIGS. 21 and 24.

The sleeve 597 of the engaging member 572 is preferably captured on upper portion 598 of the outer surface 573 of the cylindrical housing 574 in any convenient manner, e.g. and not limiting to the invention, the outside diameter of the upper portion 598 of the cylindrical housing 574 is less than the diameter of the cap 578 at the juncture of the open end 579 of the housing 574 and the cap 578, and less than the diameter of lower portion 600 of the cylindrical housing 574 to provide a circular channel to capture the sleeve 597 for rotational motion around the upper portion 598 of the outer surface 573 of the cylindrical housing 574.

An arm 599 extends outward from the base 576 and terminates in a platform 602 having a supporting surface 604 to support or engage the outer surface 456 of the flange 452. With reference to FIGS. 21 and 22, the engaging member 572 has an engaging arm 606 having a plate 607 having side 609 secured to the sleeve 597 and a sloping surface member 608 extending upward from the plate 607 and outward from the cylindrical sleeve 597. Side 610 of the plate 607 opposite to the side 609 extends over the supporting surface 604. The sloping surface member 608 has one end 612 at corner 613 of the plate 607 and curves upward to top portion 614 of the sleeve 597 spaced above corner 615 of the plate 607.

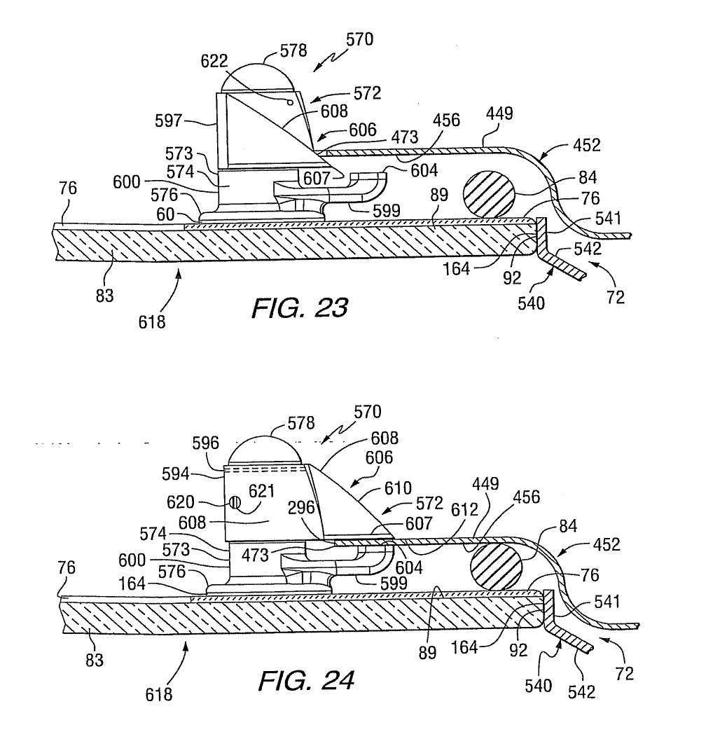

The arm 599 and the supporting surface 604 are aligned with the plate 607 such that the engaging member 572 in the engaging position has a portion of bottom surface 616 (see FIG. 21) of the plate 607 of the engaging arm 606 over the supporting surface 604 of the platform 602 and the biasing action of the coil spring 580 is about zero. The height, the length, and the curvature, of the sloping surface member 608 of the engaging arm 599 are selected such that a turn of 90-180 degrees of the engaging arm 606 from the engaging position moves the engaging arm 606 from the engaging position to a non-engaging position having the plate 607 of the engaging arm 606 moved from over the supporting surface 604 of the platform 602 so that the supporting surface 604 is exposed to receive the outer surface 456 of the flange 452 (see FIG. 23).

As can be appreciated the mounting device 570 can be constructed in any manner from any type of material. In a non-limiting embodiment of the invention, the mounting device is made of metal. The spring 580 mounted on the shaft 582 is mounted in the cylindrical housing 574 and the end 592 of the spring 580 connected to the sleeve 591. The cap 578 is secured to the open end 579 of the cylindrical housing 574 in any convenient manner as previously discussed.

In the practice of the invention, the base 576 of each of a plurality of the mounting device 570 is secured to the ceramic band 76 fired on the inner marginal edge portions 89 of the transparency 83 by the adhesive layer 164 with the mounting devices in spaced relationship to one another to provide a panel 618. The elongated gasket 541 is applied to the peripheral sides 90-93 of the transparency 83 (only side 92 shown in FIGS. 23 and 24) by the adhesive layer 164 as previously discussed. The weather seal 84 is applied to ceramic band 76 on the inner marginal edge portions 89 of the transparency 83 encircling the mounting devices 570 with the ends of the weather seal joined together. With the mounting devices 570 in the engaging position as shown in FIG. 21, the panel 618 is moved into the recess 72 in the body of the van 30 to move the sloping surface member 608 of the engaging arm 606 of the engaging member 572 into contact with the end 473 or outer corner of the flange 452. Continued movement of the panel 618 into the recess 72 moves the end 473 or the outer corner of the flange 452 along the surface of the sloping surface member 608 to rotate the engaging member 572 against the biasing action of the spring 580 to move the engaging member 572 from the engaging position (see FIG. 21) toward the non-engaging position (see FIG. 23). When the engaging arm 606 of the engaging member 572 is in the non-engaging position, the end 473 of the flange 452 clears the plate 607 of the engaging arm 606, and the outer surface 456 of the flange 452 contacts the supporting surface 604 of the platform 602. With the end 473 of the flange 452 moved past the plate 607, the engaging arm 599 is free to move under the action of the spring 580 to move the engaging member 572 to the engaging position as shown in FIG. 24 with the plate 607 of the engaging arm 606 of the engaging member 572 over the inner surface 449 of the flange 452.

In the preferred practice of the invention, the layer 202 of friction material (a segment of the layer 202 shown in FIG. 20) is provided on the supporting surface 604. As can be appreciated but not limiting to the invention, the sloping surface member 608 of the engaging arm 606 and/or the bottom surface 616 of the plate 607 of the engaging arm 606 can be coated with the layer 324 of a low friction material (segments of the layer 324 shown FIG. 12), or in the alternative the engaging member 572 or parts thereof can be made of low-friction material, e.g. a low-friction material of the type sold under the registered trademark TEFLON.

Although not limiting to the invention a locking arrangement can be used to lock the engaging arm 572 in the engaging position and/or non-engaging, e.g. but not limiting to the invention, a screw 620 can be passed through a hole 621 in the sleeve 597 of the engaging member 572 and threaded into wall of the cylindrical housing 574 (see FIG. 24).

The panel 618 is remove from the recess 72 in any convenient manner, e.g. and not limiting to the invention, the engaging member 572 is moved to the non-engaging position and secured in position by the securing arrangement, e.g. but not limiting the invention thereto, by the screw 620 passed through a second hole 622 (see FIG. 23) in the sleeve 597 of the engaging member 572 spaced from the first hole 621 or through the first hole 621, and threaded into the wall of the cylindrical housing 574 (see FIG. 23). With all the engaging members 572 of the mounting devices 570 in the non-engaging position, the panel 618 is removed from the recess 72 of the van.

### Eighth Mounting Device

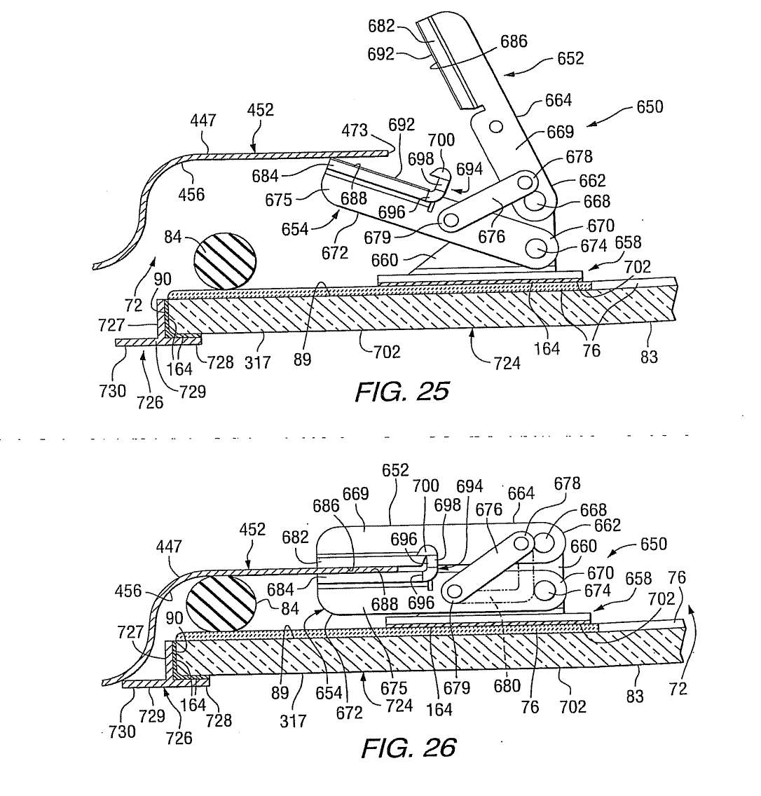

With reference to FIGS. 25-27 there is shown an eighth non-limiting embodiment of a mounting device of the invention designated by the number 650. The mounting device 650 includes upper jaw member 652 and lower jaw member 654 to engage the flange 452 defining the recess 72 in the body 53 of the van 30 (see FIG. 1) to mount the transparency 83 in the recess 72 in a manner presented below. The mounting device 650 further includes a plate or platform 658 having a wall member 660 extending therefrom with the jaw members 652 and 654 pivotally mounted thereon in any convenient manner.

In one-non-limiting embodiment of the invention, the upper jaw member 652 has end 662 of elongated member 664 pivotally mounted to the wall member 660 by a double headed rivet 668 passing through side surface 669 of the elongated member 664 and the wall member 660, and the lower jaw member 654 has end 670 of elongated member 672 pivotally mounted to the wall member 660 by a double headed rivet 674 passing through side surface 675 of the member 672 and wall member 660 as shown in FIGS. 25-27. The rivets 668 and 674 are preferably vertically aligned with one another, and an elongated arm member 676 has one end 678 pivotally mounted on the elongated member 664 of the upper jaw 652, and other end 679 pivotally mounted on the elongated member 672 of the lower jaw member 654. The distance between the pivot point of the end 678 of the arm 676 and the rivet 668 (the “first distance”) is less than the distance between the pivot point of the end 679 of the arm, 676 and the rivet 674 (the “second distance”). As is appreciated by those skilled in the art, with this arrangement an incremental upward or downward displacement of the upper jaw member 652, moves the lower jaw member 654 in a likewise direction for a fraction (“displacement fraction”) of the distance of the first jaw member 652. The value of the displacement fraction depends on the ratio of the first distance to the second distance. As the ratio of the first distance to the second distance increases, the fraction of displacement decreases, and vise versa. Further as can now be appreciated by those skilled in the art, the elongated arm member 676 shown as a linear member can have different shapes e.g. an “L” shape as shown for member 680 shown in phantom in FIG. 26.

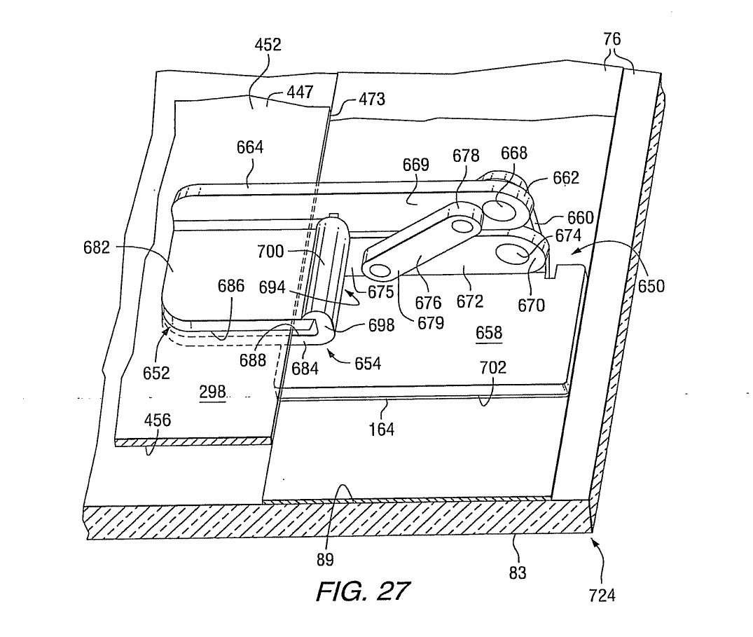

The upper jaw member 652 has a flat engaging jaw 682 secured to the side surface 669 of the elongated member 664 (clearly shown in FIG. 27), and the lower jaw member 654 has a flat engaging jaw 684 secured to the side surface 675 of the elongated member 672. In one non-limiting embodiment of the invention, surface 686 or lower surface 686 of the flat engaging jaw 682, and surface 688, or upper surface 688 of the flat engaging jaw 684 each have the layer 202 of a friction material (not shown in FIGS. 25-27, see in FIG. 14) to eliminate sliding motion of inner and outer surfaces 447, 456 of the flange 452 relative to the flat engaging jaws 682 and 684, respectively. In another non-limiting embodiment of the invention, one of the surfaces 686 or 688 of the flat engaging jaws 682 and 684, respectively, e.g. the surface 686 of the upper jaw 682, has the layer 202 of the friction material, and the other one of the surfaces 688 or 686, e.g. the surface 688 of the lower jaw 684 has the layer 324 of the low or non-friction material (not shown in FIGS. 25-27, see in FIG. 12). The layer 202 of the friction material and the layer 324 of the low or non-friction material are each designated by the number 692 and only shown in FIG. 25.

Although not limiting to the invention, a locking arrangement is provided to lock the jaw members 652 and 654 in the engaging position, i.e. portions of the flange 452 captured between the jaw members 652 and 654 as shown in FIGS. 26 and 27. In one non-limiting embodiment of the invention, and with reference to FIGS. 25-27 as needed there is shown locking arrangement 694 mounted on side 696 of the flat engaging jaw 684 of the lower jaw member 654. The locking arrangement 694 has an elongated vertical member 698 connected to the side 696 of the flat engaging jaw 684, and has an elongated horizontal member 700 spaced from and extending over the flat engaging jaw 684. The distance between the horizontal member 700 and the flat engaging jaw 684 is sufficient to engage side of the flat engaging jaw 682 of the jaw member 652 with the flange 452 between the flat engaging jaws 682, 684 as shown in FIGS. 26 and 227.

In a non-limiting embodiment of the invention, surface 702 of the platform 658 of each one of a plurality of the mounting devices 650 is securely mounted in spaced relationship to one another by the adhesive layer 164 on the ceramic band 76 fired on the inner marginal edge portions 89 of the transparency 83 to provide panel 724. The weather seal 84 is positioned on the ceramic band to encircle the mounting devices 650 with the ends of the weather seal contacting one another. An elongated gasket 726 having a “T” shaped cross-section, with a vertical leg 727 secured to the peripheral sides 90-93 (only side 90 shown in FIGS. 25-27) of the transparency 83 by the adhesive layer 164. Portion 728 of horizontal leg 729 of the “T” shaped gasket is secured by the adhesive layer 164 to the outer marginal edge portions 317 of the transparency 83, and portion 730 of the horizontal leg 729 of the “T” shaped gasket extends away from its respective side 90-93 of the transparency 83 to engage the outer body surface of the van 30 when the panel 724 is secured in the recess 72 as shown in FIG. 26.

The mounting devices 650 are set in the non-engaging position as shown in FIG. 25, and the panel 724 is moved into the recess 72 to move the jaw member 652 past the end 473 of the flange 452 and to move the outer surface 456 of the flange 452 into contact with the upper surface 688 of the flat engaging jaw 684. Continued movement of the panel 724 into the recess 72 moves the lower jaw member 654 toward the transparency 83 and the upper jaw member 652 toward the inner surface 447 of the flange 452 to capture portions of the inner and outer surfaces 447 and 456 respectively of the flange 452 between the jaw members 652 and 654 of the mounting devices 650 and to move the elongated horizontal leg 700 of the locking arrangement 694 into engagement with the side of the flat engaging jaw 682 to securely mount the panel 724 in the recess 72.

The panel 724 is removed from the recess 72 in any convenient manner. In one non-limiting embodiment of the invention, the elongated horizontal leg 700 of the locking arrangement 694 of each of the mounting devices 650 is released from the flat engaging jaw 682, and the panel 724 is moved out of the recess 72. As the panel 724 moves out of the recess 72, the flange 452 moves the upper jaw member 652 away from the lower jaw member 654. When the end 473 of the flange 452 moves past the flat engaging jaw 682 of the upper jaw member 652, the mounting devices 650 are in the non-engaging position, and the panel 72 is moved out of the recess 72. As can be appreciate, the invention contemplates using a spring to bias at least one of the flat engaging jaws 682 and/or 684 into the non-engaging position or to use a friction coupling between the rivets 668 and 674 and it respective one of the elongated arm members 672 and 676, to maintain the mounting devices 650 in the non-engaging position.

### Ninth Mounting Device

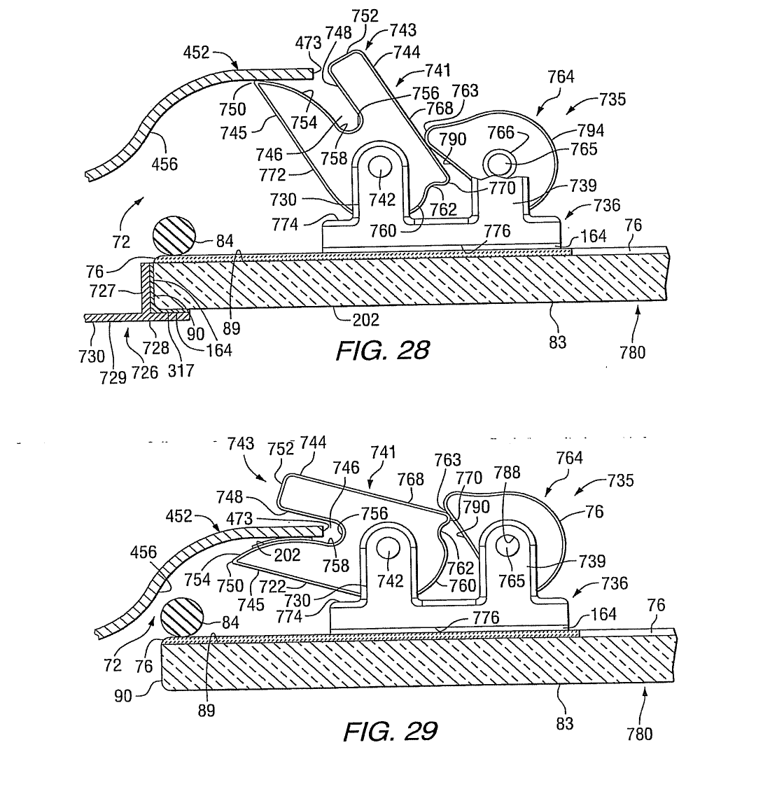

With reference to FIGS. 28-31, there is shown a ninth non-limiting embodiment of a mounting device of the invention designated by the number 735. The mounting device 735 has a base 736 and a first pair of spaced vertical struts 737 and 738, and a second pair of spaced vertical struts 739 and 740 (struts 738 and 740 shown only in FIG. 31 and shown only in phantom) extending away from the base 736. Jaw engaging member 741 is mounted between the struts 737 and 738 on a shaft 742 for reciprocating rotational motion. The shaft 742 has it ends secured in struts 737 and 738 in any convenient manner, e.g. but not limiting to the invention by a pressure fit. End 743 of the jaw-engaging member 741 has a pair of leg members 744 and 745 spaced from one another to provide a groove 746 for receiving the end 452 of the flange 473 in a manner discussed below. The leg member 744 in cross section has a generally rectangular shape with long flat side 748 forming an inside wall of the groove 746. The leg member 745 has an end 750 that extends beyond end 752 of the leg member 744 to contact outer surface 456 of the flange 452 in a manner discussed below. Surface portion 754 of the leg member 745 from the end 750 toward base 756 of the groove 746 is curved and as it approaches the base 756 of the groove 746 has a flat portion 758 generally parallel to the flat side 748 of the leg member 744 (clearly shown in FIGS. 28-30). Opposite end 760 of the jaw engaging member 741 has a tab receiving recess 762 for receiving tab 763 of locking member 764 in a manner discussed below.

The locking member 764 is mounted between the struts 739 and 740 on shaft 765 for reciprocating rotational motion and biased by a spring 766 shown only in FIG. 28 mounted on the shaft 765 in any convenient manner to move the locking member 764 in a counter clockwise direction as viewed in FIGS. 28-31 to bias the tab 763 against upper surface 768 of the jaw engaging member 741 as shown in FIGS. 28 and 29. In practice, moving the jaw engaging member 741 in a counter clockwise direction moves a portion of the upper surface 768 of the jaw engaging member against the tab to move the tab of the locking member in a clockwise direction. After lip 770 adjacent the recess 762 of the jaw engaging member 741 moves past the tab 763, the tab 763 moves into the recess 762. The jaw engaging member 741 is now locked in the engaging position. More particularly, the jaw engaging member 741 is prevent from moving in a counterclockwise direction by bottom surface 772 of the engaging member 741 contacting upper surface 774 of the base 736, and from moving in a clockwise direction by the tab 763 in the recess 762.

In a non-limiting embodiment of the invention, bottom surface 776 of the base 736 of each one of a plurality of the mounting devices 735 is secured in spaced relationship to one another by the adhesive layer 164 on the ceramic band 76 fired on the inner marginal edge portions 89 of the transparency 83 to provide panel 780. The weather seal 84 is positioned on the ceramic band 76 to encircle the mounting devices 735 with the ends of the weather seal contacting one another. The elongated gasket 726 (shown only in FIG. 28) having a “T” shaped cross-section, has the vertical leg 727 secured to the peripheral sides 90-93 (only side 90 shown in FIGS. 25-27) of the transparency 83 by the adhesive layer 164. The portion 728 of the horizontal leg 729 of the “T” shaped gasket 726 is secured by the adhesive layer 164 to the outer marginal edge portions 317 of the transparency 83, and the portion 730 of the horizontal leg 729 of the “T” shaped gasket extends away from its respective side 90-93 of the transparency 83 to engage the body of the van 30 when the panel 724 is secured in the recess 72.

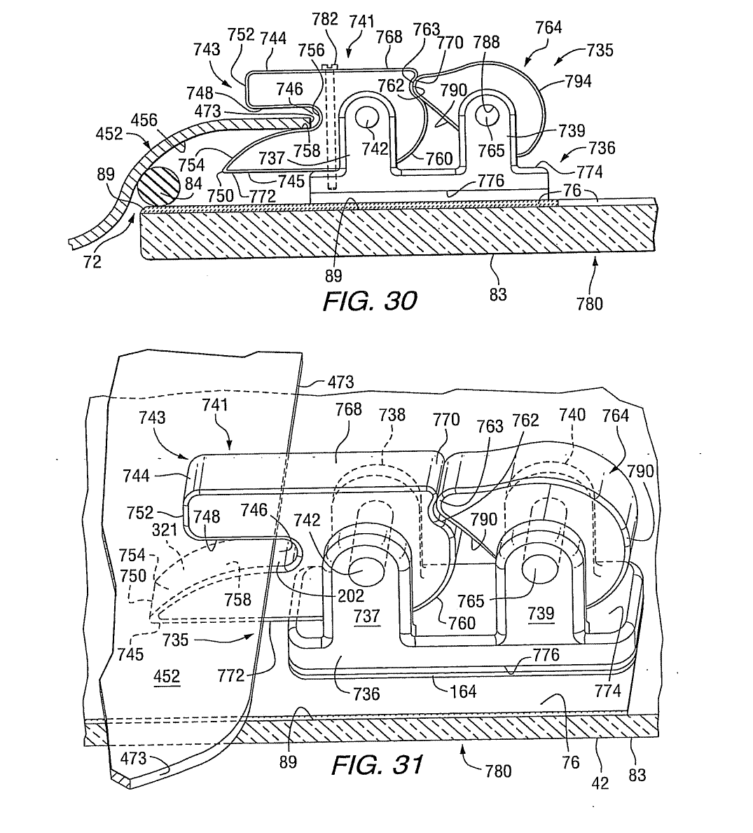

The mounting devices 735 are set in the non-engaging position as shown in FIG. 28, and the panel 780 is moved into the recess 72 to move the outer surface 456 of the flange 452 into contact with the curved surface portion 754 of the jaw engaging member 741. Continued movement of the panel 780 into the recess 72 moves the jaw engaging member 741 toward the base 736 of the mounting device 735 and toward the transparency 83 of the panel 780 to move the flange 452 further into the groove 746 and move the lip 770 of the jaw engaging member 741 against the tab 763 of the locking member 764. The locking member 746 moves in a clockwise direction against the biasing action of the spring 766 until the lip 770 moves past the tab 763 of the locking member and the recess 762 is in position to receive the tab 763. Optionally the threaded end of the screw 782 (shown only in FIG. 30) is moved through the jaw engaging member 741 and threaded into the base 736 to secure the jaw engaging member in the engaging position.

The panel 724 is removed from the recess 72 in any convenient manner. In one non-limiting embodiment of the invention, the screw 782 is removed from the jaw engaging member 741, and the jaw engaging member 741 moved counter clockwise to move the locking member 764 clockwise. The locking member 764 is moved further in the clockwise direction against the biasing action of the spring 760 to move the tab 763 out of the recess 762. The jaw engaging member is released after which the locking member is release. The tab 763 under the action of the spring 766 moves against the upper surface 768 of the jaw engaging member. As the panel 780 moves out of the recess 72, the flange 452 moves the jaw engaging members of the mounting devices to the non-engaging positions (see FIG. 28), and the panel 780 is moved out of the recess 72.

Although not limiting to the invention and with reference to FIG. 31, the inner surface of the leg member 745 of the jaw engaging member 741 can be coated with the layer 321 of the low or non friction material adjacent the end 750 to easily move the end 473 of the flange 452 toward the groove 746, and the inner surface of the leg member 745 adjacent the groove 746 can be coated with the layer 202 of a friction material to minimize or prevent sliding of the flange 452 in the groove 746, of the engaging member 740. Further, in the instance when the base 736, the jaw engaging member 741 and the locking member have sharp corners the corners can be beveled, e.g., as designated by number 790 only for the locking member 764 in FIG. 31.

### Tenth Mounting Device

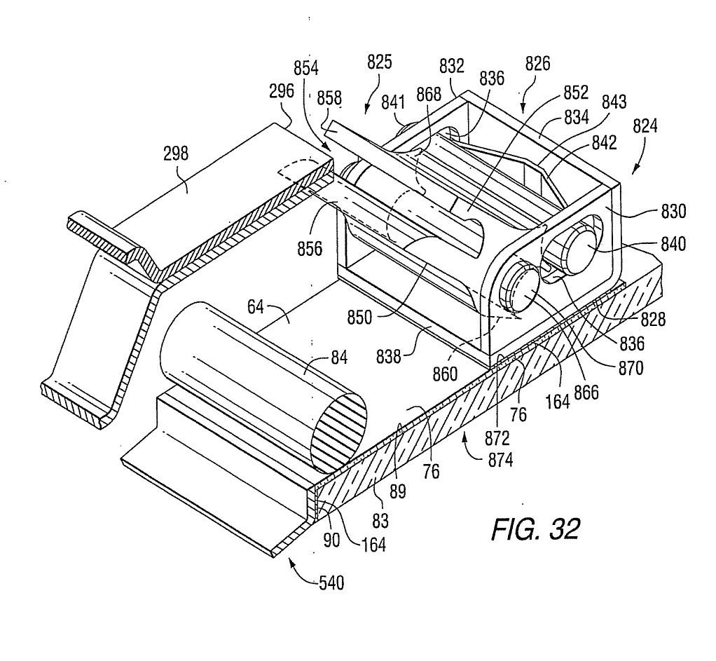

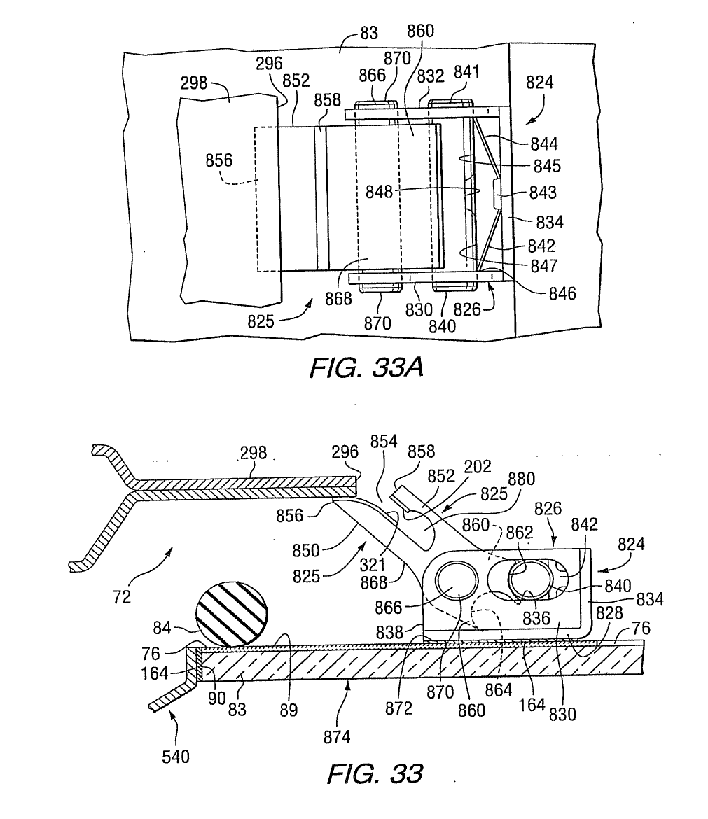

With reference to FIGS. 32-35A, there is shown a tenth non-limiting embodiment of a mounting device of the invention designated by the number 824. The mounting device 824 includes an engaging member 825 mounted in a housing 826. The housing 826 has a base 828 and a pair of side walls 830 and 832, and a backwall 834 in contact with and extending between the sidewalls 830 and 832. Each of the sidewalls 830 and 832 has a slot 836 extending from a position adjacent the backwall 834 toward opposite open end 838 (clearly shown in FIG. 32) of the housing 826, e.g. but not limiting to the invention to about the midpoint between the backwall 834 and the open end 838 of the housing 826. One end of a cylinder 840, e.g. but not limiting to the invention a solid cylinder is mounted in the slot 836 of the sidewall 830, and opposite end of the solid cylinder 840 is in the slot 836 of the other sidewall 832 and captured to slide between the ends of the slot 836, in any convenient manner. With reference to FIG. 33A, a leaf spring 842 is mounted at 843 on the backwall 834 and has one end 844 captured in groove 845 formed in the cylinder 840 and other end 846 of the spring 842 captured in groove 847. The grooves 845 and 847 are interconnected by recess 848, which is sized to receive the ends 844 and 846 of the spring 842 and pass the ends of the spring into their respective groove to slidably capture the ends of the springs therein. With this arrangement the spring 842 biases the cylinder 840 away from the backwall 834.

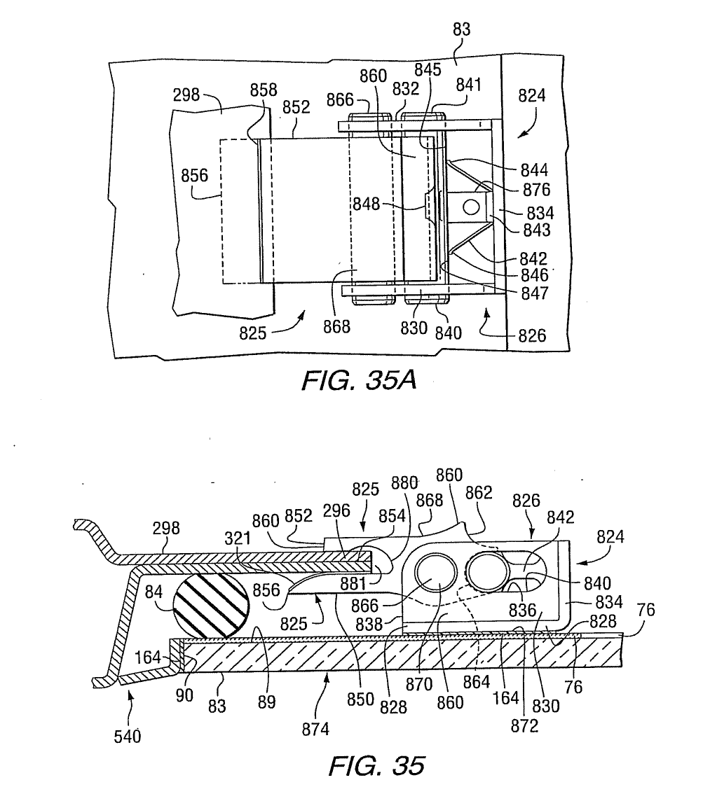

The engaging member 825 includes a flange-contacting arm 850 and a flange retention arm 852 mounted above and spaced from the flange-contacting arm 850 to provide a flange receiving recess 854 therebetween. End 856 of the flange contacting arm 850 extends beyond end 858 of the flange retaining arm 852 (clearly shown in FIG. 33A) so that the end 296 of the flange 298 can move past the end 858 of the retaining arm 852, in a manner discussed below to provide contact between the flange 298 and the flange contact arm 850. Opposite end 860 of the engaging member 825 has a first arcuate cut out 862 and a second arcuate cut out 864. A shaft 866 extends through body 868 of the engaging member 825 and has it ends 870 mounted in the sidewalls 830 and 832 of the housing 826 to pivotally move the engaging member 825 between a flange engaging position (see FIGS. 35 and 35A) and a flange non-engaging position (see FIGS. 32-33A) in a manner discussed below.

The cut outs 862 and 864, and the cylinder 840 are each sized such that the cylinder can move into the cut outs by the biasing action of the spring 842 and move out of each of the cut outs in a manner discussed below against the biasing action of the spring. Although not limiting to the invention, the distance between the center of the shaft 866 on which the body 868 of the engaging member 825 rotates and the center point of the first cut out 862 is greater than the distance between the center of the shaft 866 and the center point of the second cut out 864. In this manner, the biasing action of the spring 842 applies a greater force on the cylinder 840 when the cylinder is in the second cut out 864 (the engaging member 825 is in the engaging position, see FIGS. 35 and 35A) than the biasing force of the spring 842 applied to the cylinder 840 when the cylinder 840 is in the first cut out 862 (the engaging member 825 in the non-engaging position, see FIGS. 33 and 33A). As can be appreciated, the invention is not limited to the distance between the center of the shaft 860 and the center of the cut outs 862 and 864, and the distance can be any value.

In a non-limiting practice of the invention, bottom surface 872 of the base 828 of each of a plurality of mounting devices 824 are secured in spaced relationship to none another by the adhesive layer 164 to the ceramic band 76 at the marginal edge portions 89 of the transparency 83 to provide a panel 874. The weather seal 84 is positioned on the ceramic band 76 to encircle the mounting devices 824 with ends of the weather seal contacting one another. The gasket 540 is secured to the peripheral edges 90-93 (only peripheral edge 90 shown in FIGS. 33-35) by the adhesive layer 164 as previously discussed for the sixth mounting device. The mounting devices 824 are each put in the non-engaging position (see FIGS. 32 and 33) by rotating the body 868 of the engaging member 825 to move the flange contacting arm 850 away from the inner marginal edge portions 89 of the transparency 83 to align the first cut out 862 with the slot 836 of the sidewalls 830 and 832, i.e. to move the first cut out 862 in the path of the cylinder 840 so that the biasing action of the spring 842 moves the cylinder 840 into the first cut out 862 to maintain the engaging member 825 in the non-engaging position.

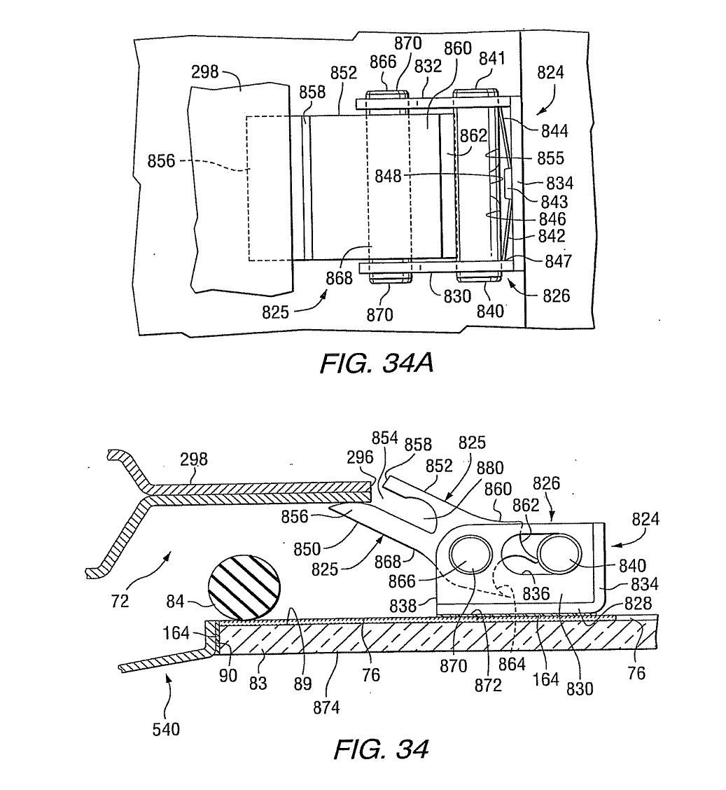

The panel 874 is moved into the recess 72 to move the flange contacting arm 850 into contact with the outer surface of the flange 298 (see FIGS. 32 and 33); continued movement of the panel 874 toward the flange 298 moves the flange contacting arm 850 toward the inner marginal edge portions 89 of the transparency 83 and toward the base 828 of the mounting devices to move the cylinder 840 against the biasing action of the spring 842 toward the backwall 834 of the housing 826 and out of the first cut out 862 (see FIG. 34). Continued movement of the panel 874 into the recess 72, moves the second cut out 864 in alignment with the cylinder 840 and moves more of the flange end 296 into the flange receiving recess 854. The spring 842 moves the cylinder 840 into the second cut out 864 to maintain the engaging member 825 in the engaging position (see in FIG. 35) to secure the panel in the recess. Optionally a block 876 (shown only in FIG. 35A) can be secured between the backwall 834 and cylinder 840 or other locking arrangement can be used to lock the engaging member 825 in the engaging position.

The panel 874 is removed from the recess 72 in any convenient manner, e.g. by reversing the steps practice to install the panel 874 in the recess 72.

Optionally the surfaces of the flange-contacting member 850 can have the layer 321 of a low friction material (see FIGS. 33 and 35), and/or the layer 202 of a friction material (see FIG. 33) on the end 858 of the flange retention arm 852. Further the retentive arm 852 and/or the flange contacting arm 850 can have an enlarged area 880 (shown only in the retentive arm 852 in FIGS. 33, 34 and 35) so as not to disturb paint globs 881 (shown only in FIG. 35) usually found at the end 296 of painted flanges. More particularly, vibrations generated by the van as it is driven can move the flange 298 relative to the surfaces of the groves 847. This motion can fracture the globs 881 exposing the underlying metal of the flange 298. As can be appreciated by those skilled in the art, chipping or removing the paint glob can cause rusting of the flange. By providing the enlarged area 880 in the flange receiving recess 854, the flange can vibrate and the paint glob 881 within the receiving recess 854 of the engaging member 825 does not come in contact with the surfaces of the recess, e.g. and not limiting to the invention with the retentive arm 852 (see FIG. 35).

### Eleventh Mounting Device

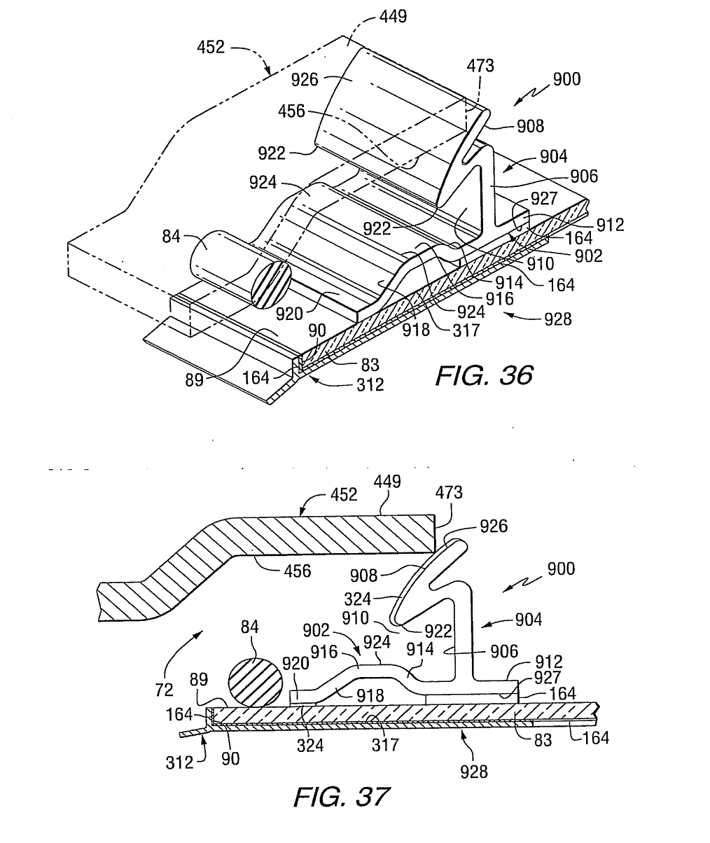

With reference to FIGS. 36-39, there is shown an eleventh non-limiting embodiment of a mounting device of the invention designated by the number 900. The mounting device 900 includes a base 902 having a flexible upright engaging member 904. The flexible member 904 includes a flexible vertical wall member 906 having a leg 908 extending over the base 902 to provide a cavity 910 to receive the end portion 473 of the flange 452 in a manner discussed below.

The base 902 includes a first segment 912 having the engaging member 904 securely attached to, or integral with the first segment 912, a second segment 914 sloping upward from the first segment 912 or sloping away from the inner marginal edge portions 89 of the transparency 83, a generally flat third segment 916 to support the outer surface 456 of the flange 452 as shown in FIG. 39, a fourth segment 918 sloping downward or toward the inner marginal edge portions 89 of the transparency 83, and a fifth flat segment 920 resting on the inner marginal edge portions 89 of the transparency 83. The distance between engaging surface portion 922 of the leg 908 contacting the inner marginal edge potions 449 of the flange 452 (see FIG. 39) and upper surface 924 of the third segment 916 of the base 902 is approximately equal to or slightly less than the thickness of the flange 452. In one non-limiting embodiment the leg 908 has a “V” shape cross-section having an upper curved surface 926, and the surface 924 of the leg 908 is curved for reasons discussed below.

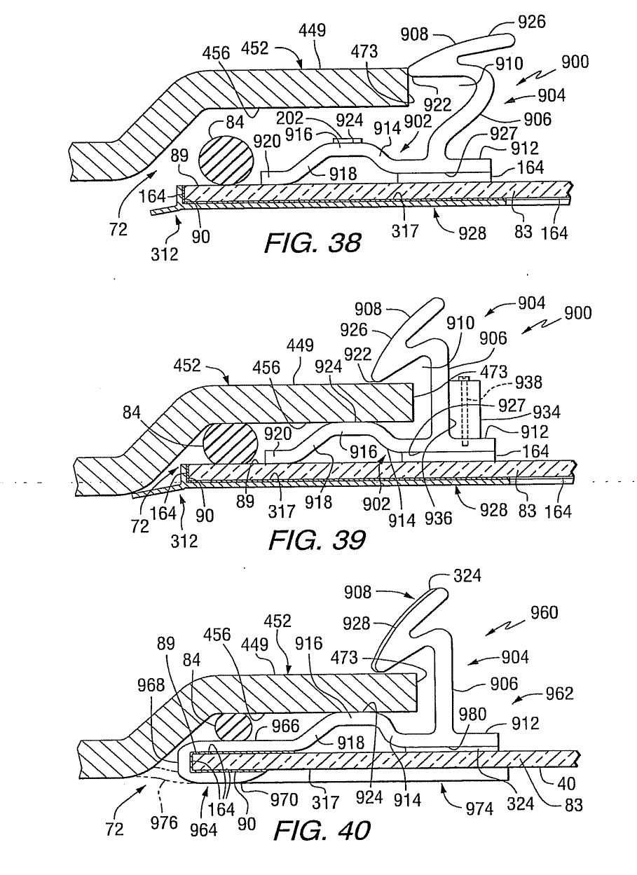

Bottom surface 927 of the first segment 912 of the base 902 of each of a plurality of mounting devices 900 is secured in spaced relationship to one another by the adhesive layer 164 to the inner marginal edge portions 89 of the transparency 83 to provide panel 928. The remaining segments 914, 916, 918 and 920 of the base 902 are unattached to the transparency 83; surface 930 of the third segment 916 of the base 902 is optionally provided with the layer 202 of friction material (shown only in FIG. 38). The weather seal 84 is positioned on the inner marginal edge portions 89 of the transparency 83 to encircle the mounting devices 900 with the ends of the weather seal contacting one another. The gasket 312 is secured to the peripheral sides 90-93 (only side 90 shown in FIGS. 36-39) and the outer marginal edge portions 317 of the transparency 83 by the adhesive layer 164 in a manner similar to the manner previously discussed for mounting the gasket 312 to the transparency 83 of the panel 311 shown in FIGS. 10-13.

The panel 928 is moved into the recess 72 moving curved surface 926 of the leg 908 into engagement with the end 473 or outer corner of the flange 452 (see FIG. 37). Continued movement of the panel 928 into the recess 72 moves the end 473 of the flange 452 over the sloping surface 926 of the leg 908 to move the leg 908 away from the end 473 of the flange 452 (see FIGS. 38 and 39); to move the flange past the leg 908, to move the outer surface 456 of the flange 452 onto the surface of the friction material 202 on the surface of the third segment 916 (see FIG. 38). The panel 928 is further moved into the recess 72 moving the flange 452 further against the third segment 916 of the base 902 moving the third segment 916 toward the inner marginal edges 89 of the transparency 83 and sliding the fifth segment 920 along the inner marginal edges 89 of the transparency 83 until the flexible upright engaging member 904 moves to its unbiased position with the surface 922 of the engaging member 904 over the inner marginal edges 449 of the flange 452. Pressure is removed from the panel and the third segment 916 of the base 902 biases the flange against the engaging surface 922 of the leg 908 of the flexible upright engaging member 904 to captured the flange 298 in the cavity 910 of the engaging member 904. As can now be appreciate, the engaging member 904 in the engaging position represents the engaging member 904 in the unbiased position with the flange 452 in the cavity 910, and the engaging member 904 in the non-engaging position represents the engaging member 904 in the unbiased position with the end 473 of the flange 452 not in the cavity 910. Although not limiting to the invention, all other positions are referred to as intermediate positions of the engaging member 904.

Although not limiting to the invention, a locking arrangement can be used to maintain or lock the flexible upright engaging member 904 in the engaging position as shown in FIG. 39. In one non-limiting embodiment of the invention, a block 934 of rigid material, e.g. metal is positioned against outer surface 936 of the engaging member 904 (shown only in FIG. 39) and secured to the first segment 912 of the base 902 in any convenient manner, e.g. by a screw 938.

The panel 928 is removed from the recess 72 in any convenient manner, e.g. but not limiting to the invention, the block 934, if present is removed, and the leg 908 of the engaging member 904 is moved away from the end 473 of the flange 452. As the leg 908 moves past the end 473 of the flange 452, the biasing action of the third segment 916 of the base moves the panel 928 away from the flange 452 a short distance to move the end 473 of the flange 452 against the engaging surface 922 of the engaging member 904 (see FIG. 38). With all the legs 908 of the engaging member 904 of the mounting devices 900 of the panel 928 out of engagement with the inner surface 449 of the flange 452, the panel 928 is moved out of the recess 72.

As can be appreciated the surface of the fifth segment 920 contacting the inner marginal edge portions 89 of the transparency 83 and the engaging surface 922 of the leg 908 contacting the flange 298 can have the layer 324 of low friction material 937 (shown only in FIG. 37).

### Twelfth Mounting Device

With reference to FIGS. 40 and 41 and with particular reference to FIG. 40, there is shown a twelfth non-limiting embodiment of a mounting device of the invention designated by the number 960. The mounting device 960 is similar to the mounting device 900 shown in FIGS. 36-39 with the differences now discussed. The mounting device 960 shown in FIG. 40 has the flexible upright engaging member 904 extending upward from base 962. The flexible engaging member 904 has the flexible vertical wall member 906 and the leg 908. The base 962 has the first segment 912, the second segment 914, the third segment 916 and the fourth segment 918. Fifth segment 964 of the base 962 extends from the fourth segment 918 and unlike the fifth segment 920 of the base 902, (see FIG. 39) has a first section 966 that extends from the fourth segment 918 of the base 962 to adjacent one of the peripheral sides 90-93 (only side 90 shown in FIG. 40) of the transparency 83; a second section 968 that extends around the peripheral sides 90-93 of the transparency 83, and a third section 970 that extends over portions of the outer marginal edges 317 of the transparency 83 as shown in FIG. 40.

In one non-limiting embodiment of the invention the fifth segment 964 of the base 962 includes the first, second and third sections 966, 968 and 970, respectively mounted to the inner marginal edges 89, the peripheral sides 90-93, and the outer marginal edges 317, respectively of the transparency 83 by the adhesive layer 164, and the first segment 912 of the base 962 is free to slide along the inner marginal edges 89 of the transparency 83. In another non-limiting embodiment of the invention, the fifth segment 964 of the base 962 includes the first and second sections 966 and 968, respectively mounted to the inner marginal edges 89, and peripheral sides 90-93, respectively of the transparency 83 by the adhesive layer 164, and the first segment 912 of the base 962 free to slide along the inner marginal edge portions 317 of the transparency 83. In still another non-limiting embodiment of the invention, the fifth segment 966 of the base 962 includes only the first section 966 mounted to the inner marginal edges 89 of the transparency 83 by the adhesive layer 164, and the first segment 912 of the base 962 free to slide along the inner marginal edges 317 of the transparency 83.

As can be appreciated by those skilled in the art, practicing the non-limiting embodiments of the invention that provide for the fifth segment 964 excluding the third section 978 requires an additional component to provide UV protection of the weather seal 84 and underlying adhesive layer 164. The invention is not limited to the components to provide the UV protection and any component can be used in the practice of the invention, e.g. and not limiting to the invention, the ceramic band 76 (see FIG. 35) can be fired on the inner marginal edges 89, the peripheral sides 90-93, and/or the outer marginal edges 317, of the transparency 83, and/or a gasket, e.g. and not limiting to the invention, the gasket 312 shown in FIG. 39 can be used. Practicing the non-limiting embodiment of the invention that provides for the fifth segment 964 to include the third section 970, the third section 970 extending over the outer marginal edges 317 of the transparency 83 will provide UV protection for the underlying adhesive layer 164 and only for underlying portions of the weather seal 84. Further having spaced third sections 970 of the fifth segment 964 on the outer marginal edges 317 of the transparency 83 most likely will be considered by some vehicle owners to be aesthetic unacceptable.

To eliminate the forgoing drawbacks and with reference to FIG. 41, a still further non-limiting embodiment of the invention contemplates providing the third section 970 of the fifth segment 964 secured to and completely covering the outer marginal edges 317 of the transparency 83, and optionally the second section 968 of the fifth segment secured to and completely covering the outer marginal edge portions of the transparency 83 as shown by the right half of FIG. 41. In another non-limiting embodiment of the invention, optionally a section 966 of the fifth segment 964 can be secured to and completely cover the inner marginal edge portions 89 of the transparency 83 of the panel 974 as shown by the left side of FIG. 41.

With reference to FIGS. 40 and 41, the fifth segment 964 of each of plurality of mounting devices 960 are secured by the adhesive layer 164 in spaced relationship to one another on the inner marginal edges 89 of the transparency 83 to provide a panel 974. The fifth segment 964 includes at lest the segment 966 and optionally the segments 968 and 970 depending on the non-limiting embodiment of the invention practice. The weather seal 84 is positioned on the inner marginal edges of the panel 974 encircling the mounting devices with the ends of the weather seal contacting one another.

The panel 974 is secured in the recess 72 and removed from the recess in a similar manner as the panel 928 having the mounting devices 900 (see FIGS. 36-39) except that as the end 473 of the flange 452 engages the upper surface 924 of the third segment 916 of the base 962 (see FIG. 40), the segment 912 of the base 962 moves along the inner major surface 89 of the transparency 83.

Optionally, a gasket 976 shown in phantom in FIG. 40 can be provide between the edges of the panel 974 and the adjacent body of the van. Further a locking arrangement can be used to maintain the engaging member 904 of the mounting device 960 in the unbiased position, e.g. but no limiting to the invention using the block 934 and screw 938 shown in FIG. 39. Further, bottom surface 980 of the first segment 912 and the surface 928 of the leg 908 of the engaging member 904 of the base 962 of the mounting device 960 can be provided with the layer 324 of the non-friction material. Still further, the surface 924 of the third segment 916 of the base 962 engaging the outer surface 456 of the flange 552 can be provide with the layer 202 of the friction material, as was discussed above for the base 902 of the mounting device 900.

### Thirteenth Mounting Device

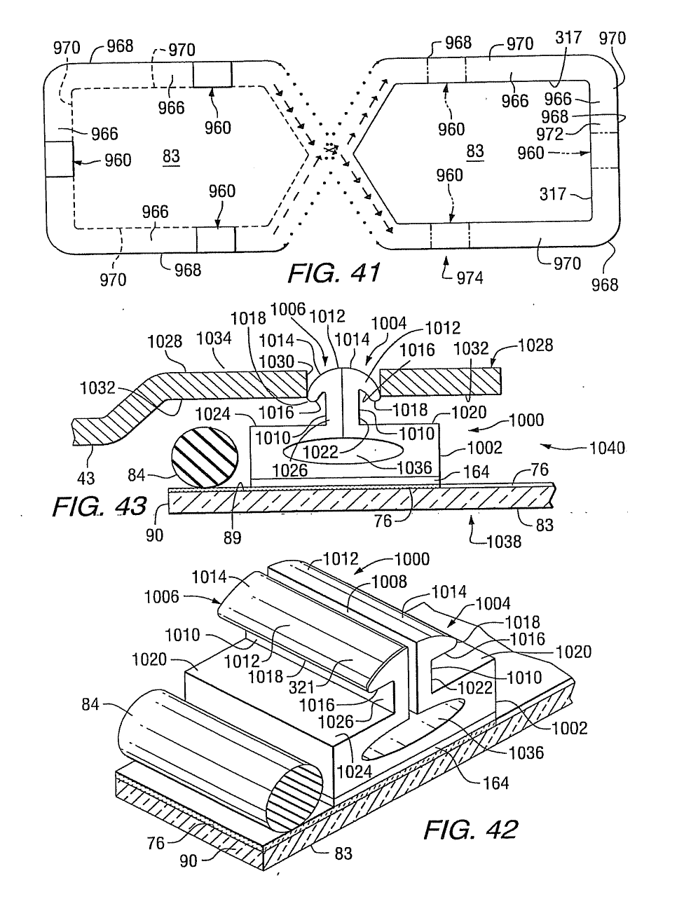

With reference to FIGS. 42-44, there is shown a thirteen embodiment of a mounting device of the invention designated by the number 1000. The mounting device 1000 includes a base 1002 having a pair of flexible engaging fingers 1004 and 1006 extend therefrom and having a space 1008 therebetween (clearly shown in FIG. 42). Each of the fingers 1004 and 1006 include a flexible plate member 1010 and a headed end member 1012 having a convex curved outer surface 1014 and an opposite concave curved inner surface 1016 meeting at an engaging portion 1018. The engaging portion 1018 of the finger 1004 extends over surface portion 1020 of the base 1002 to provide a flange receiving recess 1022, and the engaging portion 1018 of the finger 1006 extends over surface portion 1024 of the base 1002 to provide a flange receiving recess 1026.

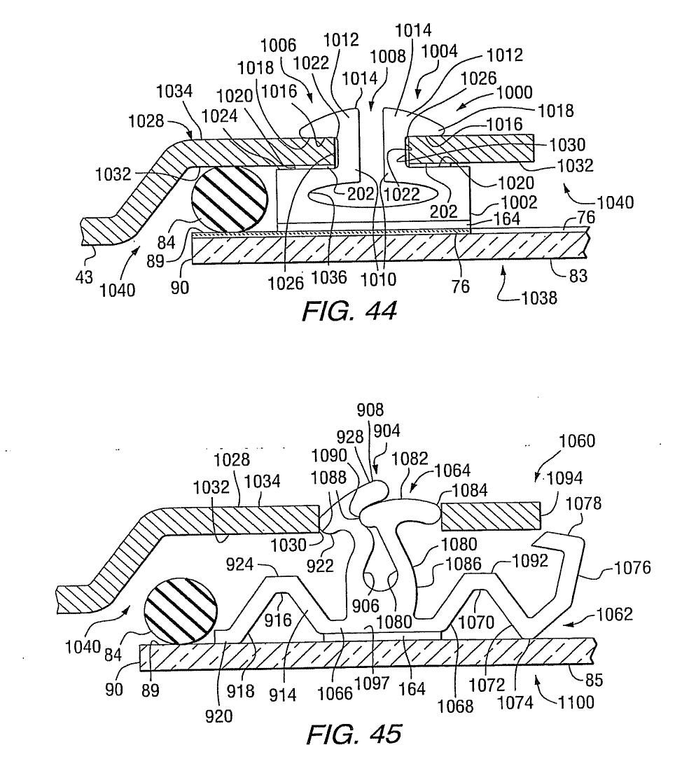

The mounting device 1000 is preferably used, but not limiting to the invention, in those instances when a flange, e.g. flange 1028 has holes or slots 1030 (only one hole shown in the flange 1028 shown in FIGS. 43 and 44). With continued reference to FIGS. 42-44, the spacing 1008 between the flexible fingers 1004 and 1006 is sufficient such that when the headed end members 1012 of the engaging fingers 1004 and 1006 contact the hole 1030 in the flange 1028, the fingers 1004 and 1006 are brought together by the walls of the hole 1030 (see FIG. 43), and the distance between the engaging portions 1018 of the headed end member 1012 of the flexible fingers 1004 and 1006 is sufficiently reduced to pass the headed end members 1012 of the fingers 1004 and 1006 through the hole 1030. As can be appreciated, the inside dimensions of the hole are not limiting to the invention. In one non-limiting embodiment of the invention, the inside dimensions of the hole are smaller than the distance between the engaging portions 1018 of the engaging fingers 1004 and 1006 when the fingers are brought together to reduce the space 1008 to zero. In this instance the engaging portions 1018 of the engaging fingers 1004 and 1006 flex to pass the engaging fingers through the hole 1030.

The height of the flange receiving recess 1022 of the engaging fingers is sized such that the flange 1028 as it passes over the engaging portion 1018 of the fingers 1004 and 1006, outer surface 1032 of the flange 1028 contacts the surface portion 1020 and the surface portion 1024 of the base 1002 as the engaging portions 1018 of the engaging fingers 1004 and 1006 move over inner surface 1034 of the flange 1028 to capture the flange in the flange receiving cavity 1022 of each of the engaging flexible fingers 1004 and 1006. Optionally, the base 1002 can be provided with a cavity 1036 to provide more flexibility to the fingers 1004 and 1006 moving toward one another.

Referring to FIGS. 43 and 44 as needed, in the practice of the invention, but not limited thereto, a plurality of the mounting devices 1000 are secured by the adhesive layer 164 to the ceramic band 76 on the inner marginal edge portions 89 of the transparency 83 to provide panel 1038. An elongated piece of the weather seal 84 is positioned on ceramic band 76 on the inner marginal edges 89 of the transparency 83 to encircle the mounting devices 1000 with the ends of the weather seal contacting one another. The flange 1028 defines a recess 1040 in the body of the van 30 and has a plurality of spaced holes or slots 1030 (only one shown in FIGS. 43 and 44). Optionally a gasket of the type known in the art and/or discussed herein, e.g. the gasket 540 shown in FIG. 23 is provided on the peripheral sides 90-93 (only side 90 shown in FIGS. 42-43) of the transparency 89 by the adhesive layer 164 as previously discussed.

The panel 1038 is moved into the recess 1040 to move the headed end members 1012 of the engaging fingers 1004 and 1006 of the plurality of the mounting devices 1000 into their respective hole 1030. Moving the panel 1038 further into the recess 1040 moves the headed end members 1012 of the fingers 1004 and 1006 together as shown in FIG. 43. Continued movement of the panel 1038 into the recess 1040 moves the outer surface 1032 of the flange 1028 into engagement with the surface portions 1020 and 1024 of the base 1002 and moves the engaging portions 1018 of the engaging fingers 1004 and 1006 over the inner surface 1034 of the flange 1028 to fixedly secure the panel 1038 in the recess 1040.

Optionally a locking arrangement can be provided to maintain the fingers 1004 and 1006 in spaced relationship to one another. For example and not limiting to the invention, a block, e.g. the block 934 shown in FIG. 39 can be secured in the space 1008 between the fingers 1002 and 1004i and secured therein in any convenient manner e.g. by the screw 938.

The mounting devices 1000 of the panel 1038 are released from the flange 1028 in any convenient manner. For example and not limiting to the invention, after the locking arrangement, if present, is removed, the fingers 1004 and 1006 are moved together and the engaging portions 1018 of the fingers pushed into their respective hole 1030 in the flange 1028. Moving the engaging portions 1018 into their respective hole 1030 moves the lower portion of the fingers 1004 and 1006 into the cavity 1036 of the base 1002. After all the fingers of the mounting devices 1000 are in their respective hole 1030 in the flange 1028, the panel 1038 is pushed or pulled out of the recess 1040.

In non-limiting embodiments of the invention, the layer 202 of friction material of can be provided on the surface portions 1020 and 1024 of the base 1002 (shown only in FIG. 44), and/or the layer 321 of low friction material can be provided over the outer surface 1014, the inner surface 1016 and/or the engaging portion 1018 of the headed end member 1012 of the fingers 1004 and 1006 (shown only on outer surface 1014 of the finger 1006 in FIG. 42) and/or in the walls of the holes or slots 1030 in the flange 1028.

### Fourteenth Mounting Device

With reference to FIGS. 45-47, there is shown a fourteenth non-limiting embodiment of a mounting device of the invention designated by the number 1060. The mounting device 1060 includes a base 1062 having the flexible upright engaging member 904 spaced from a second flexible upright engaging member 1064 each extending upward from first or middle segment 1066 of the base 1062. The base 1062 further includes the second segment 914, the third segment 916, the fourth segment 918 and the fifth segment 920 of the base 902 of the mounting device 900 shown in FIGS. 36-38 extending from one side of the first segment 1066. Extending from the other side of the first segment 1066 is an upwardly sloping sixth segment 1068, a flat horizontal seventh segment 1070, a downwardly sloping eighth segment 1072, a rounded ninth segment 1074 and an upward sloping tenth segment 1076 having a tab 1078. The tenth segment 1076 slopes away from the second engaging member 1064 and the tab 1078 extends toward the engaging members 1064.

As previously discussed, the engaging member 904 includes the flexible wall member 906 and the V shaped leg 908. The second engaging member 1064 includes a wall member 1080 and a leg 1082 having end 1086 extending away from the engaging member 904 and an opposite end 1088 facing the engaging member 904 and sized and shape to fit in cavity 1090 of the engaging member 904 in a manner discussed below.

The distance between the engaging surface portion 922 of the of the leg 908 contacting the inner marginal edges 1032 of the flange 1028 and upper surface 924 of the third segment 916 of the base 1062 is approximately equal to or slightly less than the thickness of the flange 1028. The distance between the end 1084 of the of the second engaging member 1064 contacting the inner marginal edges 1034 of the flange 1028 and upper surface 1092 of the seventh segment 1070 of the base 1062 is slightly less than the thickness of the flange 1028. In this manner, when the outer surface 1032 of the flange 1028 contacts the surface 1092 of the seventh segment 1070, the seventh segment will move downward toward the inner marginal edges 89 of the transparency 83 causing the tenth segment 1076 to pivot around the ninth segment 1074 to move toward end 1094 of the flange 1028. After the inner surface 1034 of the flange 1028 clears the engaging surface portion 922 of the engaging member 904 and the end 1084 of the second engaging member 1064, the tab 1078 of the tenth segment 1076 of the base 1062 is over the inner surface 1034 of the flange 1028. The upward force of the third segment 916 and the seventh segment 1070 moves the outer surface 1032 of the flange 1028 against the engaging surface 922 of the engaging member 904, against the end 1084 of the second engaging member 1064, and against the tab 1078 of the tenth segment 1076. In this manner, the tab cooperates with the engaging members 904 and 1064 to maintain the mounting device on the flange 1028, and the flange 1028 maintains the tab 1078 in position.

In a non-limiting embodiment of the invention, surface 1097 of the first segment 1066 of the base 1062 of a plurality of mounting devices 1060 is secured by the adhesive layer 164 to the inner marginal edge portions 89 of the transparency 83 to provide a panel 1100. An elongated piece of the weather seal 89 is positioned on the inner marginal edges 89 of the transparency 83 to encircle the mounting devices 1060 with the ends of the weather seal contacting one another. Optionally a gasket of the type known in the art and/or discussed herein, e.g. the gasket 540 shown in FIG. 23 is provided on the peripheral sides 90-93 (only the side 90 shown in FIGS. 45-47) of the transparency 89 by the adhesive layer 164 as previously discussed.

The panel 1100 is moved into the recess 1040 to move the leg 908 of the engaging member 904 and the leg 1082 of the second engaging member 1064 into contact with the hole or slot 1030 of the flange 1028 moving the end 1088 of the leg 1082 in the cavity 1090 of the engaging member 904. The panel 1100 is continually moved into the recess 1040 until the inner surface 1034 of the flange 1028 clears the engaging surface portion 922 of the engaging member 904 and the end 1084 of the second engaging member 1064. The panel 1100 is further moved into the recess 1040 to move the outer surface 1032 of the flange 1028 into contact with the surface 1092 of the seventh segment 1070, and thereafter into contact with the surface 924 of the third segment 916. As discussed above, the seventh segment will move downward toward the inner marginal edges 89 of the transparency 83 causing the ninth segment 1074 to pivot the tenth segment 1076 to move toward end 1094 of the flange 1028. After the inner surface 1034 of the flange 1028 clears the engaging surface portion 922 of the engaging member 904 and the end 1086 of the second engaging member 1064, the tab 1078 of the tenth segment 1076 is over the inner surface 1034 of the flange 1028. The upward force of the third segment 916 and the seventh segment 1070 moves the inner surface 1034 of the flange 1028 against the engaging surface 922 of the engaging member 904, against the end 1086 of the engaging member 1064, and against the tab 1078 of the tenth segment 1076 to fixedly secure the panel 1100 in the recess 1040.

The panel 1100 is removed from the recess 1040 in any convenient manner, e.g. and not limiting to the invention, by moving the panel 1100 toward the flange 1028 to move the flange away from the v-shaped leg 908 and the leg 1082 of the engaging members 904 and 1064 respectively, and the tab 1078. The legs 904 and 1082 of the engaging members 904 and 1064 respectively are moved together to move the end 1088 of the leg 1082 into the cavity 1090 of the leg 908 and the legs 908 and 1082 of the mounting devices 1060 pushed through the hole 1030 of the flange. The tab 1078 of the tenth segment 1076 is moved away from the inner surface 1034 of the flange against the end 1094 of the flange 1028. The panel 1100 is pushed or pulled out of the recess 1040.

Optionally the surfaces of the segments 920 and 1074 of the base 1062 contacting the inner marginal edges 89 of the transparency 83 can have the layer 321 of a low friction material, and the surfaces of the segments 916 and 1076 and the tab 1078 contacting the outer surface 1034 and the inner surface 1032 of the flange 1028 can have the layer 202 of the friction material.

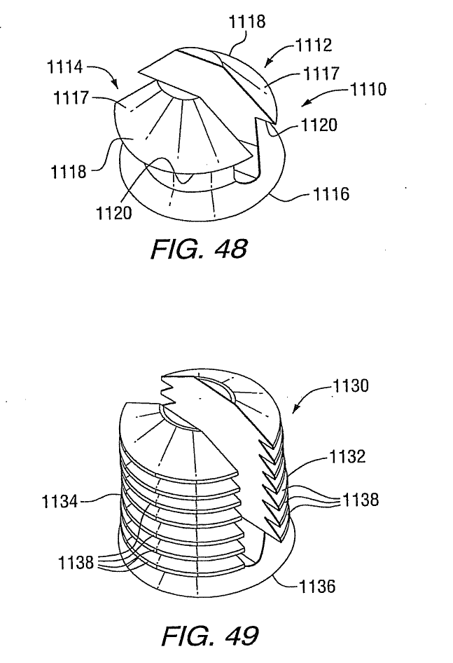

As can be appreciated, the invention is not limited to the shape of the engaging member 904 of the eleventh mounting device 900 (see FIG. 36), the twelfth mounting device 960 (see FIG. 40) and the fourteenth mounting 1060 (see FIG. 47); the flexible engaging fingers 1004 and 1006 of the mounting devices 1000 (see FIG. 43) and the engaging member 1064 of the mounting device 1060 (see FIG. 47), and a flexible engaging member of any shape can be used in the practice of the invention. For example, and not limiting to the invention, there is shown in FIG. 48 an engaging member 1110 having a pair of flexible engaging fingers 1112 and 1114 spaced from one another and extending away from a base 1116. Each of the engaging fingers 1110 and 1112 has a head 1117 having a sloping surface 1118. The flexible engaging fingers 1112 and 1114 are similar to the flexible fingers 1004 and 1006 of the mounting device 1040 shown in FIG. 42 except that the flexible fingers 1004 and 1006 shown in FIG. 42 are elongated whereas the engaging fingers 1112 and 1114 of the engaging member 1110 shown in FIG. 48 are rounded and more suitable for flanges that have circular holes instead of slots, e.g. elongated holes.

As is appreciated by those skilled in the art, engaging surface 1120 of the head 1117 of the engaging fingers 1112 and 1114 facing the base 1116 can be flat or curved. In a non-limiting embodiment of the invention, the engaging fingers 1112 and 1114 are used in a similar manner as the engaging fingers 1004 and 1006 (see FIG. 42).

Shown in FIG. 49, is an engaging member 1130 having flexible engaging fingers 1132 and 1134 spaced from one another and extending from a base 1136. The fingers 1132 and 1134 are similar to the engaging fingers 1110 and 1112 of the engaging member 1110 except that the engaging fingers 1132 and 1134 of the engaging member 1130 each have a plurality of downward facing vanes 1138, making the engaging member 1130 useable with flanges having a wide range of different thick nesses whereas the engaging member 1130 is preferred for flanges of a narrower range different thicknesses.

### Fifteenth Mounting Device

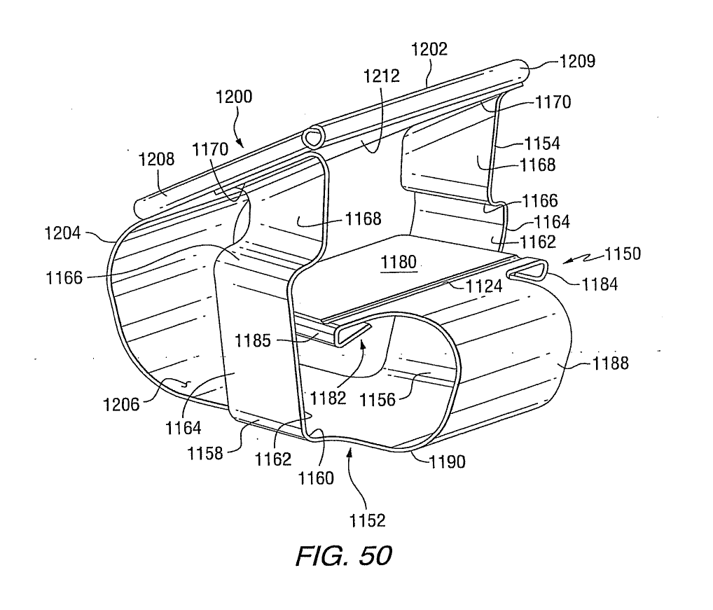

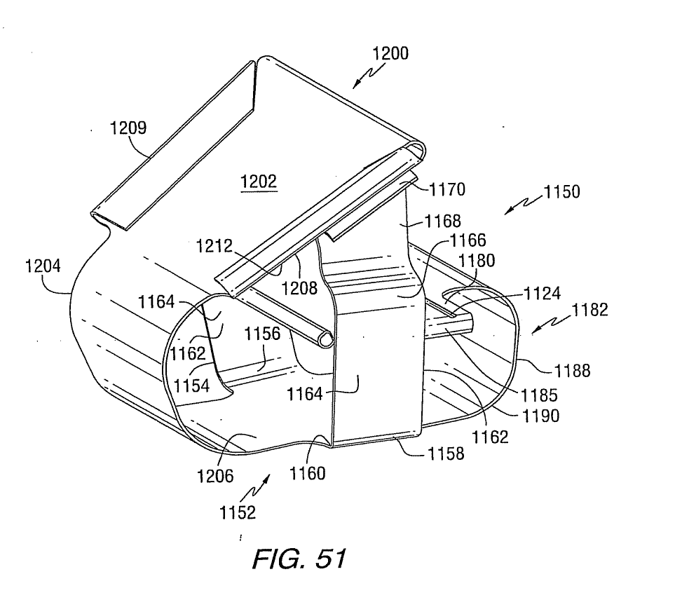

With reference to FIGS. 50-54 as needed there is shown a fifteenth non-limiting embodiment of a mounting device of the invention designated by the number 1150. Although not limiting to the invention, the mounting clip 1150 is made from a single piece of spring steel bent or formed to have a base 1152, a first retentive arm 1154 extending upward from side 1156 of the base 1152 (see FIGS. 50 and 51), and a second retentive arm 1158 extending upward from opposite side 1160 of the base 1152 (see FIG. 50). Inner surface 1162 of each of the retentive arms 1154 and 1158 face one another with the distance between the inner surfaces 1162 of lower portion 1164 of the retentive arms 1154 and 1158 (see FIGS. 50 and 51) increasing as the distance from the base 1152 increases up to shoulder 1166 (see FIG. 50) formed in each of the retentive arms 1154 and 1158 and extending toward one another over the base 1162. The shoulders 1166 of the retentive arms 1154 and 1158 face and extend toward one another to decrease the distance between the inner surfaces 1162 of the retentive arms 1154 and 1158. In non-limiting embodiments of the invention, the distance between the shoulders 1166 of the retentive arms 1154 and 1158 is equal to or slightly greater than the distance between the sides 1156 and 1160 of the base 1152. As the distance from the shoulder 1166 in a direction away from the base increases, the distance between the inner surfaces 1162 of upper portion 1168 of each of the retentive arms 1154 and 1158 increases with each of the retentive arms 1154 and 1158 terminating with a flanged angled end 1170.

The retentive arms 1154 and 1158 in the unbiased position are positioned relative to one another about support plate 1180 of support member 1182 (see FIGS. 50-52) such that the distance between the inner surfaces 1162 of the retentive arms 1154 and 1158 immediately above the shoulders 1166 of the retentive arms 1154 and 1158 is about equal to the distance between the sides 1158 and 1160 of the base 1152 (see FIG. 50). As can be appreciated, the invention is not limited to having the retentive arms 1154 and 1158 in the unbiased position. The retentive arms can be biased by the internal spring action of the spring steel toward one another and the desired distance between the shoulders 1166 maintained by the inner surfaces 1162 of the lower portions 1164 of the retentive arms 1154 and 1158 engaging sides 1184 and 1185 (see. FIG. 50), respectively of the support plate 1180 of the support member 1182.

With continued reference to FIGS. 50-54 as needed, the support member 1182 in addition to the support plate 1180, further includes a leaf spring section 1188 (also referred to as “first leaf spring section”) having the support plate 1180 at one end and connected at the opposite end to side 1190 of the base 1152. The support plate 1180 between the sides 1184 and 1185 is sized such that as the support plate 1180 moves toward the base 1152 of the mounting device 1150 against the biasing action of the first leaf spring section 1188 in a manner discussed below, the sides 1184 and 1185 of the support plate 1180 move the retentive arms 1154 and 1158 away from one another against the internal biasing action of the spring steel. The first leaf spring section 1188 in the unbiased position in one non-limiting embodiment of the invention maintains the support plate 1180 slightly below the shoulders 1166 of the retentive arms 1154 and 1158 as shown in FIGS. 50-52. As can be approached, the invention contemplates the first leaf spring section 1188 biasing the support plate 1180 toward or against the shoulders 1166 of the retentive arms 1154 and 1158 to urge the support plate away from the base 1152. In this instance, the support plate 1180 is maintained below the upper portion 1168 of the retentive arms 1154 and 1158 by the sides 1184 and 1185 of the support plate 1180 engaging the shoulders 1166 of the retentive arms 1154 and 1158.

With reference to FIG. 51, engaging member 1200 includes an engaging plate 1202 on end of leaf spring section 1204 (also referred to as “second leaf spring section”) with the opposite end of the second leaf spring section connected to side 1206 of the base 1152. The engaging plate 1202 is biased against the flanged angled ends 1170 of the retentive arms 1154 and 1158 by the biasing action of the second leaf spring section 1204. The distance between sides 1208 and 1209 (see FIGS. 50 and 51) of the engaging plate 1202 is selected to be greater than the distance between the flanged angled ends 1170 to prevent the engaging plate from moving between the retentive arms 1154 and 1158 under the biasing action of the second leaf spring section 1188, and to be greater than the distance between the shoulders 1166 at the start of the upper portion 1168 of the retentive arms 1154 and 1158 to capture the engaging plate 1202 in the lower portion 1164 of the retentive arms for reasons discussed below. The invention is not limited to the distance between the sides 1208 and 1209 of the engaging plate in relationship to the distance between the inner surface 1162 of the lower portion 1164, adjacent the shoulders 1166, of the retentive arms 1154 and 1158; however, in a non-limited embodiment of the invention, the distance between the sides 1208 and 1209 should be sufficient to provide for the support plate 1180 to move away from the base 1152 under the biasing action of the first leaf spring section 1188 when the biasing force discussed below moving the support plate 1180 toward the base of the mounting device is removed.

With the above arrangement, applying a biasing force against the support plate 1180 in a manner discussed below moves the support plate 1180 toward the base 1152 against the biasing action of the first leaf spring section 1188 to move the retentive arms 1154 and 1158 away from one another to pass the engaging plate 1202 under the biasing action of the second leaf spring section 1204 past the flared angled ends 1170 of the retentive arms. As the support plate 1180 moves closer to the base, the retentive arms 1154 and 1158 move further apart allowing the engaging plate 1202 too move under the biasing action of the second leaf spring section 1204 toward the shoulders 1166 of the retentive arms 1154 and 1158. Continued movement of the support plate 1180 closer to the base 1152 moves the retentive arms further apart moving the engaging plate 1202 under the biasing action of the second leaf spring section 1204 past the shoulders 1166. The biasing force is removed from the support plate 1180, to move the support plate 1180 under the biasing action of the second leaf spring section 1204 toward the shoulders 1166 of the retentive arms 1154 and 1158 and toward the engaging plate 1202 below the shoulders 1166. As the support plate moves toward the shoulders 1166, the retentive arms 1154 and 1158 move toward one another to capture the engaging plate 1202 under the shoulders 1166 to prevent the engaging plate from moving away from the base when a force greater than the biasing force of the second leaf spring section 1204 is applied to engaging surface 1212 (see FIGS. 53-55) of the engaging plate 1202 for reasons discussed below.

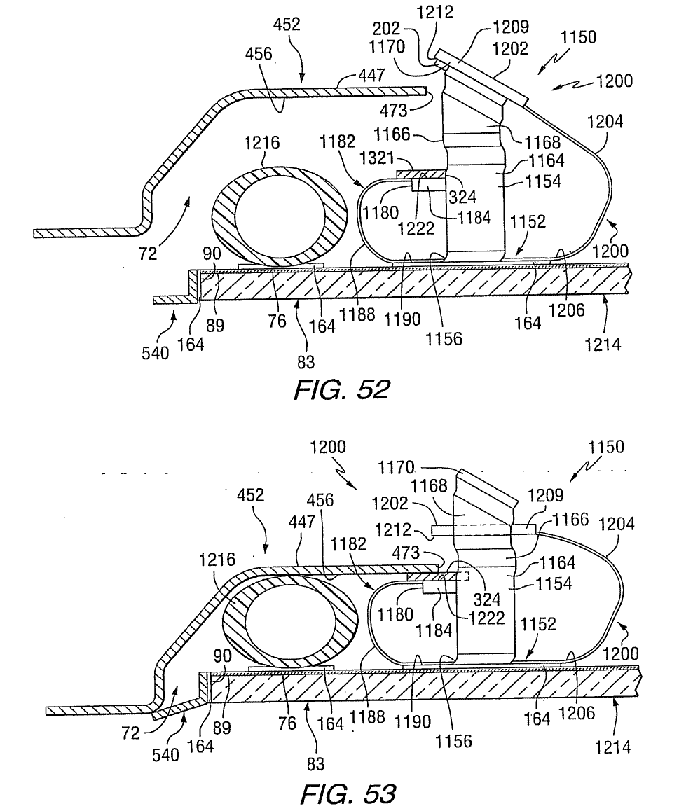

Referring to FIGS. 52-54 as needed, in the practice of the invention, but not limited thereto, a plurality of the mounting devices 1150 are secured by the adhesive layer 164 to the ceramic band 76 on the inner marginal edge portions 89 of the transparency 83 to provide panel 1214. An elongated piece of weather seal 1216 is secured to the ceramic band 76 on the inner marginal edges 89 of the transparency 83 by the adhesive layer 60 to encircle the mounting devices 1150 with the ends (not shown) of the weather strip 1216 joined together. The weather seal 1216 is a preformed hollow plastic strip having non-tacky surfaces and can be any of the types used to provide a fluid seal, e.g. of the type sold by Saargummi Technologies. As can be appreciate, the weather seal 84 (e.g. see FIG. 47) can be used in place of the weather seal 1216, and the weather seal 1216 can be used in place of the weather seal 84. The gasket 540 is attached to the sides 90-93 (the side 90 shown in FIGS. 52-54) of the transparency 83 by the adhesive layer 60 as previously discussed.

The mounting devices 1150 are set to the non-engaging position by positioning the engaging plate 1202 of the engaging member 1200 on the flanged angled ends 1170 of the retentive arms 1154 and 1158 (see FIG. 52). The panel 1214 is moved into the recess 72 of the van 30 to move the engaging plate 1202 past the end 473 of the flange 452 and to move the outer surface 456 of the flange 452 into contact with support surface 1220 of the support plate 1180. Moving the panel 1214 further into the recess 1040 moves the support plate 1180 toward the base 1152 of the mounting device 1150 to move the flanged angled ends 1170 of the retentive arms 1154 and 1158 apart to pass the engaging plate 1202. The biasing action of the second leaf spring section 1204 moves the engaging plate 1202 toward the base 1152 of the mounting device 1150 and toward the inner surface 447 of the flange 452. The panel 1214 is further move into the recess 72 until the engaging plate 1202 moves under the shoulders 1216 of the retentive arms 1154 and 1158 as previously discussed.

The biasing force moving the panel 1214 into the recess 72 is removed and the support plate 1180 under the biasing action of the first leaf spring section 1188 engages the outer surface 447 of the flange 452 to move the panel in a direction out of the recess 1040 to move the inner surface 456 of the flange 452 of the recess 1040 and the engaging surface 1212 of the engaging plate 1202 into contact with one another. The panel 1214 is secured in the recess 72 by the engaging plate 1202 engaging the inner surface 447 of the flange 452, and the shoulders 1166 preventing the engaging plate 1202 from moving away from the base, and the first leaf spring section 1188 biasing the support plate 1180 against the outer surface 447 of the flange 452.

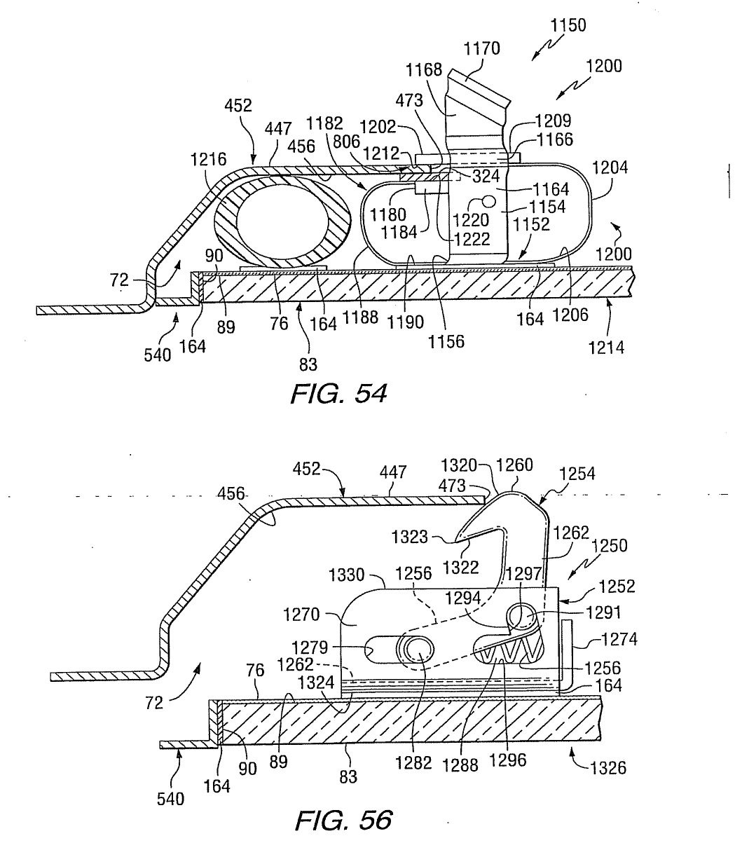

As can be appreciated, force can be applied to move the panel 1214 into the recess 72, a distance equal to the spaced distance between the support plate 1180 of the support member 1182 and the base 1152 of the mounting clip 1150. By reducing the spaced distance, the distance the panel can be moved into the recess can be reduced. In a non-limiting embodiment of the invention, a screw 1192 (shown only in FIG. 54) passes through both the retentive arms 1154 and 1158 (only arm 1154 shown in FIG. 54) under the support plate 1180 to prevent the support plate from moving toward the base 1152 to prevent movement of the panel into the recess.

The panel 1214 is removed from the recess 72 by removing the screw 1220, if present, spreading the retentive arms 1154 and 1158 apart in any convenient manner and moving the engaging plate 1202 from between the retentive arms. The retentive arms are released after which the engaging plate is released to move against the flanged angled ends 1170. When the mounting devices 1150 are in the non-engaging position, the panel is removed from the recess 72.

The layer 324 of the low friction material can be provide on an any moving contacting surfaces of the mounting device 1150, e.g. but not limiting to the invention, on the support surface 1222 of the support plate 1180 (see FIGS. 52-54) contacting the outer surface 456 of the flange 452; on surface of the flanged angled ends 1170 contacting the engaging plate 1200, and on the sides of the support plate and the sides of the engaging plate contacting the inner surfaces 1162 of the retentive arms 1154 and 1158. Further, and not limiting to the invention, the layer 202 of the friction material can be provided on surfaces of the mounting device or flange to reduce noise from surfaces of the mounting device 1150 and the flange 452 moving against one another, e.g. but not limiting to the invention on the engaging surface 1212 of the engaging plate (shown only in FIG. 52) contacting the inner surface 447 of the flange 452.

As can be appreciated the invention is not limited to the manner in which the mounting device 1150 is made. In the one non-limiting embodiment of the invention discussed above, the mounting was made from a piece of spring steel. The sides of the support plate 1180 and the engaging plate 1202 except for the side connected to the leaf spring section were folded over to eliminate sharp edges and areas of friction. Further, the engaging member is biased toward the base 1152 by internal force of the spring steel, and the support plate 1180 is biased away from the base by the internal force of the spring steel. Since it is more economical to form the mounting device 1150 from a piece of spring steel biased in one direction, in one non-limiting embodiment of the invention, the support plate is made from a separate piece of spring steel and secured to the base to provide for the engaging member is biased toward the base 1152 by internal force of the spring steel from which it was made, and the support plate 1180 is biased away from the base by the internal force of the spring steel from which it was made.

In other non-limiting embodiments of the invention, one or both of the support plate 1180 and the engaging member 1200 can have a groove 1124 (groove 1124 shown only in the support plate 1180, only in FIG. 50 and only in phantom) similar to the area 880 in the retentive arm 852 of the tenth mounting device 824 to prevent the glob of paint 881 (see FIG. 35) from breaking or falling off the end of the flange.

### Sixteenth Mounting Device

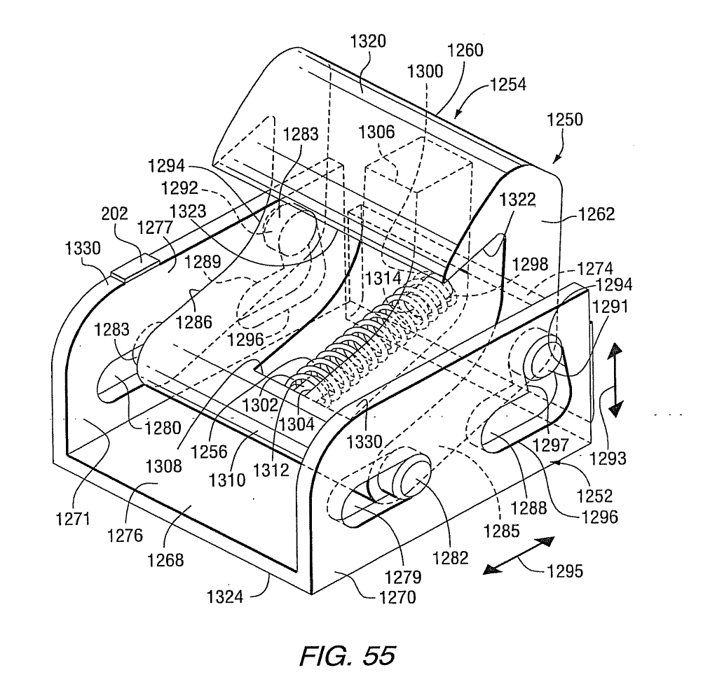

With reference to FIGS. 55-58 as needed there is shown a sixteenth non-limiting embodiment of a mounting device of the invention designated by the number 1250. The mounting device 1250 includes a housing 1252, an engaging member 1254 and a spring 1256 acting on the engaging member 1254 in a manner discussed below. The engaging member 1254 has a first leg 1256 and a second or engaging leg 1260 interconnected my an intermediate leg 1262 to provide the engaging member 1254 with a generally U-shaped configuration with the engaging leg 1260 preferably shorter than the first leg 1258 for reasons discussed below. The housing 1252 has a base 1268, a pair of side walls 1270 and 1271, a back wall 1274, an open end 1276 and open top 1277 (clearly shown in FIG. 55). In one non-limiting embodiment of the invention, the housing 1252 of the mounting device 1250 is made of a bent or formed configurative metal sheet.

With continued reference to FIG. 55, each of the side walls 1270 and 1271 of the housing 1252 has a linear horizontal slot 1279 and 1280, respectively for receiving a rounded tab 1282 and 1283, respectively extending from sides 1285 and 1286, respectively of the first leg 1256 of the engaging member 1254 (also referred to as “first pair of tabs 1282 and 1283”), and each of the side walls 1270 and 1271 has a reversed “L” shaped slot 1288 and 1289 spaced from the horizontal slots 1279 and 1280, respectively for receiving rounded tabs 1291 and 1292 (also referred to as “second pair of tabs 1291 and 1292”), respectively extending from the sides 1285 and 1286, respectively of the engaging member 1254 with the first pair of tabs 1282 and 1283 spaced from the second pair of tabs 1291 and 1292. In this manner, the engaging member 1254 is captured between the side walls 1270 and 1271 of the housing 1252 for movement along the paths defined by the horizontal slots 1279 and 1280 and the L-shaped slots 1288 and 1289. More particularly and not limiting to the invention, the second pair of tabs 1291 and 1292 move along a reciprocating vertical path defined by the number 1293 (shown only in FIG. 55) defined by vertical leg members 1294 of the L-shaped slots 1288 and 1289, while the first pair of tabs 1282 and 1283 rotate in their respective linear slot 1279 and 1289, and the second pair of tabs 1291 and 1292 move along a horizontal reciprocating path defined by horizontal leg members 1296 of the L-shaped slots 1288 and 1289, while the first pair of tabs 1282 and 1283 move along a reciprocating horizontal path defined by horizontal slots 1288 and 1289 to move the engaging member 1254 along a reciprocating horizontal path designated by the number 1295 (shown only in FIG. 55).

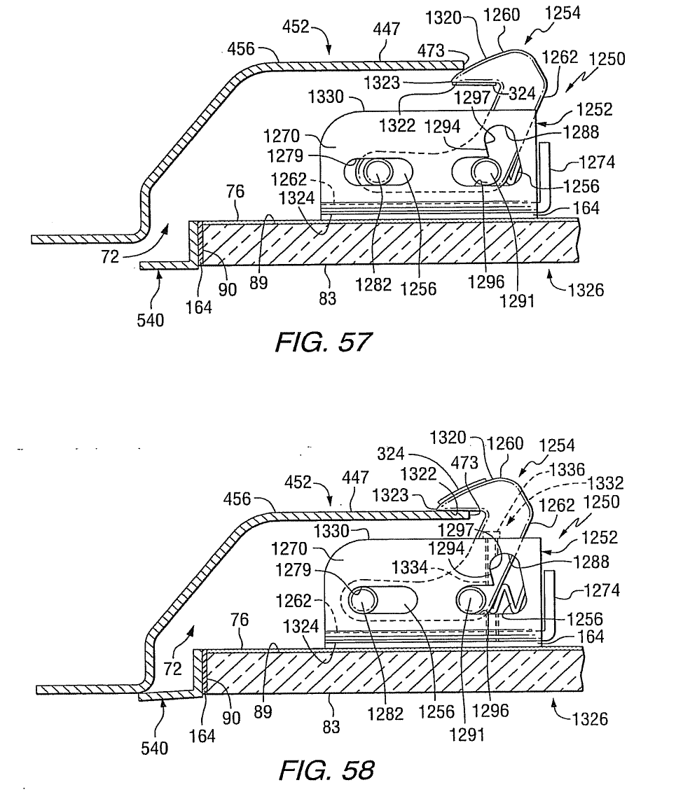

With reference to FIGS. 55-58, the vertical leg member 1294 of the L-shaped slots—1288 and 1289 slants away from the backwall 1274 and optionally surface portion 1297 (the surface of the vertical leg members farthest from the backwall 1274 of the housing 1252) can be provided with a concave curved surface portion (curved surface portion shown only in FIG. 57). Although not limiting to the invention, the slanting of the leg members 1294 from the backwall 1274 and the curved surface 1297 facilitates maintaining the second pair of tabs 1291 and 1292 of the engaging member 1254 in the vertical leg members 1294 of the L-shaped slots 1288 and 1289, respective under the biasing action of the spring 1256. This non-limiting feature of the mounting device 1250 is discussed in more detail below.

Referring now to FIG. 55, the spring 1256, e.g. and not limiting to the invention, a coil spring, has a first end 1298 connected to inner surface 1300 of the backwall 1274 in any convent manner, and opposite second end 1302 connected to the engaging member 1254 in any convenient manner. In one non-limiting embodiment of the invention, the engaging member 1254 is provided with a center cut out portion 1304 extending from a position designated by the number 1306 on the intermediate leg 1262 adjacent the second leg 1260 of the engaging member 1254 to a position designated by the number 1308 on the first leg 1258 spaced from end 1310 of the first leg 1258 of the engaging member 1254. The second end 1302 of the spring 1256 is mounted on a stub 1312 provided at the position 1308 of the cut out portion 1304. In this non-limiting embodiment of the invention, the first end 1298 of the spring 1256 is maintained in position by providing a stub 1314 on the inner surface 1300 of the backwall 1274 of the housing 1252.

With the second pair of tabs 1291 and 1292 in their respective one of the vertical leg members 1294 of the L shaped slots 1288 and 1289, the spring 1256 biases the engaging member to bias the second pair of tabs 1291 and 1292 in their respective one of the vertical leg members 1294, and if present, to bias the second pair of tabs 1291 and 1292 into the curved portions 1297 of the vertical leg members 1294 of the L shaped slots to position the engaging member 1254 in a mounting position as shown in FIG. 56. In one non limiting embodiment of the invention, the second leg 1260 of the engaging member 1254 is moved against the biasing action of the spring 1256 toward the backwall 1274 in a manner discussed below to move the second pair of tabs 1291 and 1292 from their respective one of the vertical leg members 1294 of the L shaped slots 1288 into its respective one of the horizontal leg members 1296, of the L shaped slots 1288 and 1289 as shown in FIG. 57. The engaging member moves under the biasing action of the spring 1256 away from the backwall 1274 of the housing 1252 into an engaging position. As the engaging member moves into the engaging position, the first pair pf tabs 1282 and 1283 move in their respective one of the horizontal slots 1279 and 1280, and the second pair of tabs 1291—and 1292—move in their respective one of the horizontal leg members 1296 of the L shaped slots 1288 and 1289.

In one non-limiting embodiment of the invention, the flange 452 engages the leg 1260 of the engaging member 1254 to move the engaging member toward the backwall of the housing. With reference to FIGS. 55-58, the engaging leg 1260 of the engaging member 1254 is shorter than the first leg 1258 to reduce the length of the base as measured from the backwall. Further the engaging leg 1260 has a rounded convex outer surface 1320 that meets flat inner or engaging surface 1322 of the engaging leg 1260 at an end portion 1323 for ease of moving the flange over the engaging leg in a manner discussed below.

Referring to FIGS. 55-58 as needed, in one non-limiting embodiment of the invention, outer surface 1324 of the base 1268 of each of a plurality of the mounting devices 1250 is fixedly secured by the adhesive layer 164 to the ceramic band 76 on the inner marginal edge portions 89 of the transparency 83 to provide panel 1326. A weather seal, e.g. and not limiting to the invention, the weather seal 84 (e.g. see FIG. 28) or 1216 (e.g. see FIG. 54) can be used; however, in this non-limiting embodiment of the invention, a weather seal is not used to prevent moisture from moving through the recess 72 in the van 30. In this non-limiting embodiment of the invention, moisture is preventing from moving into the recess 72 by the gasket 540 attached to the sides 90-93 (the side 90 shown in FIGS. 56-58) of the transparency 83 by the adhesive layer 164 as previously discussed.

The mounting devices 1250 are placed in the mounting position as discussed above and shown in FIG. 56, and the panel 1326 is moved into the recess 72 of to move the convex shaped surface 1320 of the engaging leg 1260 of the engaging member 1254 and the end 473 or outer corner of the flange 452 into contact with one another (see FIG. 56). Moving the panel 1326 further into the recess 72 moves the engaging member 1254 against the biasing action of the spring 1256 toward the backwall 1274 of the housing 1252. Continued movement of the panel into the recess 72 moves the engaging member 1254 closer to the backwall 1274 of the housing 1252, moving the second pair of tabs 1282 and 1283 out of the vertical leg member of the L shaped slots 1288 and 1289, respectively (see FIG. 57). The panel 1326 is move further into the recess 72, and the end 473 of the flange 452 and the end 1323 of the engaging leg 1260 move past one another. The outer surface 456 of the flange 452 and support surface 1330 of the sidewalls 1270 and 1271 of the housing 1252 (see FIG. 55) contact one another, and the engaging surface 1322 of the engaging leg 1260 of the engaging member 1254 under the biasing action of the spring 1256 moves over the inner surface 449 of the flange 452. The engaging member is in the engaging position (see FIG. 58), and the panel 1326 is secured in the recess 72.

Although not limiting to the invention a locking arrangement, e.g. locking arrangement 1332 (shown only in phantom and only in FIG. 58) can be used to maintain the engaging member 1254 in the engaging position. In one non-limiting embodiment of the invention, the locking device 1332 includes a passageway 1334 extending through one or both of the sidewalls 1270 and 1271. In FIG. 58 the passageway 1334 extends only through the sidewall 1270. A headed threaded shaft or screw 1336 (only the head and upper portion of the screw shown in FIG. 58) mounted in the passageway 1334 passes through the horizontal leg member 1296 of the L shaped slot 1288 upstream of the tab 1291, e.g. to the right of the tab 1291 as viewed in FIG. 58 to prevent the engaging member 1254 from moving toward the backwall 1274 out of the engaging position to fixedly mount the panel in the recess 72.

The panel 1326 can be removed from the recess 72 in any convenient manner. In one non-limiting embodiment of the invention, the locking arrangement 1332, if present, is removed, and the engaging member 1254 is moved against the biasing action of the spring 1256 along the horizontal path 1295 (shown in FIG. 55) toward the backwall 1274 until the end 1323 of the engaging leg 1258 of the engaging member 1254 clears the end 473 of the of the flange 452. The threaded shaft 1336 of the locking arrangement 1332 can be mounted in the passageway 1334 to maintain the engaging member 1254 in the non-engaging position, e.g. by positioning the thread pin 1336 in the passageway 1334 downstream of the tab 1291, e.g. to the left of the tab 1291 as shown in FIG. 58 to prevent the engaging member 1254 from moving away from the backwall 1274 of the housing 1252 under the biasing action of the spring 1256. After the mounting devices 1250 are in the non-engaging position, the panel 1326 is removed from the recess 72.

The layer 324 of low friction material can be provide on the curved surface 1320 (see FIG. 58), and the engaging surface 1320 (see FIG. 57) of the engaging leg 1260 of the engaging member 1254, the inner walls of the slots 1279, 1280, 1288 and 1289, and/or the outer surfaces of the first and second pair of tabs 1282, 1283 and 1291, 1292, respectively. The layer 202 of the friction material can be provided on the support surface 1330 of the housing 1252 (in FIG. 55, partially shown and only shown on the support surface 1330 of the sideway 1271).

### Seventeenth Mounting Device

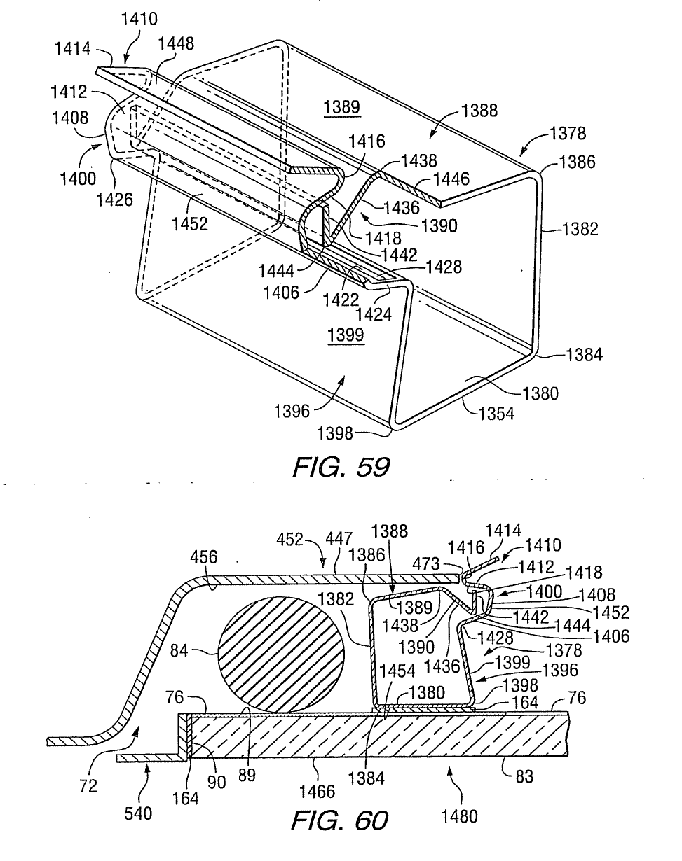

With reference to FIGS. 59-62 as needed there is shown a seventeenth non-limiting embodiment of a mounting device or mounting clip of the invention designated by the number 1378. In one non-limiting embodiment of the invention, the mounting device 1378 is made by bending or forming a configured piece of spring steel. The mounting device 1378 includes a base 1380 and a first upright wall member 1382 connected at connection area 1384 to the base and connected at connection area 1386 opposite to the connection area 1-384 to supporting member 1388. The supporting member 1388 has a body 1389 extending over the base 1380, spaced from the base, and in the non-engaging position discussed below angles away from the base as shown in FIG. 60. The body 1389 of the supporting member 1388 terminates with an activation and securing member 1390 discussed in detail below, the activation and securing member 1390 is opposite to the connection area 1386. The mounting device 1378 further includes a second upright wall member 1396 connected to the base at connection area 1398 and a body 1399 extending away from the base 1380 and terminating with an engaging arrangement 1400 discussed in detail below, the engaging arrangement 1400 is opposite to the connection area 1398. The body 1399 of the second upright wall member 1396 is spaced from, in facing relationship to, and angled toward the first upright wall member 1382.

The engaging arrangement 1400 includes an extension 1406 that angles outward from the body 1399 of the second wall member 1396 and away from the base 1380 to an extension arm 1408. The extension arm 1408 is connected to an engaging member 1410 having a first arm member 1412 connected to the extension arm 1408 and to a second arm member 1414 at end 1416. The first arm member 1412 of the engaging member 1410 has a flange-engaging surface 1418. The second arm member 1414 is not limiting to the invention and can be used for ease of moving the engaging member 1410 away from the activation and securing member 1390. With particular reference to FIG. 59, the extension 1406 of the engaging arrangement 1400 has a slot 1422 spaced from and extending between sides 1424 and 1426 of the extension 1406 to receive activating and securing member 1390 in a manner discussed below. In one non-limiting embodiment of the invention, the slot 1422 is formed by punching the slot in the sheet metal and using the punched out portion to provide a strip 1428 to guide the activating and securing member 1390 into the slot 1422 in a manner discussed below.

The activating and securing member 1390 of the support member 1388 includes a first leg section 1436 connected to the body 1389 of the support member and angled toward the base 1380 as shown in FIGS. 59 and 60, and a second leg section 1442 angled away from the base. The first and second leg sections 1436 and 1442, respectively are joined at an apex 1444 with the distance between the first and second leg sections increasing as the distance from the apex 1444 increases to provide the activating and securing member with a generally V shaped cross section as clearly shown in FIGS. 59 and 60. With specific reference to FIG. 59, the length of the activating and securing member 1390 as measured between side edges 1446 and 1448 is less than the length of the slot 1422 in the extension 1406.

The support member 1388 is biased to resist movement of the support member 1388 toward the base 1380 and has the apex 1444 engaging the guiding strip 1450 with the second leg-section 1442 between the extension 1406 and the engaging member 1408 as shown in FIG. 60. The mounting device 1378 is shown in FIG. 60 in the non-engaging position.

As a force is continuously applied to move the supporting member 1388 toward the base 1380, the apex 1444 of the activating and securing member 1390 is moved into the slot 1422, moving the engaging arrangement member 1400 toward the first upright wall member 1382 over the supporting member. The activating and securing member 1390 is further moved into the slot moving the first and second leg sections 1436 and 1442, respectively toward one another, and the engaging arrangement 1400 moves further over the supporting member. With the second leg section 1442 passing through the slot, the force applied to the supporting member is removed and the support member is biased away from the base 1380 by the internal spring force of the spring steel moving the second leg section 1442 against outer surface 1452 of the extension arm 1408 of the engaging arrangement 1400. The mounting device 1378 is in the engaging position (see FIG. 62).

Referring to FIGS. 59-62 as needed, in one non-limiting embodiment of the invention, outer surface 1454 of the base 1380 of each of a plurality of the mounting devices 1378 is secured by the adhesive layer 164 to the ceramic band 76 on the inner marginal edges 89 of the transparency 83 to provide panel 1460. A weather seal, e.g. and not limiting to the invention, the weather seal 84 is mounted on the ceramic band on the inner marginal edges of the transparency encircling the mounting devices and having the ends of the weather seal contacting one another. The gasket 540 is attached to the sides 90-93 (the side 90 shown in FIGS. 59-62) of the transparency 83 by the adhesive layer 164 as previously discussed.

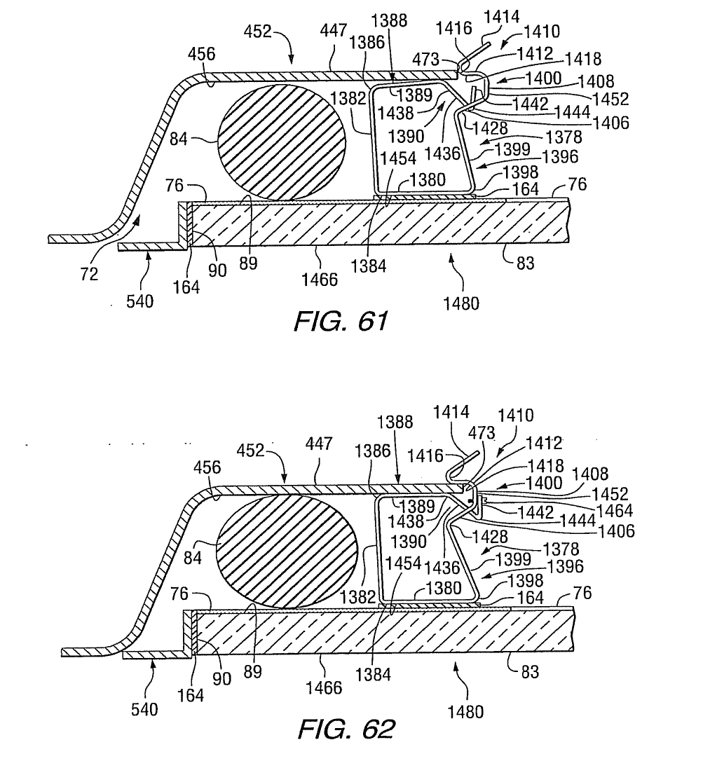

The mounting devices 1378 are placed in the non-engaging position (see FIG. 60) with the apex 1444 of the activating and securing member 1390 engaging the guide strip 1428. The panel 1460 is moved into the recess 72 in the body of the van to move the end 1416 of the engaging member 1410 past the end 473 of the flange 452. Continued movement of the panel 1460 into the recess 72 moves the body 1389 of the supporting member 1388 into engagement with the outer surface 456 of the flange 452 and moves the apex 1444 of the activating and securing member 1390 into the slot 1422 moving the first and second leg sections 1435 and 1442, respectively toward one another (see FIG. 61). When the second leg section 1442 clears the slot 1422, the engaging surface 1418 of the first arm member 1412 of the engaging arrangement 1400 moves over the inner surface 447 of the flange 452. The panel 1460 is no longer moved into the recess 72, and the internal biasing action of the spring steel moves the supporting member 1388 away from the base 1380. The flange 452 is captured between the supporting member 1388 and the engaging surface 141-8 of the engaging arrangement 1400 to secure the panel 1480 in the recess 72. The second leg section 1442 engages outer surface 1452 of the extension arm 1408 maintain the engaging member 1410 over the inner surface 447 of the flange 452.

Although not limiting to the invention a locking arrangement, e.g. a screw 1464 (shown only in FIG. 62) can be used to secure the second leg section 1442 to the extension arm 1408 to prevent the supporting member 1388 from moving toward the base 1380 should a force be applied to the outer surface 1466 of the transparency 83 of the panel 1480 greater than the internal biasing force of the spring steel. Further the screw 1464 maintains the engaging arrangement 1400 in the engaging position.

The panel 1460 can be removed from the recess 72 in any convenient manner. In one non-limiting embodiment of the invention, the screw 1464, if present, is removed, and the panel 1480 is moved into the recess 72 to move the second leg section 1442 away from the extension arm 1408. The first and second leg sections 1436 and 1442 respectively are moved toward one another and moved through the slot. The engaging arrangement 1400 is moved away from the end 473 of the flange 452 putting the mounting device in the non-engaging position (see FIG. 60). With all the mounting devices in the non-engaging position, the panel 1460 is moved out of the recess.

Although not limiting to the invention, the layer 324 of low friction material can be provide on the inner surfaces of the slot 1422, on the engaging surface of the engaging member and/or outer surface of the first and second leg sections. The layer 202 of the friction material can be applied to the surface of the supporting member engaging the outer surface of the flange 452. The layers 202 and 324 are not shown in FIGS. 59-62 and are shown in select ones the preceding Figs.

### Eighteenth Mounting Device

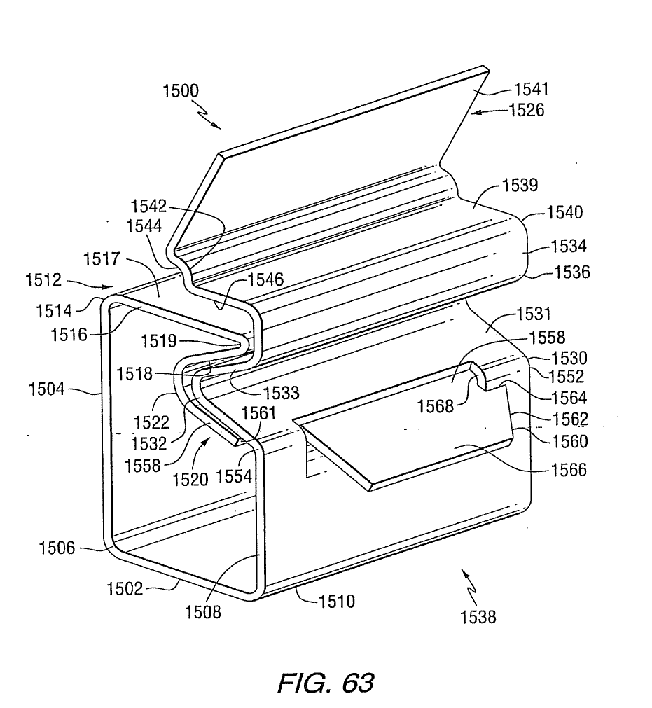

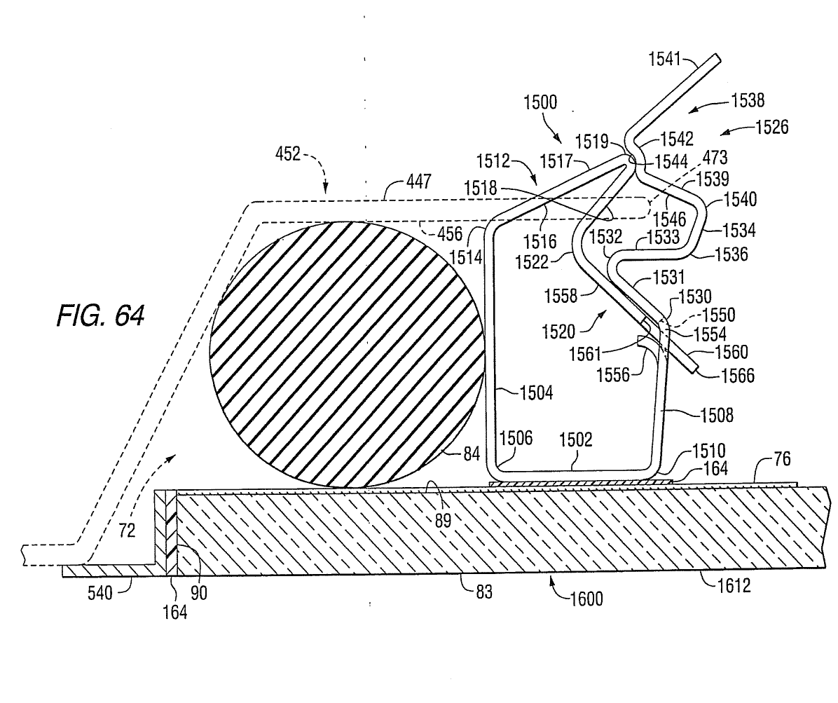

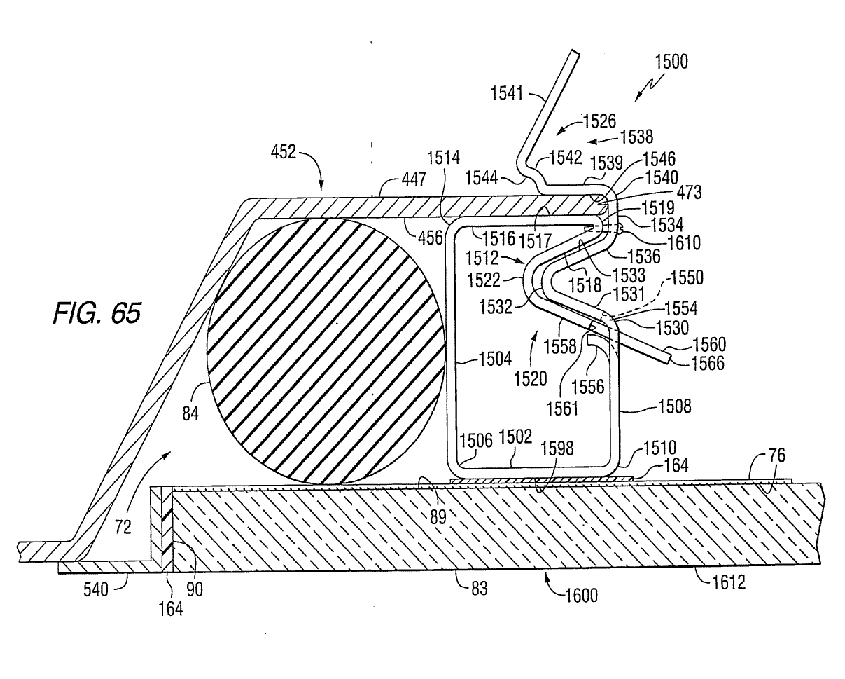

With reference to FIGS. 63-65 as needed, there is shown an eighteen non-limiting embodiment of a mounting device or mounting clip of the invention designated by the number 1500. In one non-limiting embodiment of the invention, the mounting device 1500 is made by bending or forming a configured piece of spring steel. The mounting device 1500 includes a base 1502, a first upright wall member 1504 connected to the base 1502 at connection area 1506, and a second upright wall member 1508 connected to the base 1502 at connection area 1510. A supporting member 1512 is connected to the first upright wall member 1504 at connection area 1514 spaced from the connection area 1506. The supporting member 1512 has a body 1516 with a flange supporting surface 1517. The flange supporting surface extends over and away from the base 1502. With the mounting device 1500 in the non-engaging position as shown in FIG. 64 and discussed below, the body 1516 of the supporting member 1512 angles away from the base 1502, and with the mounting device 1500 in the engaging position as shown it, FIG. 65 and discussed below, the body 1516 of the supporting member 1512 is generally parallel to the base 1502. The body 1516 of the supporting member 1512 is connected to stop member 1518 at connection area 1519. The stop member 1518 angles back towards the first wall member 1504 and is connected to activation and securing member 1520 at connection area 1522. The activation and securing member 1520 angles toward the second wall member 1508 with a portion of the activating and securing member 1520 passing through the second upright wall member 1508 in a manner discussed below. The second upright wall member 1508 extends away from the base 1502, is spaced from, and slightly angled away from, the first upright wall member 1504 and is connected to engaging arrangement 1526 discussed in detail below at connection area 1530.

The engaging arrangement 1526 includes an extension 1531 that is connected at the connection area 1530 to the second upright wall member 1508 and at connection area 1532 to stop-support member 1533. The extension 1531 angles in a direction over and away from the base 1502 of the mounting device 1500. The extension 1531 of the engaging arrangement 1526 and the activation and securing member 1520 of the supporting member 1512 are angled relative to one another such that the activation and securing member 1520 and the extension 1531 contact one another and slide relative to one another when the mounting device moves between the non-engaging position (see FIG. 64) and the engaging position (see FIG. 65) in a manner discussed below. Although not required, in the non-limiting embodiment of the invention shown in FIGS. 63-65, the stop-support member 1533 is generally flat and substantially parallel to the base 1502 when the mounting device is in the non-engaging position as shown in FIG. 64, and the stop-support member 1533 angles away from the base 1502 when the mounting device is in the engaging position as shown in FIG. 65. The stop-support member 1533 is connected to an extension arm 1534 at connection area 1536. The extension arm 1534 is connected to an engaging member 1538 having a first arm member 1539 connected to the extension arm 1534 at connection area 1540, and to a second arm member 1541 at connection area 1542. The connection area 1542 includes receiving area 1544 to receive and capture the connection area 1519 of the supporting member 1512 to maintain the engaging member 1538 and subsequently the mounting device 1500 in the non-engaging position as shown in FIG. 64. As is appreciated, the connection area 1519 and the receiving area 1544 are parts of a retention arrangement of the mounting device 1500. The first arm member 1539 of the engaging member 1538 of the engaging arrangement 1526 has a guide surface 1546 on which the connection area 1519 slides as the mounting device moves between the non-engaging position (see FIG. 64) and the engaging position (see FIG. 65). With particular reference to FIG. 63, the connection area 1530 connecting the extension 1531—of the engaging arrangement—1-526 and the second upright wall member 1508 has a slot 1550 extending between and terminating short of sides 1552 and 1554 of the connection area 1530 (clearly shown in FIG. 63) to receive activating and securing member 1520 of the supporting surface 1512 in a manner discussed below. In one non-limiting embodiment of the invention, the slot 1550 is formed by punching the slot in the sheet metal and using the punched out portion to provide a guide strip 1556 (clearly shown in FIGS. 64 and 65) to guide the activating and securing member 1520 into the slot 1550. As is appreciated, the slot 1550 and the activating and securing member 1520 are parts of another retention arrangement of the mounting device 1500.

The activating and securing member 1520 of the supporting member 1512 includes a first leg section 1558 connected to the stop member 1518 by the connection area 1522, and a second leg section 1560. The angled relationship of the activating and securing member 1520 and the extension 1531 of the engaging arrangement 1526 were discussed above. The width of the first leg section is greater than the width of the slot 1550, and preferably equal to or less than the width of the connection area 1530, and the second leg section 1560 is sized to pass through the slot 1550 when the supporting member 1512 and the first upright wall member 1504 are rotated relative to the base 1502, and the first and second upright wall members 1504 and 1508, respectively are moved toward one another in a manner discussed below. In one non-limiting embodiment of the invention, the second leg section 1560 includes an angled side 1562 having a notch 1564 to capture the second upright wall member 1508 between notch 1564 of the angled side 1562 of the second leg section 1560 and edge 1561 of the first leg section 1558 when the mounting device 1500 is in the engaging position (see FIG. 63). When the mounting device 1500 is in the non-engaging position (see FIG. 64), the notch 1564 is between the first and second upright wall members 1504 and 1508, respectively, and end portion 1566 of the second leg section 1560 extends through slot 1550 (see FIG. 64) with wall 1568 of the slot 1550 contacting the angled side 1562 of the second leg section 1560.

The support member 1512 is biased to resist movement toward the base 1502, and the engaging arrangement is biased to resist movement away from the first upright wall member 1504. Applying a force to the flanged supporting surface 1517 of the body 1516 of the supporting member 1512 to move the flanged supporting surface 1517 toward the base 1502, moves the connecting area 1519 out of the receiving area 1544 of the engaging member 1538 toward the stop-support member 1533 of the activation and securing member 1520, and moves the second leg section 1560 of the activation and securing member 1520 over the guide strip 1556 further into the slot 1550 in the connection area 1530. Continued movement of the flange supporting surface 1517 toward the base 1502, moves the connection area 1519 along the surface 1546 of the first arm member 1539 toward the stop-supporting member 1533 and—the angled side 1562 against the wall 1568 of the slot 1550. Because the side 1562 of the second leg section 1560 is angled (see FIG. 63), the second leg section 1560 as it moves farther through the slot 1550, the angled side 1562 slides along slot wall 1568 twisting the supporting member 1512 and the first upright wall member 1504. When the force applied to the flange supporting surface 1517 of the supporting member 1512 is sufficient to move the connection area 1519 along the surface 1546 of the first arm member 1539 to move the stop member 1518 at least in close proximity to, e.g. in contact with the stop-support member 1533, the notch 1564 will have moved past the wall 1568 of the slot 1550. The spring force in supporting member 1512 and the first upright wall member 1504 will force the angled side 1562 to rotate to rotate the notch 1564 to capture the wall 1568 of the slot 1550 in the notch 1564, locking the supporting member 1512 and the engaging member 1538 in the engaging position, as shown in FIG. 65. With the wall 1568 of the slot 1550 engaged by the notch 1564, the force applied to the flange supporting surface 1517 of the supporting member 1512 is removed, and the supporting member 1512 is biased away from the base 1502 by the internal spring force of the spring steel. The notch 1564 engaging the wall 1568 of the slot 1550 maintains the supporting member 1512 and the engaging member in a fixed position relative to one another against the internal spring force of the spring steel, i.e. maintains the mounting device 1500 in the engaging position as shown in FIG. 65. With reference to FIG. 65, the distance between the flange supporting surface 1517 and the surface 1546 of the first arm member 1539 of the engaging member 1538 is equal to or slightly greater than the thickness of the flange defining the recess. As can be appreciated, the flange supporting surface 1517 and/or the surface 1546 of the first arm member 1539 can be provided with a groove similar to the groove 1124 (groove 1124 shown only in the support plate 1180, only in FIG. 50 and only in phantom) similar to the area 880 in the retentive arm 852 of the tenth mounting device 824 to prevent the glob of paint 881 (see FIG. 35) from breaking or falling off the end of the flange. Although not required, the notch 1564 can be sized so that there is a small amount of movement of the notch 1564 permitted when the wall 1568 of the slot 1550 is fully engaged within the slot 1550.

Referring to FIGS. 64 and 65 as needed, in one non-limiting embodiment of the invention, outer surface 1598 of the base 1502 of each of a plurality of the mounting devices 1500 is secured by the adhesive layer 164 to the ceramic band 76 on the inner marginal edge portions 89 of the transparency 83 to provide panel 1600. A weather seal, e.g. and not limiting to the invention, the weather seal 84 is mounted on the ceramic band 76 encircling the mounting devices 1500 and having the ends of the weather seal contacting one another. The gasket 540 is attached to the sides 90-93 (the side 90 shown in FIGS. 64 and 65) of the transparency 83 by the adhesive layer 164 as previously discussed.

With continued reference to FIGS. 64 and 65, the mounting devices 1500 of the panel 1600 are put in the non-engaging position with the contact area 1519 of the supporting member 1512 in the receiving area 1544 of the engaging member 1538 and the notch 1564 between the first and second upright wall members 1504 and 1508, respectively. The panel 1600 is moved into the recess 72 to (1) move the outer surface 456 of the flange 452 and the flanged supporting surface 1517 into engagement with one another to move the flanged supporting surface 1517 toward the base 1502; (2) move the connecting area 1519 out of the receiving area 1544 of the engaging member 1538 and toward the stop-support member 1533 of the activation and securing member 1520, and (3) move the second leg section 1560 of the activation and securing member 1520 over the guide strip 1556 further into the slot 1550 in the connection area 1530. The panel is moved into the recess 72 until the wall 1568 of the slot 1550 is captured in the notch 1564 in the manner discussed above to put the mounting device in the engaging position, as shown in FIG. 65 with the surface 1546 of the first arm member 1539 of the engaging member 1538 over the inner surface 447 of the flange 452 and the flange supporting surface 1517 of the supporting member 1512 engaging the outer surface 456 of the flange 452. The pressure applied to move the panel 1600 into the recess 72 is removed, and the supporting member 1512 is biased away from the base 1502 against by the internal spring force of the spring steel to move the flange supporting surface 1517 of the supporting member 1512 against the outer surface 456 of the flange 452 and the surface 1546 of the first arm member 1539 of the engaging member 1538 against the inner surface 447 of the flange 452. The flange 452 is captured between the supporting member 1517 and the engaging member 1538 to secure the panel 1600 in the recess 72.

Although not limiting to the invention, a locking arrangement, e.g. a screw 1610 (shown only in FIG. 65) can be used to prevent the supporting member 1512 from moving toward the base 1502 should a force be applied to outer surface 1612 of the panel 1600 greater than the internal biasing force of the spring steel of the mounting device 1500. Further the screw 1610 prevents the engaging arrangement 1526 from moving away from the supporting member 1512.

The panel 1600 can be removed from the recess 72 of the vehicle in any convenient manner. In one non-limiting embodiment of the invention, the screw 1610, if present, is removed. The angled side 1562 is moved to move the wall 1568 out of the slot 1550 and against the angled side 1562; thereafter, a downwardly directed force is applied to the second arm member 1541 of the engaging member 1538, biasing the engaging member 1536 away from the base 1502 of the mounting device, e.g. in a clockwise direction about the connection area 1530, as viewed in FIG. 64. This movement will also move surface 1546 of first arm member 1538 away from the outer surface 456 of the flange 452 and allow the supporting member 1512 to rotate away from the base 1502, e.g. in a counterclockwise to release the flange 452 and move the mounting device 1500 towards its non-engaging position. The connection area 1519 of the supporting member 1512 is now positioned within the receiving area 1544 of the engaging member 1538 to maintain the engaging member 1536 in position to allow removal of the panel 1600.

Although not limiting to the invention, the layer 324 of low friction material can be provide on the wall 1568 of the slot 1550, on the guide surface 1556, on the flange receiving surface 1517 of the supporting member, on the connection area 1419 of the supporting member, and/or on the receiving area 1544 of the engaging member 1538. The layer 202 of the friction material can be applied to the surface of the stop-support member 1533 contacting the stop member 1518. The layers 202 and 324 are not shown in FIGS. 63-65 and are shown in select ones the preceding figures.

### Nineteenth Mounting Device

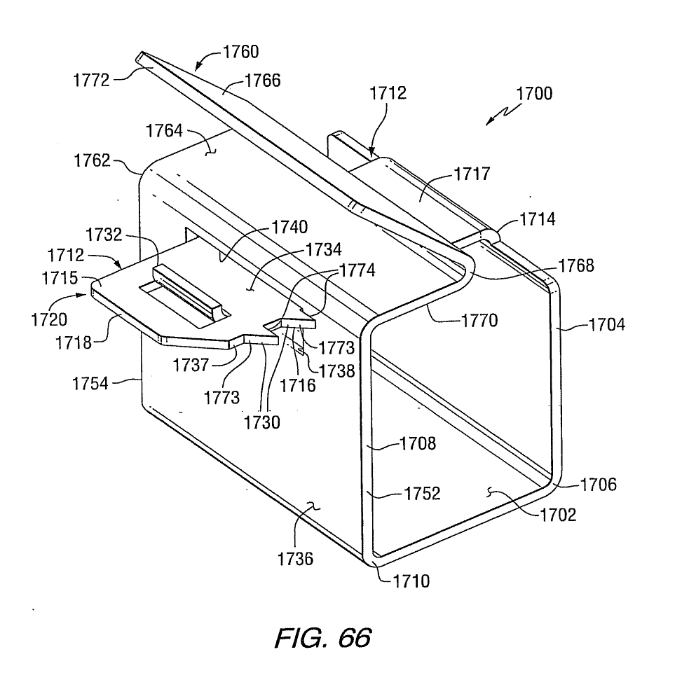

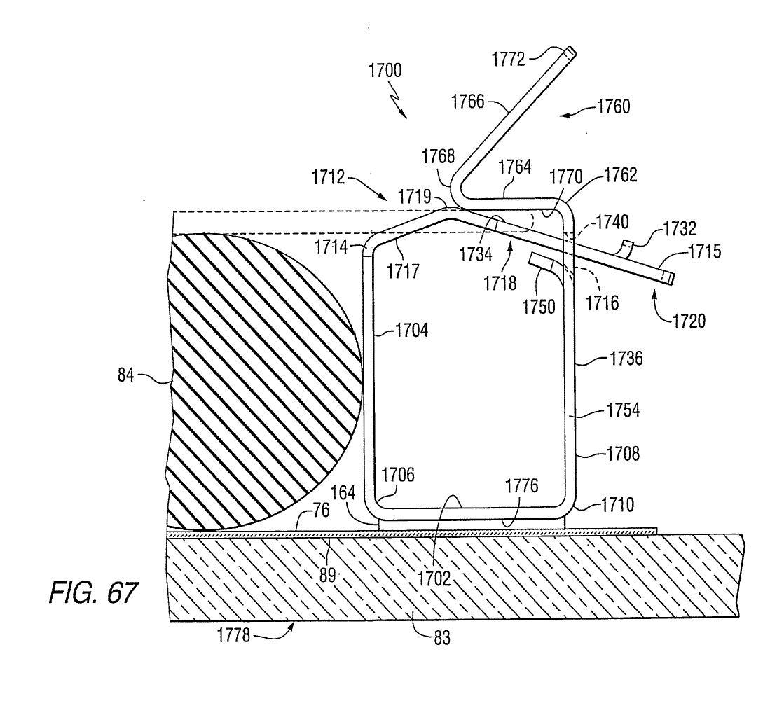

With reference to FIGS. 66-69 as needed, there is shown a nineteenth non-limiting embodiment of a mounting device or mounting clip of the invention designated by the number 1700. In one non-limiting embodiment of the invention, the mounting device 1700 is made by bending or forming a configured piece of spring steel. The mounting device 1700 includes a base 1702, a first upright wall member 1704 connected to the base 1702 at connection area 1706, and a second upright wall member 1708 connected to the base at connection area 1710. A supporting member 1712 is connected to the first upright wall member 1704 at connection area 1714 and extends over the base 1702 with an end portion 1715 extending through slot 1716 in the second upright wall member 1708. The supporting member 1712 includes a first section 1717 and a second section 1718 connected to one another by connection area 1719. With the mounting device 1700 in the initial or non-engaging, non-cocked position, discussed in detail below, the supporting member 1712 has a “V” shape with the opening of the “V” facing the base 1702 (see FIG. 67).

The second section 1718 of the supporting member 1712 terminates with a cocking and locking member 1720 having the end portion 1715 extending through the slot 1716. The cocking and locking member 1720 of the second section 1718 of the supporting member 1712 includes one or more teeth members 1730 (shown only in FIG. 66) that serve to lock the first upright wall member 1704, the supporting member 1712 and the second upright wall member 1708 in place when the mounting device 1700 is in the engaging position, as will be discussed later in more detail. The cocking and locking member 1720 also includes a latch member 1.732, which extends upwardly from surface 1734 of the second section 1718. In one non-limiting embodiment of the invention, the latch member 1732 is formed by punching a slot in the second section 1718 and curving the punched section away from the surface 1734, as shown in FIGS. 66-69.

The width of the second section 1718; the height of the latch member 1732 plus the thickness of the second section 1718, and the opening of the slot 1716 are sized such that the cocking and locking member 1720 can pass through the slot 1715 in the second upright wall member 1708 after which each one of the teeth members 1730 as it passes through the slot 1716 engages the outer surface 1736 of the second upright wall member 1708. In one non-limiting embodiment of the invention, side 1737 (see FIG. 66) of the second section 1718 of the supporting member 1712 having the teeth members 1730 is biased toward a wall or side wall of the slot 1716, e.g. wall 1738 in FIG. 66, and the surface 1734 of the second section 1718 is biased away from the base 1702. The width of the slot 1716 is equal to or slightly larger that the widest portion of the cocking and locking member 1720, and the height of the slot 1716 is equal to or slightly greater than the highest portion, e.g. the portion of the second section 1718 having the latch member 1732. In this manner, as each one of the teeth members 1730 moves from between the first and second upright members 1704 and 1708, respectively, through the slot 1716, the cocking and locking member 1720 is moved away from the wall 1738 of the slot toward the opposite wall of the slot 1716 against the internal biasing action of the spring steel. After one of the teeth members 1730 passes through the slot 1716, the biasing action of the spring steel moves the side 1737 of the cocking and locking member against the wall 1738 of the slot 1716 to prevent the first and second upright wall members 1704 and 1708, respectively from moving away from one another. When the latch member 1732 moves from between the first and second upright wall members 1704 and 1708, respectively, through the slot 1716, the cocking and locking member 1720 moves toward the base against the internal biasing action of the spring steel to pass the latch member 1732 through the slot 1716. After the latch member 1732 passes through the slot 1716, the biasing action moves the cocking and locking member 1720 away from the base against upper wall 1740 of the slot 1716.

In one non-limiting embodiment of the invention, the slot 1716 is formed by punching the slot in the sheet metal and using the punched out portion to provide a guide strip 1750 to guide the cocking and locking member 1720 into the slot 1716 in a manner discussed below. The slot 1716 is punched in the second upright wall member 1708 with the side walls of the slot 1716 spaced from adjacent one of sides 1752 and 1754 of the second upright wall member 1708. The second upright wall member 1708 further includes an engaging member 1760 connected to the second upright wall member 1708 by connection area 1762. The engaging member 1760 includes a first arm member 1764, which is spaced from and extends over the base 1702, and a second arm member 1766; which angles upward and away from base 1702 and is interconnected to the first arm member by connection area 1768. Surface 1770 of the first arm member 1764 of the engaging member 1760 is generally in facing relationship to the surface 1734 of the second section 1718 of the supporting member 1712 (see FIG. 67).

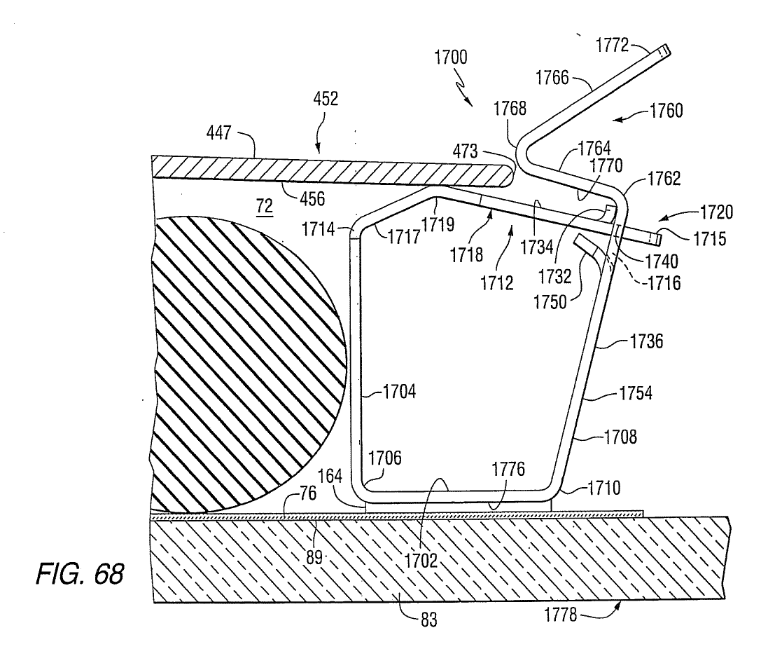

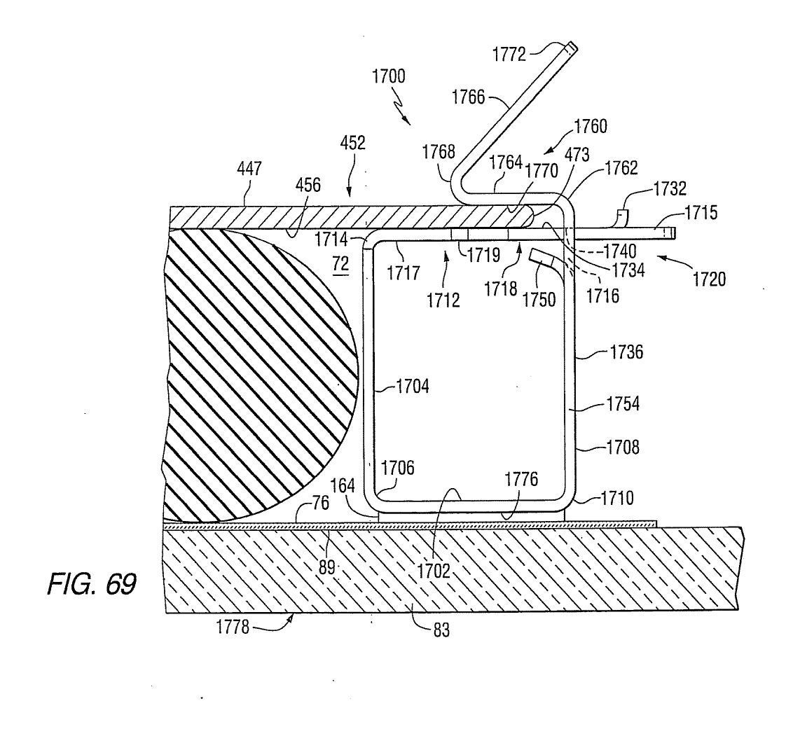

With continued reference to FIGS. 66-69 as needed, in one non-limiting embodiment of the invention, the mounting device 1700 is moved from the initial position or the non-engaging, uncocked position (FIG. 67) to the non-engaging, cocked position (FIG. 68), and thereafter to the engaging position (FIG. 69). In the non-engaging, uncocked position, the mounting device has the first and second sections 1717 and 1718, respectively of the supporting member 1712 forming the “V” shape (see FIG. 67) and the latch member 1732 and optionally the teeth members 1730 of the cocking and locking member 1720 in facing relationship to the outer surface 1736 of the second upright wall member 1708. In one non-limiting embodiment of the invention, the mounting device is moved from the non-engaging, uncocked position to the non-engaging, cocked position (see FIG. 68) by moving the first upright wall member 1704 and the second upright wall member 1708 away from one another, e.g. moving end 1772 of the second arm member 1766 of the engaging member 1760 to move the second upright wall member away from the first upright member while moving the end portion 1715 of the supporting member 1712 away from the wall 1738 of the slot 1716 (see FIG. 66) and toward the base 1702 to pass the teeth members 1730 and the latch member 1732 through the slot 1716. After the latch member 1746 has passed through the slot 1716, the end portion 1715 of the supporting member 1712 is released and the upward biasing force of the supporting member 1712 (the internal biasing force of the spring steel) forces the second section 1718 of the supporting member 1712 away from the base 1702 to move the second section 1718 against the upper wall 1740 of the slot 1716 (see FIGS. 66 and 68). The force applied to the second upright wall member 1708 is removed, and the second upright wall member 1708 is moved by the internal biasing force of the spring steel toward the first upright wall member 1702 into engagement with the latch member 1732. In this position, the latch member 1732 maintains the second upright wall member 1708 in position spaced from the first upright wall member 1704 to place the mounting device 1700 in the non-engaging, cocked position (see FIG. 68). As is appreciated the latch member 1732 and the engaged surface of the second upright wall member 1708 are parts of a retention arrangement of the mounting device 1700.

In another non-limiting embodiment of the invention, the mounting device 1700 is moved from the non-engaging, uncocked position to the non-engaging, cocked position in the following manner. The second upright wall member 1708 and engaging member 1760 are rotated away from the first upright wall member 1704 as shown in FIG. 68; the second upright member 1708 is rotated clockwise about connection area 1710, for example by applying a lateral force to the end 1772 of the second arm member 1766. As the second upright wall member 1708 moves, the internal biasing forces of the supporting member 1712 biases the second section 1718 of the supporting member 1712 upward against upper wall 1740 of the slot 1716. As the second upright wall member 1708 continues to rotate, the latch member 1732 slides along the upper wall 1740 of the slot 1716 until the latch member 1732 moves completely through the slot 1716. At this point, the upward biasing force of the supporting member 1712 forces the latch member 1732 to move away from the base 1702 and to move the end portion 1715 of the supporting member 1712 into engage with the upper wall 1740 of the slot 1716. The engaging member 1760 is released, and the second upright wall member 1708 engages the latch member 1732. In this position, the latch member 1732 will hold the second upright wall member 1708 in place. As can be seen, the engaging member 1760 is also rotated away from the support member 1712. In this configuration, the mounting device 1700 is in the non-engaging, cocked position. It should be appreciated that as mounting device 1700 in this non-limiting embodiment of the invention is being put in the non-engaging, cocked position, the second section 1718 of the supporting member 1712 is biased in a direction that allows the teeth members 1730 to pass through slot 1716. More specifically, referring to FIG. 66, the supporting section 1718 is biased away from the side wall 1738 of the slot 1716. After the latch member 1732 has engaged the second upright wall member 1708, the biasing force applied to the second section 1718 of the supporting member 1712 can be released and the internal spring forces of the mounting device 1700 will reposition the second section 1718 back to it original orientation with the slot 1716.

In one non-limiting embodiment of the invention, the mounting device 1700 is moved from the non-engaging, cocked position to the engaging position (see FIG. 69) in the following manner. With reference to FIGS. 68 and 69 as needed, a force is applied to the supporting member 1712, e.g. but not limiting to the invention to the connection area 1719, to move the supporting member 1712 toward the base 1702 of the mounting device 1700. As the supporting member 1712 moves toward the base 1702, the first and second sections 1717 and 1718, respectively move into the same plane or into alignment with one another as the latch member 1732 moves toward the base 1702 of the mounting device 1700 and against the second upright wall member 1708 moving the second upright wall member 1702 against the internal biasing action of the spring steel further away from the first upright wall member 1704. As the second section 1718 of the supporting member 1712 moves further toward the base, it also moves away from the upper wall 1740 of the slot 1716 in the second upright wall member 1708 (see FIG. 66). When the latch member 1732 is generally aligned or almost aligned with the slot 1716, the internal biasing action of the spring steel moves the second upright wall member 1708 toward the first upright wall member 1704 moving the latch member 1732 and the teeth members 1730 of the cocking and locking member 1720 through the slot 1716. As the teeth members 1730 pass through the slot 1716, angled surface 1773 of each one of the teeth members 1730 individually engage the side wall 1738 of the slot 1716 (see FIG. 66) moving the end portion 1715 of the supporting member 1712, e.g. the cocking and locking member 1720 away from the side wall 1738 to pass the teeth member 1730 through the slot 1716. After the last of the teeth members 1730 passes through the slot 1716, stop surface 1774 (see FIG. 66) of the last one of the teeth members to pass through the slot 1716 moves in facing relationship to the surface 1736 of the second upright wall member 1708 to prevent the first and second upright wall members 1704 and 1708 from moving away from one another. As the second upright wall member 1708 moves toward the first upright wall member, the engaging member 1760 moves toward and over the supporting member 1712, e.g. over the connection area 1719 of the supporting member 1719. The applied force to the supporting member 1712 is removed and the supporting member moves toward the first arm member 1764 of the engaging member 1760 to capture an object, e.g. the flange 452 between the surface 1734 of the second section 1718 of the supporting member 1712 and the surface 1770 of first arm member 1764 of the engaging member 1760 as shown in FIG. 69. The mounting device is now in the engaging position. As is appreciated, selected parts of the cocking and locking member 1720, the slot 1716 and/or the second upright wall member provide parts of another retention arrangement of the mounting device 1700.

With reference to FIG. 65, the distance between the surface 1770 of the first arm member 1764 of the engaging member 1760 and the surface 1734 of the second section 1718 of the supporting member 1712 when the mounting device 1700 is in the engaging position is equal to or slightly greater than the thickness of the flange defining the recess. As can be appreciated, the surface 1770 and/or the surface 1734 can be provided with a groove similar to the groove 1124 (groove 1124 shown only in the support plate 1180, only in FIG. 50 and only in phantom) similar to the area 880 in the retentive arm 852 of the tenth mounting device 824 to prevent the glob of paint 881 (see FIG. 35) from breaking or falling off the end of the flange. Although not required, the slot 1716 can be sized so that there is a small amount of movement of the second section 1718 of the supporting member 1712 toward and away from the base 1705 of the mounting device 1700 permitted when the mounting device is in the engaging position.

With reference to FIGS. 67 and 69, it is appreciated that a difference between the mounting device in the non-engaging, uncocked position (see FIG. 67) and the engaging position (see FIG. 69) is that the mounting device 1700 in the non-engaging, uncocked position has the first and second sections 1717 and 1718, respectively, of the supporting member 1712 forming a “V” shape (see FIG. 67) whereas the mounting device in the engaging position has the first and second sections 1717 and 1718, respectively, of the supporting member generally aligned with one another (see FIG. 68). Further, the invention is not limited to the number of teeth member 1730 of the cocking and locking member 1720. Various other embodiments of the invention contemplate the cocking and locking member having less than 2 or more than 2 teeth members 1730.

Referring to FIGS. 67-69 as needed, in one non-limiting embodiment of the invention, outer surface 1776 of the base 1702 of each of a plurality of the mounting devices 1700 is secured by the adhesive layer 164 to the ceramic band 76 on the inner marginal edge portions 89 of the transparency 83 to provide panel 1778. A weather seal 84 is mounted on the ceramic band 76 encircling the mounting devices 1700 and having the ends of the weather seal contacting one another. A gasket (not shown in FIGS. 67-69), e.g. and not limiting to the invention, the gasket 540 (see FIG. 65) is attached to the sides 90-93 of the transparency 83 (not shown in FIGS. 67-69) by the adhesive layer 164 as previously discussed and shown in selected ones of the preceding Figs.

The mounting devices 1700 on the panel 1778 are put in the non-engaging, cocked position (see FIG. 68) as discussed above to expose the connection area 1719 and portions of the second section 1718 of the supporting member 1712 to the outer surface 456 of the flange 452. The panel 1778 with the mounting devices 1700 in their non-engaging and cocked position (see FIG. 68) is moved into the recess 72 in the body of the vehicle to move the end 473 of the flange 452 passed the connection area 1768 of the engaging member 1760 to move the connection area 1719 of the supporting member 1712 and the outer surface 456 of the flange 452 into contact with one another. The panel 1778 is moved further into the recess 72, moving the supporting member 1712 against the outer surface 456 of the flange 452 and toward the base 1702 to (1) move the first and second sections 1717 and 1718, respectively of the supporting member 1712 into alignment or near alignment with one another, (2) move the second upright member 1708 away from the first upright member 1704 against the biasing action of the spring steel and (3) the latch member 1732 and the teeth members 1730 through the slot 1716 in the second upright wall member 1708, as discussed above. As the second upright wall member 1708 moves over the cocking and locking member 1720 toward the first upright wall member 1704, the first arm member 1764 of the engaging member 1760 moves over the inner surface 447 of the flange 452. The force applied to move the panel 1778 into the recess 72 is discontinued, and the supporting member 1712 moves away from the base 1702 and the transparency 83 to move the surface 1734 of the second section 1718 of the supporting member against the outer surface 456 of the flange 452 to move the inner surface 447 of the flange 452 against the surface 1734 of the first arm member 1764 of the engaging member 1760. The flange 452 is captured between the supporting member 1712 and the engaging member 1760 to secure the panel 1778 in the recess 72.

Although a locking arrangement can be used in the practice of the invention to prevent movement of the second upright wall member 1708 and the first upright wall member 1704 of the mounting device 1700 relative to one another, in one non-limiting embodiment of the invention, the stop surface 1774 of one of the teeth members 1730 engaging the outer surface 1736 of the second upright wall member 1708 prevents the first and second upright wall members from moving away from one another. Movement of the panel 1778 into the recess 72 is limited by the height of the slot 1716. More particularly, when the second section 1718 of the supporting member 1712 contacts the wall of the slot 1716 opposite to the wall 1740 of the slot 1716 (see FIG. 66), the panel 1778 will move no farther into the recess 72.

The panel 1778 can be removed from the recess 72 of the vehicle in any convenient manner. In one non-limiting embodiment of the invention, each of the mounting devices are moved from the engaging position to the non-engaging, cocked position by moving the end portion 1715 of cocking and locking member 1720 away from the side wall 1738 of the slot 1716 to move the stop surface 1774 of the one of the teeth members 1730 contacting the surface 1736 of the second upright wall member 1708 out of engagement with the surface 1736 and moving the end portion 1715 toward the base 1702 of the mounting device 1700. Thereafter, the second upright wall member is moved away from the first upright wall member 1708, moving the teeth members 1730 and the latch member 1732 trough the slot 1716. After the latch member 1732 passes through the slot, the end portion 1715 of the supporting member 1712 is released and the supporting member moves under the internal biasing action of the spring steel away from the base against the upper wall of the slot 1716. The second upright wall member 1708 is released to place the mounting device in the non-engaging, cocked position.

In another non-limiting embodiment of the invention, the mounting device is placed in the non-engaging, cocked position by applying a lateral force to the end 1772 of the second arm member 1766 of the engaging member 1760; biasing the engaging member 1760 and the second upright wall member 1708 in a clockwise direction about connection area 1710. This movement will also move the surface 1770 of the first arm member 1764 away from the inner surface 447 of the flange 452 and allow the supporting member 1712 to assume its original V-shape and rotate counterclockwise towards its non-engaging position. At the same time, the second section 1718 of the supporting member 171.2 is biased away from the-side wall • 1738 of the slot 171610 disengage the one of the teeth members 1730 engaging the second upright wall member 1708 and allow the second section 1718 of the supporting member 1712 to slide through the slot 1716 to put the mounting device in the non-engaging, cocked position (see FIG. 68). With the mounting devices, in the non-engaging, cocked position, the panel 1778 is removed from the recess 73.

Although not limiting to the invention, the layer 324 of low friction material can be provide on the inner walls of the slot 1716, on the connection area 1719 of the supporting member 1712, on the engaging surface 1770 of the first arm member 1764 of the engaging member 1760 and/or the portion of the surface of the supporting member 1712 over which the outer surface 456 of the flange 452 slides. The layer 202 of the friction material can be applied to the surface of the teeth 1730 engaging the outer surface 1736 of the second upright wall member 1708. The layers 202 and 324 are not shown in FIGS. 66-69 and are shown in select ones the preceding figures.

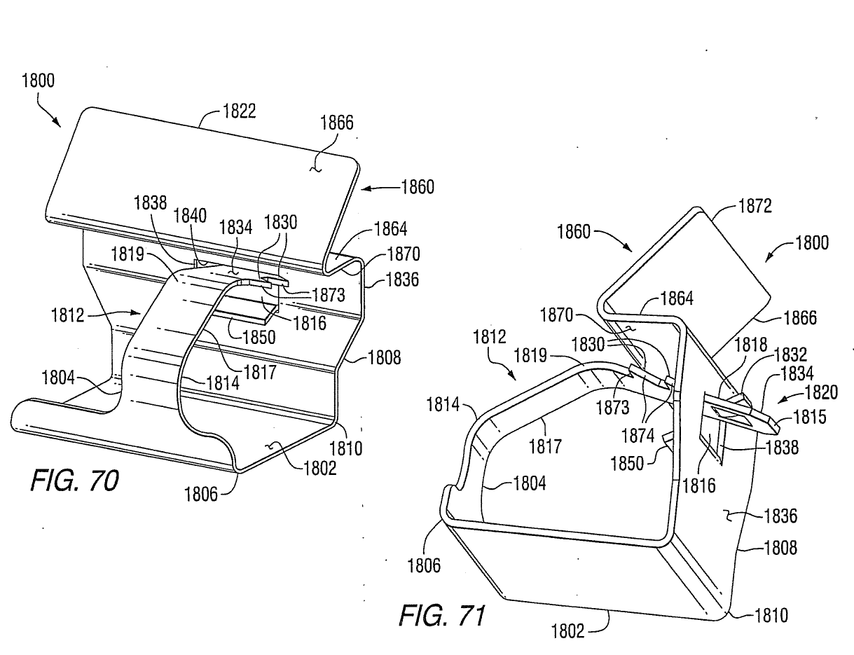

FIGS. 70 and 71 illustrate an alternate embodiment to mounting device 1700. It should be appreciated that the changes made to device 1700 and described herein can be incorporated into the other previously disclosed mounting devices. More specifically, the mounting device 1800 is made by bending or forming a configured piece of spring steel and includes a base 1802, a first upright wall member 1804 connected to the base 1802 at connection area 1806, and a second upright wall member 1808 connected to the base at connection area 1810. A supporting member 1812 is connected to the first upright wall member 1804 at connection area 1814 and extends over the base 1802 with an end portion 1815 extending through slot 1816 in the second upright wall member 1808. The supporting member 1812 includes a first section 1817 and a second section 1818 connected to one another by connection area 1819. With the mounting device 1800 in the initial or non-engaging, non-cocked position, discussed in detail below, the supporting member 1812 has a “V” shape with the opening of the “V” facing the base 1802.

Similar to mounting device 1700, the second section 1818 of the supporting member 1812 of mounting device 1800 terminates with a cocking and locking member 1820 having the end portion 1815 extending through the slot 1816. The cocking and locking member 1820 of the second section 1818 of the supporting member 1812 includes one or more teeth members 1830 that serve to lock the first upright wall member 1804, the supporting member 1812 and the second upright wall member 1808 in place when the mounting device 1800 is in the engaging position, as will be discussed later in more detail. The cocking and locking member 1820 also includes a latch member 1832, which extends upwardly from surface 1834 of the second section 1818. In one non-limiting embodiment of the invention, the-latch member 1832 is formed by punching a slot in the second section 1818 and curving the punched section away from the surface 1834.

Unlike device 1700, wall member 1804 of mounting device 1800 does not extend the entire width of the mounting device. In the particular non-limiting embodiment shown in FIGS. 70 and 71, the width of wall member 1804 at connection area 1806 is equal to the width of base 1802 but then is reduced at connecting area 1814. Although not required, the width of wall member 1804 can be reduced to about 25-50% of the width of base 1802. Typically, the width of support member 1812 is the same as the reduced width of wall member 1804, e.g. as shown in FIGS. 70 and 71, but it should be appreciated that this configuration is not required. In addition, the height of wall member 1804 in mounting device 1800 is reduced so that the distance between connecting areas 1806 and 1814 is less than the distance between connecting areas 1706 and 1714 of a similarly sized mounting device 1700.

The reduction in wall width and height of member 1804 serves to reduce the amount of force required to pivot support member 1812 downward about connecting area 1814, as will be discussed later in more detail. This in turn reduces that level of pressure required to install a panel incorporating the mounting devices 1800 in an opening, for example mounting a transparency in a window opening of a vehicle, as discussed earlier.

The other components and features of device 1800 are similar to those corresponding components and features of mounting device 1700. Furthermore, functional device 1800 operates in a similar manner. More specifically, in one non-limiting embodiment of the invention, the mounting device 1800 is moved from the non-engaging, uncocked position to the non-engaging, cocked position in the following manner. The second upright wall member 1808 and engaging member 1860 are rotated away from the first upright wall member 1804, similar to device 1700 in FIG. 68, i.e. the second upright member 1808 is rotated clockwise about connection area 1810 as viewed in FIGS. 70 and 71, for example by applying a lateral force to the end 1872 of the second arm member 1866. As the second upright wall member 1808 moves, the internal biasing forces of the supporting member 1812 biases the second section 1818 of the supporting member 1812 upward against upper wall 1840 of the slot 1816. As the second upright wall member 1808 continues to rotate, the latch member 1832 slides along the upper wall 1840 of the slot 1816 until the latch member 1832 moves completely through the slot 1816. At this point, the upward biasing force of the supporting member 1812 forces the latch member 1832 to move away from the base 1802 and to move the end portion 1815 of the supporting member 1812 into engage with the upper wall 1840 of the slot 1816. The engaging member 1860 is released, and the second upright wall member 1808 engages the latch member 1832. In this position, the latch member 1832 will hold the second upright wall member 1808 in place. As can be seen, the engaging member 1860 is also rotated away from the-support member 1812. In this configuration, the mounting device 1800 is in the non-engaging, cocked position. It should be appreciated that as mounting device 1800 in this non-limiting embodiment of the invention is being put in the non-engaging, cocked position, the second section 1818 of the supporting member 1812 is biased in a direction that allows the teeth members 1830 to pass through slot 1816. More specifically, the supporting section 1818 is biased away from the side wall 1838 of the slot 1816. After the latch member 1832 has engaged the second upright wall member 1808, the biasing force applied to the second section 1818 of the supporting member 1812 can be released and the internal spring forces of the mounting device 1800 will reposition the second section 1818 back to it original orientation with the slot 1816.

In one non-limiting embodiment of the invention, the mounting device 1800 is moved from the non-engaging, cocked position to the engaging position, similar to device 1700 in FIG. 69 in the following manner. A force is applied to the supporting member 1812, e.g. but not limiting to the invention, to the connection area 1819 to pivot support member 1812 clockwise about connection area 1814 and move the supporting member 1812 toward the base 1802 of the mounting device 1800. As the supporting member 1812 moves toward the base 1802, the first and second sections 1817 and 1818, respectively, begin to align with one another as the latch member 1832 moves toward the base 1802 of the mounting device 1800 and against the second upright wall member 1808 moving the second upright wall member 1802 against the internal biasing action of the spring steel further away from the first upright wall member 1804. As the second section 1818 of the supporting member 1812 moves further toward the base, it also moves away from the upper wall 1840 of the slot 1816 in the second upright wall member 1808. When the latch member 1832 is generally aligned or almost aligned with the slot 1816, the internal biasing action of the spring steel moves the second upright wall member 1808 toward the first upright wall member 1804 moving the latch member 1832 and the teeth members 1830 of the cocking and locking member 1820 through the slot 1816. As the teeth members 1830 pass through the slot 1816, angled surface 1873 of each one of the teeth members 1830 individually engage the side wall 1838 of the slot 1816 moving the end portion 1815 of the supporting member 1812, e.g. the cocking and locking member 1820 away from the side wall 1838 to pass the teeth member 1830 through the slot 1816. After the last of the teeth members 1830 passes through the slot 1816, stop surface 1874 of the last one of the teeth members to pass through the slot 1816 moves in facing relationship to the surface 1836 of the second upright wall member 1808 to prevent the first and second upright wall members 1804 and 1808 from moving away from one another. As the second upright wall member 1808 moves toward the first upright wall member, the engaging member 1860 moves toward and over the supporting member 1812, e.g. over the connection area 1819 of the supporting member 1819. The applied force to the supporting member 1812 is removed and the supporting member moves toward the first arm member 1864 of the engaging member 1860 to capture an object, e.g. a flange between the surface 1834 of the second section 1818 of the supporting member 1812 and the surface 1870 of first arm member 1864 of the engaging member 1860. The mounting device is now in the engaging position. As is appreciated, selected parts of the cocking and locking member 1820, the slot 1816 and/or the second upright wall member provide parts of another retention arrangement of the mounting device 1800. In addition, it is noted that when device 1800 is in its engaging position, sections 1817 and 1818 of support member 1812 are not aligned (as sections 1717 and 1718 of device are aligned in FIG. 69) but rather remain angularly offset relative to each other. However, in one non-limiting embodiment of the invention, when in the engaging position, second section 1818 is generally parallel to surface 1870 of first arm member 1864.

Although not limiting in the present invention, the width of the first arm member 1864 of the engaging member 1860 can be increased to increase the capture area of surface 1870. For example, in the non-limiting embodiment of the invention shown in FIGS. 70 and 71, the width of the first arm member 1864, along with wall member 1808, is increased so that its width is greater than that of base 1802.

As can now be appreciated, the mounting devices or mounting clips incorporating features of the invention can be made of any material that provides the structural stability required for the mounting clip to secure the panel in the recess, e.g. materials that can be used in the practice of the invention but not limiting thereto include metal, plastic, wood and combinations thereof. In the preferred practice of the invention, the material is metal, and in one non-limiting embodiment of the invention the metal is electro coated steel, which provides a better adherent surface for polymer adhesives than uncoated steel. Further the mounting devices incorporating features of the invention can be made in any manner, e.g. but not limiting to the invention, machining, forming, pressing, cutting, molding, casting, joining components and combinations thereof. The components of the mounting devices can be joined in any convenient manner, e.g. but not limiting to the invention by mechanical fasteners, adhesives, interlocking ends of components and combinations thereof.

The invention is not limited to using the mounting devices or mounting clips of the invention with any particular flange design, and the mounting devices of the invention can be used with any type of flange design known in the art and/or disclosed herein. Further interior trim is preferably provided to cover the mounting devices to provide an aesthetic appearance of the panel area from the interior of the vehicle. Further; components of the non-limiting embodiment of the mounting devices of the invention are interchangeable, e.g. but not limiting to the invention panels having the mounting devices of the invention can have any design of a gasket and/or weather seal known in the art and/or disclosed herein attached to the transparency of the panel. Still further each of the mounting devices can have an enlarged area similar to the enlarged area 880 of the engaging member 825 of the mounting device 824 (see FIG. 35) to prevent damage to the glob of paint at the end of the flange.

As is appreciated, the invention is not limited to the type of adhesive layer 164 used to secure the mounting devices on the marginal edges of the transparency. In the preferred practice of the invention, the adhesive layer 164 has shear strength greater than 250 pounds per square inch (“psi”), preferably greater than 400 psi and more preferably greater than 500 psi. Adhesive that can be used in the practice of the invention include, but are not limited to moisture curable urethanes sold by Dow Automotive as Part No. 58702 and 57502 having a shear strength of about 250 psi, and a two component chemically reactive urethane of the type sold by Dow Automotive as Part No. U-216 has shear strength of about 500 psi.

The invention is not limited to the type of weather seal used between the inner marginal edges 89 of the transparency 83 and the outer surface of the flange. Non-limiting embodiments of weather seals include, but are not limited to, an applied tacky layer of non-structural urethane, a preformed tape or rope having a tacky surface and a preformed tape or rope having a non-tacky surface, adhered the inner marginal edges of the transparency or to the outer surface of the flange by an adhesive layer. In the preferred practice of the invention, the weather seal is an applied tacky layer of non-structural urethane or a preformed tape or rope having a tacky surface. As is appreciated by those skilled in the art, using a preformed weather seal having a non-tacky surface, e.g. of the type sold by Saargummi Technologies requires the additional step of securing the weather seal to the transparency or flange with an adhesive layer. In the more preferred practice of the invention, the weather seal is a preformed urethane tape or rope having a tacky surface of the type sold by Adco Products Inc. of Michigan, Part No. RT0140.

The gaskets can be secured to the sides 90-93 and/or marginal edges of the transparency 83 using any type of adhesive used in the art. For example and not limiting to the invention, the adhesive to secure the gasket to the transparency can be the same adhesive used to secure the preformed weather seal 1216 (see FIG. 54) and/or the mounting devices to the transparency.

In a preferred non-limiting embodiment of the invention, the butyl rope and/or gasket is (are) applied to the transparency at a location assembling the panels. A protective covering of the type used in art, e.g. a paper tape is applied to the butyl rope to protect the rope during shipment of the panels. The protective covering is removed before moving the panel into the recess in the body of the vehicle. Portions of the urethane rope remaining on the inner marginal edge portions of the transparency that is to be reused and/or outer surface of the flange after the panel is removed from the recess can be removed in any convenient manner, e.g. and not limiting to the invention, swiping the flange or transparency with a plastic straight edge to remove the excess butyl rope on the flange and/or transparency, and a new tape or rope applied to the inner marginal edges of the transparency to be reused and/or outer surface of the flange without further cleaning of the transparency and/or flange. This removal procedure is acceptable because the weather seal does not provide structural strength but provides a resistance or barrier to fluid flow between the transparency of the panel and the outer surface of the flange.

The mounting devices of the invention were discussed to secure a panel in a recess and to remove a panel having an unbroken or undamaged transparency. The unbroken or undamaged panel is removed from the recess 72 to, among other things and not limiting to the invention, replace the existing panel with another panel having a different color, different transmission, upgraded solar coating, self cleaning coatings and combinations thereof, and/or to salvage undamaged transparencies from vehicles having extensive body damage. As is appreciated by those skilled in the art, removal of an undamaged transparency installed in a recess practicing the prior art as shown in FIG. 3, is difficult because of limited access to the structural adhesive between the transparency and the outer surface of the flange.

In the instance when the panel is being replaced because the transparency is broken, the mounting devices, except for mounting devices 1000 (FIGS. 42-44) and 1060 (FIGS. 45-47) in their engaging position can be pushed and/or pulled from their respective flange. The mounting devices 1000 and 1060 of a damaged panel are removed in the same manner as for an undamaged panel or in any other convenient manner.

Another non-limiting feature of the invention is the application of mechanical forces to the outer and inner surfaces of the flange by the mounting devices of the invention to secure the panel in the recess 72 in the body 43 of a vehicle, e.g. the van 53. In the prior art, the structural adhesive layer 60 (see FIG. 3) has to fully cure to have advantage of the structural properties of the adhesive to secure the transparency to the outer surface of the flange. Depending on the type of structural adhesive used and the environment, the cure time can be from 24 hours to greater than 7 days. Practicing the invention, the panel is secured in the recess when the mounting device of the invention engages the inner and outer surfaces of the flange, which is a matter of seconds.

Still further, another feature of the invention is the option of mounting the panel in the recess in the vehicle from a position outside the vehicle or from a position inside the vehicle. More particularly, the mounting devices of the invention eliminate the need for structural adhesive and rely on the mechanical force applied to the flange by the mounting devices. With this arrangement, the installer can install the panel in the recess positioned outside the vehicle, or positioned inside the vehicle. In the instance when the installer is positioned inside the vehicle, and the panel is outside the vehicle, the installer, e.g. using vacuum cups pulls the panel into the recess; when the installer and the panel are inside the vehicle, the installer moves the panel through the recess to a position outside the vehicle and then pulls the panel into the recess, and when the installer and the panel are outside the vehicle, the installer pushes the panel into the recess. In addition to flexibility to install the panel of the invention in the recess, the panel of the invention is easily removed to exit the vehicle through the recess in the event the doors cannot be opened. The removed panel can be remounted in the recess after the exit is completed.

An additional feature of the invention is a significant reduction in the time required to replace a damaged transparency installed practicing the prior art, or to replace a panel of the invention having a broken transparency, with a replacement panel of the invention. More particularly, and with reference to FIG. 3, the transparency 58 is secured in the recess 72 by the adhesive layer 60 securing the inner marginal edges 64 of the transparency 58 to the outer marginal edges 68 of the flange 70. Table 1 below shows the estimated average time range to practice the prior art steps to replace a damaged windshield, a damaged transparency secured to the flange defining an recess in a stationary or moveable side door (referred to on Table 1 as “side door transparency”), a quarter panel or quarter transparency (referred to on Table 1 as “quarter transparency”), and a transparency in the recess of a rear door of the vehicle (referred to on Table 1 as “rear door transparency”). The time ranges on Table I are representative of the time ranges usually taken to practice the prior art procedures and were determined from discussions with an after market installer of automotive transparencies. As can be appreciated by those skilled in the art, although the time ranges on Table I are not applicable to all prior art steps to replace a damaged transparency, the time ranges presented on Table 1 are expected to be within the range of 100% to 75% correct.

TABLE 1
PRIOR ART PRACTICE AND TIME RANGE TO PRACTICE PRIOR ART STEPS TO
REPLACE A DAMAGED TRANSPARENCY

| | | SIDE DOOR | QUARTER | REAR DOOR |
|---|---|---|---|---|
| PROCEDURE | WINDSHIELD | TRANSPARENCY | TRANSPARENCY | TRANSPARENCY |
| Step 1: | 15 TO 30 | 10 TO 15 MINUTES | 5 TO 10 | 10 TO 15 |
| Remove broken | MINUTES | | MINUTES | MINUTES |
| glass and | | | | |
| structural | | | | |
| adhesive from | | | | |
| outer surface of | | | | |
| flange. | | | | |
| Step 2: | 3 TO 5 | 3 TO 5 MINUTES | 3 TO 5 | 3 TO 5 |
| Apply a curable | MINUTES | | MINUTES | MINUTES |
| structural | | | | |
| adhesive to the | | | | |
| outer surface of | | | | |
| the transparency. | | | | |
| Step 3: | 3 TO 5 | 3 TO 5 | 3 TO 5 | 3 TO 5 |
| Position the | MINUTES | MINUTES | MINUTES | MINUTES |
| transparency in | | | | |
| the recess. | | | | |
| Step 4: Bias | 3 TO 5 | 3 TO 5 MINUTES | 3 TO 5 | 3 TO 5 |
| the | MINUTES | | MINUTES | MINUTES |
| transparency | | | | |
| against the | | | | |
| adhesive layer. | | | | |
| Total of | 24 TO 45 | 19 TO 30 MINUTES | 14 TO 25 MINUTES | 19 TO 30 |
| minimum and | MINUTES | | | MINUTES |
| maximum time | | | | |
| limits. | | | | |
| Step 5: | 10 TO 15 | 5 TO 10 | 5 TO 10 | 5 TO |
| Add edge trim, if | MINUTES | MINUTES | MINUTES | 10 MINUTES |
| removed. | | | | |
| Total of | 34 TO 60 | 24 TO 40 MINUTES | 19 TO 35 MINUTES | 24 TO 40 |
| minimum and | MINUTES | | | MINUTES |
| maximum time | | | | |
| limits. | | | | |
| Step 6: Fully | DEPENDS ON | DEPENDS ON THE | DEPENDS ON THE | DEPENDS ON THE |
| cure the | THE TYPE OF | TYPE OF | TYPE OF | TYPE OF |
| adhesive. | ADHESIVE | ADHESIVE | ADHESIVE | ADHESIVE |

The “Total of minimum and maximum time limits” on Table 1 is the range of the sum of the minimum times and the maximum times for the Steps 1-4 and for Steps 1-5. Step 1 is preparing the recess to receive the replacement transparency. The removal of the structural adhesive is accomplished using a knife-edge and care not to remove paint from the outer surface of the flange that can cause the flange to rust. In the instances when the vehicle has a customized paint job, additional care has to be taken not to scratch the painted surface. In the practice of Step 2, the structural adhesive is applied to the inner marginal edges of the transparency at the repair location. During Step 3, shims are mounted on the marginal edges of the transparency or the outer surface of the flange to have the proper spacing between the transparency and the flange. In the practice of Step 4, the transparency is biased against the adhesive and strips of tape are provided on the outer surface of the transparency and the outer surface of the vehicle to hold the transparency in position in the recess until the adhesive reaches a green strength which is a strength less than the strength of the adhesive at full cure but sufficient to hold in combination with the tape the transparency in the recess until the adhesive cures. Step 5 is the replacement of the outer trim that had to be removed to provide access to the recess to remove the structural adhesive from the outer surface of the flange.

As is appreciated by those skilled in the art, the time required to fully cure the adhesive depends on several factors only of which two that are of interest to the present discussion will be discussed. The first factor is the type of adhesive. Generally moisture curable urethanes e.g. of the type sold by Dow Automotive as Part No. 58702 and 57502 take about 7 days to fully cure, and a two component chemically reactive urethane of the type sold by Dow Automotive as Part No. U-216 takes about 72 hours to fully cure. Although the moisture curable adhesives take more time to cure than the two components adhesives, the moisture curable adhesives are more flexible. The second factor is the environment. For a moisture curable urethane increased temperature and increased humidity decreases the curing time and vise versa, and for two part components increasing the temperature reduces the curing time and vice versa: For exact curing-times and optimum curing conditions, reference can be had to information provided by the seller and/or manufacturer of the adhesive. Because of the time it takes to cure the adhesive, the practice is to use strips of tape positioned on the transparency and vehicle body to hold the transparency in place in the recess. Usually the tape is removed after about 8 hours. In this manner, the person can have a transparency replaced and drive the vehicle before the adhesive fully cures. This practice has limitations, e.g. the vehicle is preferably not washed for 8 hours after the transparency was installed, the unpleasant effect of driving the vehicle with taped windows, a high probability that pushing on the inner surface of the transparency can cause a break in the adhesive layer which could result water moving through the break into the vehicle.

In the practice of the invention, the prior art drawbacks are eliminated because the mounting devices of the invention (1) secure the panel in the recess in the body of a vehicle or in the recess in a part mounted on the body of a vehicle without the use of structural adhesive, e.g. but not limiting to the invention, at the interface of the inner marginal edges of the transparency and the outer surface of the flange, and (2) at least meet the requirements of National Highway Traffic Safety Administration Section 205 (hereinafter also referred to as “NHTSA 205”). NHTSA 205 is well known, and is easily available, to those skilled in the art and no further discussion is deemed necessary. NHTSA 205 is hereby incorporated by reference.

More particularly, the discussion will be directed to replacing a broken transparency installed using the prior art procedures set out in Table 1 with a panel of the instant invention. Step 1 of Table 1 is practiced to remove the broken glass and the structural adhesive from the outer surface of the flange. Step 2 of Table 1 is eliminated because the panel at the fabrication location had the weather seal and gasket applied to the transparency of the panel. Prior to the practice of Step 3 of Table 1, the protective tape on the weather seal is removed. Step 3 of Table 1 is effectively eliminated because the shims are not needed to properly space the transparency from the outer surface of the flange, the spacing is provided by the supporting surface of the mounting devices. Step 4 of Table 1 is effectively eliminated because the panel is secured in the recess when the panel is pushed into the recess, which takes a matter of seconds. Since the practice of the instant invention does not totally eliminate Steps 2-4, it is estimated that 3 to 5 minutes is required to practice modified Steps 2-4. Practicing the instant invention, using a locking arrangement on one or more of the mounting devices, the inner trim around the window is removed to apply the locking arrangement and the inner trim put back in position after the panel is secured in the recess. This procedure is expected to take the same amount of time as Step 5 of Table 1. Step 5 is practiced if the outside trim was removed to remove the transparency. Step 6 of Table 1 is eliminated.

From the above discussion, the practice of Steps 2-4 and 6 of Table 1 to install a transparency by the prior art procedure takes about 9 to 15 minutes plus the curing time for the adhesive, which for an appreciation of the invention is considered to be 8 hours for a total time of 8.15 to 8.25 hours; whereas, for the practice of the invention the time period to install a transparency is 0.05 hour (3 minutes) to 0.08 hour (5 minutes). In the instance when a locking arrangement is not provided with the mechanics of the mounting device, using a locking arrangement, the time range to install a windshield practicing the invention is 0.21 hour (13 minutes) to 0.33 hour (18 minutes), and for the remaining transparencies listed on Table 1 is 0.13 hour (8 minutes) to 0.25 hour (15 minutes). Examples of mounting devices having locking arrangements provided with the mechanics of the mounting device, and not limiting to the invention are the First and Eighth Mounting Devices, and examples of mounting devices not having locking arrangements provided with the mechanism of the mounting device and not limiting to the invention are the Second and Fifth Mounting Devices. Steps 1 and 5 were not considered in the discussion because the time ranges for steps 1 and 5 to remove a transparency installed practicing the prior art with a panel of the invention are the same.

For purposes of clarity, a prior art transparency is “fixedly secured” in a recess when the structural adhesive securing the transparency in the recess, e.g. to the outer surface of the flange is fully cured. A panel of the instant invention is fixedly secured in the recess when the mounting devices of the invention having a locking arrangement with the mechanics of the mounting device engage the flange, and a panel of the instant invention is fixedly secured in the recess when the mounting devices of the invention not having a locking arrangement with the mechanics of the mounting device engage the flange and have a locking arrangement applied.

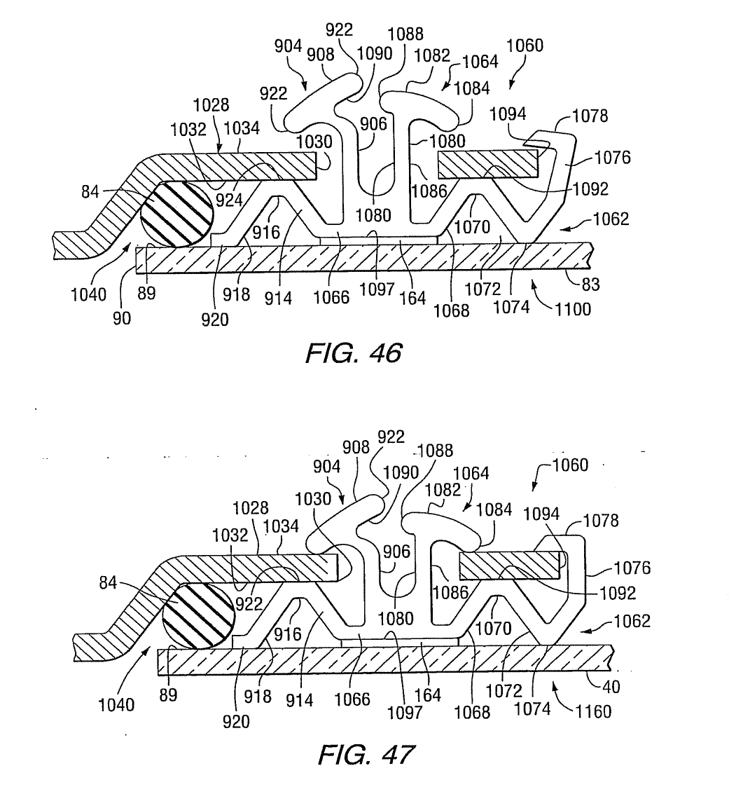

As can be appreciated, the time range to practice Step 1 of Table 1 to remove a damaged transparency installed practicing the prior art procedure is about equal to or greater than the time range for removing a damaged transparency of a panel of the instant invention. The removal of broken glass from the interior of the car is the same for both the prior art procedure and for installing a panel of the invention. There is no structural adhesive to remove when the broken transparency is from a panel of the invention, and the mounting devices, except for the Thirteenth and Fourteenth Mounting Devices that have not fallen off the flange are pulled from the flange taking a minimal amount of time. To remove the Thirteen Mounting Device not having a locking arrangement, the flexible engaging fingers 1004 and 1004 are moved together and the mounting device pulled from the flange (see FIG. 44). To remove the Fourteen Mounting Device not having a locking arrangement, the legs 908 and 1082 of the Fourteenth Mounting Device are moved together, and the mounting device pulled from the flange (see FIG. 46). When locking arrangements are used with the Thirteenth and Fourteenth Mounting Devices, the interior trim is preferably removed to remove the mounting devices from the flange. The flange is cleaned of butyl rope weather seal by swiping a plastic edge over the outer surface of the flange to remove any rope from the damaged panel on the outer surface of the flange. From the foregoing, excluding the removal of broken glass from the interior of the vehicle, the time to practice Step 1 to remove a broken transparent of a panel of the invention is about 0 to 5 minutes.

From the above discussion, it is appreciated that a panel of the instant invention can be fixedly secured in a “prepared recess” of a vehicle in a time period in one of the following ranges: greater than 0 seconds to equal to or less than 60 minutes; greater than 0 seconds to equal to or less than 45 minutes; greater than 0 seconds to equal to or less than 30 minutes, greater than 0 seconds to equal to or less than 20 minutes, and greater than 0 seconds to equal to or equal to 10 minutes. A “prepared recess” is one in which the broken glass of the damaged transparency, if present is removed, the outer surface of the flange is cleaned to receive the weather seal of the panel of the invention, e.g. the structural adhesive, if used or the butyl rope, if used is removed and/or mounting devices, if present are removed.

As is appreciated, the time ranges presented above are not limed to fixedly secure a panel of the invention in an recess in the body of an automotive vehicle, but are applicable to fixedly secure a panel of the invention in an recess in (1) any type of vehicle, e.g. but not limiting the invention thereto, any type of land vehicle, e.g. but not limiting the invention thereto an automobile, a van, a truck, a train; an above water vehicle; a below water vehicle; an air vehicle, or a space vehicle; (2) any type of residential or commercial building; (3) any type of a curtain wall system or cladding for a building, and/or (4) any type of door, e.g. but not limiting the invention, an oven door having a viewing window, a refrigerator door having a viewing window and entrance door having a viewing window.

The invention is not limited to replacing panels having damaged or undamaged transparencies as discussed above, but can be used to install panels in vehicles during their fabrication. At the present time original equipment manufactures (“OEM”) of vehicles use robotic equipment to apply the structural adhesive to the marginal edges of the transparency and/or the outer surface of the flange. Installing the panels of the instant invention by OEM eliminates the need for the robotic equipment and an inventory of the structural adhesive. Another advantage of the instant invention is that the panel of the invention can be secured in the recess after the interior, e.g. but not limited to dashboard, seats; carpeting of the vehicle has been installed. At the present time, the general practice is to install the windshield and rear window before the interior of the vehicle is installed in the event structural adhesive drips on the interior decor. Mounting the panels of the invention after the interior of the vehicle-is-installed-provides for moving tools and/or components of the interior through the windshield recess and rear window recess.

While specific embodiments of the invention have been described in detail, it will be appreciated by those skilled in the art that various modifications and alternatives to those details can be developed in light of the overall teachings of the disclosure. Further, the presently preferred embodiments described herein are meant to be illustrative only and not limiting as to the scope of the invention which is to be given the full breadth of the appended claims and any and all equivalents thereof.

1-19. (canceled)

20. A panel for covering an opening in a vehicle body, the panel having a flange around an edge portion of the opening in a body, the panel comprising:
(a) a transparency;
(b) at least one mounting device for mounting the panel to the flange, the mounting device comprising:
(i) an engaging member comprising a first surface for engaging an inner surface portion of the flange, an opposite surface, a rounded end between two sides, a cylindrical shaped end extending from each side, a first plurality of elongated inclined teeth positioned about 150° to about 270° along the rounded end from the first surface, and a second plurality of teeth positioned about 90° to about 120° along the rounded end from the first surface; and
(ii) a base with a surface secured to an inner marginal edge portion of the transparency adjacent a peripheral edge or side of the transparency, an opposite surface having two upright members with holes for receiving the cylindrical shaped ends of the engaging member, a first elongated restraining member having a pawl and a rounded end pivotally mounted in a groove in the opposite surface for rotating the pawl to engage or disengage one of the first plurality of teeth, and a second elongated restraining member having a pawl, an activating member, and a rounded end pivotally mounted in a groove in the opposite surface for rotating the pawl and the activating member to engage or disengage the pawl from one of the second plurality of teeth; and
(c) at least one of an edge trim and a weather seal secured to the inner marginal edge portion of the transparency.

21. The panel of claim 1, wherein the engaging member is spring biased.

22. The panel of claim 1, wherein the engaging member further comprises a coil spring mounted on each cylindrical shaped end between the sides of the engaging member and the upright members of the base with a positioning arm against the upright member and a positioning other arm against the opposite surface of the engaging member.

23. The panel of claim 1, wherein the first surface and the opposite surface of the engaging member are not parallel.

24. The panel of claim 1, wherein the transparency has a ceramic band fired on the inner marginal edge portion of the transparency.

25. The panel of claim 1, wherein the surface of the base is secured to the inner marginal edge portion of the transparency by an adhesive layer.

26. The panel of claim 1, wherein the surface of the base has a pair of keyways.

27. The panel of claim 1, wherein the opposite surface of the base has a slot for receiving the activating member.

28. The panel of claim 1, wherein the first surface of the engaging member has a layer of a noise absorbent material or a material with a surface friction.

29. The panel of claim 1, wherein the distance between an outer surface of the panel and the opposite surface of the base is equal to the distance between an outer surface of the flange and an outer surface of the body with the opening.

30. The panel of claim 1, wherein a center to center spacing between adjacent mounting devices and spacing between a center of the mounting device and an adjacent side of the panel is no greater than about 10 inches with at least one mounting device at each side of the panel.

31. The panel of claim 1, wherein the transparency is coated.

32. The panel of claim 1, wherein the transparency is at least one of a double glazed or insulating unit.

33. A panel for covering an opening having a flange around an edge portion of the opening in a body, the panel comprising:
(a) a transparency;
(b) at least one mounting device comprising a spring biased engaging member mounted to a housing having a base with a surface secured to an inner marginal edge portion of the transparency adjacent a peripheral edge or side of the transparency, wherein an inner portion of the flange contacts a surface of the engaging member and an outer portion of the flange contacts a portion of the housing or base; and
(c) at least one of an edge trim and a weather seal secured to the inner marginal edge portion of the transparency.

34. The panel of claim 33, wherein the housing comprises a pair of ends, a pair of sides with slots extending between the ends, and a topside having a recess extending between the ends; and wherein the engaging member has an inverted L-shaped edge receiving member mounted on a platform slideably mounted in the housing with a long leg extending upward from the platform and a short leg having a sloped upper surface extending through the topside recess and over a surface of the platform, thereby providing a groove to receive the flange; and wherein a coil spring is secured to the platform and an inner surface of the end of the housing opposite the groove thereby biasing the engaging member toward the end of the housing facing the groove.

35. The panel of claim 34, wherein opposed sides of the platform have an extension extending through the slots in the sides of the housing.

36. The panel of claim 33, wherein the transparency has a ceramic band fired on the inner marginal edge portion adjacent a peripheral edge or side.

37. The panel of claim 33, wherein the surface of the base is secured to the inner marginal edge portion of the transparency by an adhesive layer.

38. The panel of claim 33, wherein the transparency is coated.

39. The panel of claim 33, wherein the transparency is at least one of a double glazed or insulating unit.

40. The panel of claim 33, further comprising a gasket surrounding the transparency.

41. The panel of claim 33, further comprising a locking mechanism.

42. The panel of claim 41, wherein the locking mechanism comprises a passageway in the housing and a passageway in the engaging member such that when the passageways are aligned a shaft or threaded pin may be secured in the passageways to lock the engaging member in an engaging position.

43. The panel of claim 33, further comprising a friction layer on the portion of the housing or base in contact with the flange.

44. The panel of claim 33, further comprising a layer of low friction material on at least one surface of the engaging member in contact with the flange.

45. The panel of claim 33, wherein the housing comprises a passageway with a closed end and an open end; and wherein the engaging member has an end captured in the passageway, an opposite end biased toward and extending out of the open end of the passageway by way of a coil spring positioned in the passageway, a sloped upper surface, and a flat opposite surface for engaging the flange.

46. The panel of claim 33, wherein the housing is a tower having a recess shaped to accommodate an outer shape of the engaging member; wherein the engaging member is mounted on an axis for pivotal motion along a reciprocating circular path to move into and out of the recess; and wherein a spring is mounted on the axis acting on the engaging member to bias the engaging member out of the recess.

47. The panel of claim 33, wherein the housing comprises a first wall and an opposite second wall interconnected by a third wall with a recess between the first wall and the opposite second facing wall facing an adjacent peripheral side of the transparency; wherein the base has a supporting surface extending from the housing for interacting with the flange; wherein the engaging member is pivotally mounted on a shaft secured to the first wall and the opposite second facing wall in the housing and comprises an U-shaped arm member having a bifurcated first arm and a bifurcated second arm interconnected by an intermediate arm with the shaft passing through the arm member adjacent the second arm and the intermediate arm; wherein a spring has an end mounted to an elongated member passing through the first wall and the opposite second facing wall of the housing and an opposite end secured to the arm member adjacent the first arm and the intermediate arm; and wherein the shaft and the elongated member are positioned relative to one another such that the spring biases the arm member in a clockwise direction.

48. The panel of claim 47, wherein the bifurcated first and second arms of the arm member further comprise a rotating wheel at an end opposite the intermediate arm.

49. The panel of claim 33, wherein the housing is a hollow cylinder extending upward from the base with an open end and a cap secured to the open end; wherein a shaft is mounted in the cylindrical housing; wherein a coil spring is mounted on the shaft with an end of the spring extending through a slot out of the cylindrical housing and connected to a sleeve on the engaging member thereby biasing the engaging member into an engaging position; wherein the sleeve is captured on an upper portion of an outer surface of the cylindrical housing for rotational motion; wherein an arm extends outward from the base and terminates in a platform having a supporting surface to engage an outer surface of the flange; wherein the engaging member has an en engaging arm comprising a plate having a side secured to the sleeve, a sloping surface member extending upward from the plate and outward from the sleeve, and a side opposite the side secured to the sleeve extending over the supporting surface of the base; and wherein the arm and the supporting surface are aligned with the plate such that in the engaging position the plate has a bottom surface portion over the supporting surface and a biasing action of the coil spring of about zero.

50. The panel of claim 33, wherein the housing comprises the base, a back wall, a pair of side walls with a linear horizontal slot and a second reversed L-shaped slot spaced from the horizontal slot with a vertical leg slanting away from the back wall with a concave curved surface portion, an open end, and an open top; wherein the engaging member has a first leg having a first tab spaced from a second tab corresponding to the slots of the side walls of the housing on each side and a second engaging leg shorter than the first leg interconnected by an intermediate leg in a U-shaped configuration; wherein the engaging member is captured between the side walls of the housing by the tabs for movement along a path defined by the slots; wherein a spring has a first end connected to an inner surface of the back wall and an opposite end connected to the engaging member to bias the second tabs into the vertical leg of the second slot into an engaging position.

51. The panel of claim 50, wherein the housing is made of a bent or formed configurative metal sheet.

52. A panel for covering an opening having a flange around an edge portion of the opening in a body, the panel comprising:
(a) a transparency;
(b) at least one mounting device comprising a base with a pair of spaced stub shafts on opposite sides, an engaging member with a pair of spaced stub shafts on opposite sides corresponding to the stub shafts on the base, a strut rotatably mounted on each stub shaft on the base and the corresponding stub shaft on the engaging member; wherein the engaging member has a rounded end portion having a raised portion facing the base and an adjacent side of the transparency for engaging an inner surface of the flange; wherein a lower surface of the base is secured to an inner marginal edge portion of the transparency adjacent a peripheral edge or side; and wherein the engaging member is biased toward the side of the transparency and side of the base; and
(c) at least one of an edge trim and a weather seal secured to the inner marginal edge portion of the transparency.

53. The panel of claim 52, further comprising a spring on at least one of the stub shafts.

54. The panel of claim 52, wherein the transparency has a ceramic band fired on the inner marginal edge portion adjacent a peripheral edge or side.

55. The panel of claim 52, wherein the surface of the base is secured to the inner marginal edge portion of the transparency by an adhesive layer.

56. The panel of claim 52, wherein the transparency is coated.

57. The panel of claim 52, wherein the transparency is at least one of a double glazed or insulating unit.

58. The panel of claim 52, further comprising a gasket surrounding the transparency.

59. The panel of claim 52, further comprising a locking mechanism.

60. The panel of claim 59, wherein the locking mechanism comprises a passageway in the engaging member and a threaded passageway in the base such that when the passageways are aligned in an engaging position a threaded screw can be secured in the passageways to lock the engaging member in the engaging position.

61. The panel of claim 52, further comprising a friction layer on the portion of the base in contact with the flange.

62. The panel of claim 52, further comprising a layer of low friction material on at least one surface of the engaging member in contact with the flange.

63. A panel, comprising:
a surface;
a mounting device comprising:
a base fixedly mounted to the surface;
a supporting surface connected to the base, the supporting surface spaced from and facing away from the surface of the panel;
an engaging surface in facing relationship to the supporting surface, the engaging surface connected to the base and the supporting surface, wherein moving the supporting surface toward the surface of the panel moves the engaging surface toward the surface of the panel; and
a locking arrangement to maintain the engaging member in the engaging position.

64. The panel of claim 63, further comprising a layer of a material having a first predetermined coefficient of friction on the supporting surface and a layer of material having a second predetermined coefficient of friction on the engaging surface, wherein the first predetermined coefficient of friction is higher than the second predetermined coefficient of friction.

65. The panel of claim 63, further comprising a layer of a material having a first predetermined coefficient of friction on the engaging surface and a layer of material having a second predetermined coefficient of friction on the supporting surface, wherein the first predetermined coefficient of friction is higher than the second predetermined coefficient of friction.

66. The panel of claim 63, wherein at least one of the engaging surface or the supporting surface of the mounting device has a groove across its respective surface.
